(19) United States
(12) Patent Application Publication
(10) Pub. No.: US 2024/0351184 A1
(43) Pub. Date: Oct. 24, 2024

(54) COMPONENT BOX AND METHOD FOR STORING MULTI-FUNCTION COMPONENTS

(71) Applicant: ZHEJIANG ZHENGTE CO., LTD., Linhai (CN)

(72) Inventors: Patrick van Lierop, Linhai Zhejiang (CN); Younghui Chen, Linhai Zhejiang (CN)

(21) Appl. No.: 18/424,525

(22) Filed: Jan. 26, 2024

Related U.S. Application Data
(60) Provisional application No. 63/441,737, filed on Jan. 27, 2023.

(51) Int. Cl. B25H 3/02

(52) U.S. Cl. CPC B25H 3/026

(57) ABSTRACT

Disclosed are example embodiments of a 5-device-in-one component box including a plurality of cranking-arm-wrench storage clips respectively molded onto said undersurface of a multi-function loss-preventing storing-and-organizing lid-tray. The box includes a multi-link crank control arm wrench snap, a plurality of ground-securing-and-leveling-screws storage cavities, a plurality of Allen-wrench storage cavities; a plurality of Allen wrenches; a plurality of screws respectively stacked inside a second base-plate cover; a compartmentalized loss-preventing storing-and-organizing inner-tray, a plurality of louver end-caps, a plurality of crank-handle-coupler storage-stem molded onto said compartmentalized loss-preventing storing-and-organizing inner-tray, a crank-handle coupler snap-locked onto said crank-handle-coupler storage-stem, a plurality of compression-locking-plates storage compartments, a plurality of compression-locking plates respectively inserted and secured to said compression-locking-plates storage compartments; a plurality of drill-bit clips respectively molded onto said compartmentalized loss-preventing storing-and-organizing inner-tray; a drill bit snap-locked between said drill-bit clips; and fourth base-plate cover stacked right side up on said third base-plate cover.

### CROSS REFERENCE TO RELATED APPLICATIONS

The present application claims priority to U.S. Provisional Patent Application No. 63/441,737, filed Jan. 27, 2023, which is incorporated herein by reference in its entirety.

### TECHNICAL FIELD

The disclosure relates generally to the field of storage, and specifically and not by way of limitation, some embodiments are related to a component box and method for storing.

### BACKGROUND

A number of different storage devices have been introduced in the past. Some examples are provided below.

U.S. Pat. No. 7,296,584, issued 2007 Nov. 20, to Brian Goldwitz describes a method for disassembling and packaging the canopy in a container, wherein the length of the container is 25% shorter than the length of each of the upright assemblies. To accommodate the shortened length, the width and/or the height of the container may be increased as necessary to still house all the components of the canopy. Preferably, the length of the container is sufficiently short to accommodate placing the container in a traditional sedan automobile trunk.

U.S. Pat. No. 7,841,136, issued 2010 Nov. 30, to Ronald Chester Czyznikiewicz relates to a portable housing/shelter unit assembled in a manufacturing building, loaded on a trailer truck, and delivered to a site. Once on the site it is lifted off the trailer and lowered onto a leveled ground location or a foundation. Then the unit is un-folded from its central frame (container) and secured to the foundation and final extrusions and screws are applied; thus, the unit is setting in final set up position, structurally and weather tight. If required, additional exterior fenestration can be added to the basic shell, and the exterior customized per client needs and directives.

U.S. Pat. No. 8,555,910, issued 2013 Oct. 15, to Richard Webster describes shelter structures having an upper shelter portion supported (internally or externally) at an apex and one or more peripheral support elements supported by an external suspension web provided externally of a base region of the upper shelter portion are provided. The upper shelter portion provides a roof-like structure, while a lower enclosure portion may be connected, directly or indirectly, to the upper shelter portion and may provide wall-like structures that may include doors, vents, windows, and the like, or that may comprise an open network of lines, straps, wires, or bands. In tent embodiments, the upper shelter portion and the lower enclosure portion may be provided as fabric structures that, when erected, form tensioned fabric structures. Support systems, kits for assembling structures, reinforcement features and methods for assembling structures are also disclosed.

U.S. Pat. No. 8,590,264, issued 2020 Sep. 29, to Charles H. Leahy describes prefabricated wall panels with embedded electronic devices. Also, a modular building made from prefabricated panels with embedded electronic devices, individual panel identifiers, and a central computer system.

U.S. Pat. No. 9,192,215, issued 2015 Nov. 24, to Oliver Joen-An Ma describes a quick connect system provided for a shade structure. The system includes a hub and a structural member. The hub has a top surface, a plurality of side walls forming a slot therebetween, and a displaceable retention device having a free end disposed at an elevation below the top surface. The displaceable retention device is moveable laterally away from the slot. The structural member has an end configured to swing in the slot. The end has a laterally extending rotation device. The rotation device extends laterally beyond the free end of the displaceable retention device when the end is disposed in the slot.

U.S. Pat. No. 9,194,152, issued 2015 Nov. 24, to Felix M. Plasencia describes a cantilever canopy disclosed for extending over a surface. The cantilever canopy includes a first telescoping support member and a second telescoping support member. A telescoping coupling member is secured between the first telescoping support member and second telescoping support member. A first pivot hinge pivotably couples the first telescoping support member with a first telescoping cantilever member. A second pivot hinge pivotably couples the second telescoping support member with a second telescoping cantilever member. A screen extends between the first telescoping cantilever member and the second telescoping cantilever member for providing shelter under the screen.

U.S. Pat. No. 9,556,639, issued 2017 Jan. 31, to David Lewis Hun describes a portable shelter framing system disclosed herein. The portable shelter framing system includes a plurality of corner support members; a plurality of crossbeam members, each of the crossbeam members configured to be connected between a pair of the plurality of corner support members without the use of tools; and a plurality of roof frame members, each of the roof frame members configured to be coupled to one of the plurality of corner support members or one of the plurality of crossbeam members without the use of tools. In one or more embodiments, the portable shelter framing system further includes a plurality of connecting members, each of the connecting members configured to couple a respective one of the plurality of roof frame members to a respective one of the plurality of corner support members or to a respective one of the plurality of crossbeam members without the use of tools.

U.S. Pat. No. 9,914,209, issued 2018 Mar. 13, to Larry Mitchell Grela describes a storage assembly which has a plurality of unique storage components which may be selectively connected in order to provide an optimal storage solution for a wide variety of applications.

U.S. Pat. No. 10,034,524, issued 2018 Jul. 31, to ZHUN-AN Ma describes an umbrella hub provided that includes an inner portion, an outer periphery, a lower portion and an upper portion. A plurality of vertical grooves is disposed in the outer periphery and is configured to receive umbrella ribs or struts. A plurality of grooves extends transverse to the plurality of vertical grooves. A retention member is disposed in each of the transverse grooves. A first configuration of the hub permits deflection of the retention member such that a transverse pin coupled with the umbrella ribs or struts can be inserted into the transverse groove in which the retention member is disposed. A second configuration of the hub prevents deflection of the retention member such that inadvertent withdrawal of the pin from the transverse groove in which the retention member is disposed is prevented.

U.S. Pat. No. 10,214,938, issued 2019 Feb. 26, to Lianzhang Pan describes a rail system for an outdoor shelter described herein. The rail system includes at least one pair of support post members, each pair of support post members including a first support post member being spaced apart from a second support post member; a first guide rail member coupled to the first support post member; a second guide rail member coupled to the second support post member; and a shade support pole member slidably coupled to the first and second guide rail members, the shade support pole member being coupled to an end portion of a shade member of the outdoor shelter, and the shade support pole member configured to be slidably displaced along the lengths of the first and second guide rail members so as to allow an amount by which the shade member overhangs a side of the outdoor shelter to be adjusted by a user.

U.S. Pat. No. 10,350,746, issued 2019 Jul. 16, to Mark R. Martinez describes a tool storage device and a toolbox. The device may include flexible walls cooperating to define a storage area, and a rigid frame supported in the storage area and including a central portion extending in a direction from a bottom wall toward a top wall, one base portion extending from one side of the central portion, along the bottom wall and toward one side wall, and another base portion extending from an opposite side of the central portion, along the bottom wall and toward an opposite side wall. The toolbox may include a body defining a storage compartment; a lid defining a groove in its outer surface to support an elongated work piece; and a handle engageable with a work piece supported in the groove. The lid may be attachable to the top of the body in a closed position and to the bottom in a stowed position.

U.S. Pat. No. 10,357,874, issued 2019 Jul. 23, to David P. Engvall describes a storage container which can include a bottom surface and one or more sides that extend up from the bottom surface to define a storage area. The storage container can also include a lid rotatably coupled to at least one of the sides and can be moved from a closed position, preventing, or limiting access to the storage area, to an open position, allowing access. The storage container can also include a work surface rotatably coupled to a bottom side of the lid. When the lid is opened, the work surface is rotated into a substantially horizontal position providing a planar top surface to work on. The storage container can also include a leg support assembly that is rotatably coupled to one or more of the side walls of the storage container and can be adjusted into a support position to provide vertical support for a portion of the work surface.

U.S. Pat. No. 10,392,821, issued 2019 Aug. 27, to Dee Volin describes a four-device-in-one splash-and-drip-eliminating gazebo comprising: a top roof, top-roof columns, top-roof mosquito-mesh panels respectively screwed to the top-roof columns, a bottom roof, respectively screwed to the top-roof columns, rain-water gutters molded to the rain-water gutters as one unit for functioning as gutters and top rails at the same time for collecting rain water to be used for irrigation, splash-drip-eliminating caves respectively formed at the bottom-roof end of the bottom roof for extending downward into the gutter inside to direct water downward into the gutter inside to eliminate water splash and water drip and for collecting rain water to be used for irrigation, top rails molded to the rain-water gutters as one unit for functioning as gutters and top rails at the same time, the bottom roof screwed to the rain-water gutters and the top rails, corner posts, respectively attached to the rain-water gutters and the top rails, double-U-shaped-end covers respectively slidably coupled with the corner posts for allowing the installation of electrical components on the corner-post inside and for allowing the supply of electricity to the four-device-in-one splash-and-drip-eliminating gazebo from the corner-post inside and for removably covering and protecting electrical components on the corner-post inside, post-locking top-rail slots respectively molded into the top rails for lockably fastening the corner posts to the top rails and for automatically guiding the corner posts into the post-locking top-rail slots, top-rail-locking post slots respectively molded into the corner posts for lockably fastening the corner posts to the top rails and for automatically guiding the top rails into the top-rail-locking post slots to make assembly easier, bottom rails, multi-purpose door frames slidably placed between the top rails and the bottom rails, panels respectively secured to the multi-purpose door frames, H-shaped panel strips respectively secured between the panels, an inner post insertably screwed to the corner posts, a base welded to the inner post, base holes, height-adjustable tube-screws respectively and securably screwed into the base holes for adjusting the height of the corner posts to compensate for uneven terrain and uneven concrete surface and uneven deck surface and for leveling the four-device-in-one splash-and-drip-eliminating gazebo to keep water drainage working properly, anchoring-screw holes respectively molded into the height-adjustable tube-screws, and anchoring screws respectively screwed into the anchoring-screw holes in the height-adjustable tube-screws for securing and strengthening the triangular base and the four-device-in-one splash-and-drip-eliminating gazebo to the ground.

U.S. Pat. No. 10,661,818, issued 2020 May 26, to Edward G. Guirlinger describes a method for monitoring a tool set disclosed. According to one embodiment, the method comprises configuring a tool organizer in an open configuration. The tool organizer contains at least a portion of a tool set. The method further comprises visually inspecting the contents of the tool organizer to determine a first level of completeness of the tool set; recording the first level of completeness of the tool set; releasing the tool organizer and contents for use by a third party; receiving the tool organizer and returned contents from the third party; configuring the tool organizer in an open configuration; visually inspecting the returned contents of the tool organizer to determine a second level of completeness of the tool set; and comparing the first level of completeness with the second level of completeness to determine whether one or more tools from the tool set are missing.

U.S. Pat. No. 10,773,374, issued 2020 Sep. 15, to Christopher S. Hoppe describes tool storage devices. A tool storage device may include a handle assembly including a support arm connected between a body and a handle portion and having a substantially rectangular cross section oriented with first walls extending transverse to the axis having a greater width than second walls extending parallel to the axis. A width of the handle portion may be at least about 50% of a width of the body. The body may include a frame assembly formed of a rigid material, a wall formed of a flexible material and at least partially defining the storage compartment with an open top, and a cover formed of a rigid material connected to the frame assembly to selectively close the open top. A wheel well portion receives each wheel and may cover the width of the wheel and a portion of the circumference of the wheel. A radial clearance between the wheel and a lower end of the wheel well may be no more than about 0.5 inches.

U.S. Pat. No. 11,078,678, issued to Mark Alan Eilers describes a kit comprising components of an erectable shed, wherein the erectable shed is made of metal, in comprises at least two door panels, each of which is at least thirty four inches in height, wherein the components can be packaged in a box having dimensions of no greater than 48 inches×20 inches×10 inches, and wherein the space perimetered by the wall panels and side panels when the erectable shed is erected is at least 6 feet long by 40 inches wide and wherein the height of the shed when erected is at least 6 feet.

U.S. Pat. No. 11,206,904, issued 2021 Dec. 28, to Oliver Joen-An Ma describes a quick connect system provided for a shade structure. The system includes a hub and a rib. The hub has an upper portion, a lower portion, and a rib engagement section. The rib engagement section includes a groove. The groove includes an annular bearing zone, which may be disposed between two facing walls of the hub. The rib includes an elongate body having an inner end and an outer end, the inner end of the rib including a pivot member. The annular bearing zone is configured to support end portion of the pivot member of the rib.

U.S. Pat. No. 11,293,196, issued 2022 Apr. 5, to Dee Volin describes a six device-in-one robot-assembled arthritic-assisting noise-canceling friction-reducing dog-run-adaptable anti-wobbling gazebo which includes an adjustable canopy, foldable trusses and posts, and robotically formed connectors which connect the trusses and include a rivet tail fare noise canceling connector system, a robot assembled heat expandable, cold contractible interlocking anti-wobbling spiral saw screw system, a cone shielding intersector system, and post centering, tick preventing water discharging sleeve system.

U.S. Pat. No. 11,338,959, issued 2022 May 24, to Christopher S. Hoppe describes coupling systems to be used with storage units that are selectively coupled and decoupled. The coupling systems may be used with storage units that are stackable and/or transportable, thus allowing the storage units to function well within a large stationary environment, such as a basement, and also for a subset of the storage units to be selected and easily moved to another location.

U.S. Pat. No. 11,078,678, issued 2021 Aug. 3, to Mark Alan Eilers describes a kit comprising components of an erectable shed, wherein the erectable shed is made of metal, in comprises at least two door panels, each of which is at least thirty four inches in height, wherein the components can be packaged in a box having dimensions of no greater than 48 inches×20 inches×10 inches, and wherein the space perimetered by the wall panels and side panels when the erectable shed is erected is at least 6 feet long by 40 inches wide and wherein the height of the shed when erected is at least 6 feet.

U.S. Publication No. 20050194031A1, issued 2005 Sep. 8, to Brian Goldwitz describes a method for disassembling and packaging the canopy in a container, wherein the length of the container is 25% shorter than the length of each of the upright assemblies. As a result, the length of the container is significantly short as compared with prior art containers. To accommodate the shortened length, the width and/or the height of the container may be increased as necessary to still house all the components of the canopy. Preferably, the length of the container is sufficiently short to accommodate placing the container in a traditional sedan automobile trunk.

U.S. Publication No. 20060157098A1, issued 2007 Feb. 20, to Timothy Holub describes a ring and connector assembly for a tent. The ring and connector assembly is configured so that the connector attaches to the ring, such as via a loop that is attached to the connector and that extends around a portion of the ring. The ring is attached to the tent, for example at a floor edge of the tent, or at a corner of the tent. The connector is configured to be attached to a pole and may, for example, be a pin.

U.S. Publication No. 20080231067A1, issued 2008 Sep. 25, to Rick A. Nagle describes a tailgate barrier system designed to maintain cargo within the cargo bed of a transport vehicle when the tailgate of the vehicle's cargo bed is lowered. The barrier stores within a storage compartment in or on the tailgate of a vehicle and extends linearly upward from the storage compartment for use. An arrangement of extendable supports, pivotally coupled to the tailgate and top rail of the barrier system, enable the preferred upward movement. The system further comprises electrical connections. Groups of accessories mountable to the tailgate barrier system are also disclosed.

U.S. Publication No. 20160201326A1, issued 2018 Sep. 4, to Aleksandar Stevanov describes a post, beam and arched member modular building is shown. The modular building may be formed into any number of different configurations and different structures. The system relies upon a box shape formed from four vertical members, with an arched member extending between each of the adjacent vertical members. The rear vertical members being higher than the front vertical members, with angled members, or rafters extending from the rear vertical members (or a cross-member at the same height thereof) to the front vertical members (or the corresponding arch). In the configuration shown, the angled members or rafters are co-planar. The structure has substantial symmetry and aesthetic design.

U.S. Publication No. 20170260770A1, issued 2019 Sep. 24, to Xinjian Xu describes a mechanism for connecting two beams comprises a left beam and a right beam. The left beam is formed by an upper cross bar, a lower cross bar, and a vertical plate, the vertical plate has a width greater than a width of the upper cross bar and a width of the lower cross bar, the vertical plate has two edges protruding laterally away from the upper cross bar and the lower cross bar; the right beam has a vertical socket for receiving the vertical plate, the vertical socket is connected to the upper cross bar and to the lower cross bar, the vertical socket has two opposing curled lateral edges protruding laterally away from the upper cross bar and the lower cross bar, the two protruding edges of the vertical plate are inserted between the two opposite curled edges of the vertical socket.

U.S. Publication No. 20180023309A1, issued 2018 Jan. 25, to Randy Brawner describes a method for framing a structure using pre-dimensioned components comprising lower support components, framing components for assembling a series of frames, sheathing, and a template for guiding the assembly of the series of frames. The method comprises the steps of: fastening the lower support components together to produce a lower support rim; assembling the series of frames using markings on the template to guide placement of framing components; and fastening the series of frames to the lower support rim.

U.S. Publication No. 20190337143A1, issued 2019 Nov. 7, to Mark R. Martinez describes a tool storage device and a toolbox. The device may include flexible walls cooperating to define a storage area, and a rigid frame supported in the storage area and including a central portion extending in a direction from a bottom wall toward a top wall, one base portion extending from one side of the central portion, along the bottom wall and toward one side wall, and another base portion extending from an opposite side of the central portion, along the bottom wall and toward an opposite side wall. The toolbox may include a body defining a storage compartment; a lid defining a groove in its outer surface to support an elongated work piece; and a handle engageable with a work piece supported in the groove. The lid may be attachable to the top of the body in a closed position and to the bottom in a stowed position.

U.S. Publication No. 20200039056A1, issued 2020 Feb. 6, to Peter-Thomas Damberg describes an invention which relates to a container, such as an assortment box, comprising a storage assembly, wherein said storage assembly is for storing contents inside said container, said storage assembly comprising at least one storage unit and a reception layer, wherein said at least one storage unit is adapted to be connected to said reception layer in a releasable manner by use of a first connection means.

U.S. Pat. No. D397445S, issued 1998 Aug. 25, to Duane Thorbeck describes the ornamental design for an emergency shelter.

U.S. Pat. No. D414564S, issued 1999 Sep. 28, to Brian L. Goldwitz describes the ornamental design for the shelter frame assembly.

A need exists for an improved component box and methods related to the component box.

### SUMMARY

In one example implementation, an embodiment includes a compact portable 5-device-in-one space-saving multi-function-component box, which is economical to produce, is easy to ship, and can be quickly and easily assembled. Particularly, the present invention relates to a 5-device-in-one space-saving cost-saving production-increasing assembly-time-decreasing multi-function-component box (which can be made as compactly small as 2 inches wide by 2 inches long by 2 inches high), which comprises: a multi-function loss-preventing storing-and-organizing lid-tray system 101, a compartmentalized loss-preventing storing-and-organizing tub-tray system 105, and a compartmentalized loss-preventing storing-and-organizing inner-tray system 116.

Disclosed are example embodiments of a 5-device-in-one space-saving cost-saving production-increasing assembly-time-decreasing multi-function-component box. The box including a multi-function loss-preventing storing-and-organizing lid-tray, having an undersurface; a plurality of cranking-arm-wrench storage clips respectively molded onto said undersurface of said multi-function loss-preventing storing-and-organizing lid-tray; a multi-link crank control arm wrench snap-locked between said cranking-arm-wrench storage clips; a compartmentalized loss-preventing storing-and-organizing tub-tray; a plurality of ground-securing-and-leveling-screws storage cavities 108 respectively formed into said compartmentalized loss-preventing storing-and-organizing tub-tray; a plurality of round-securing-and-leveling screws respectively inserted into said ground-securing-and-leveling-screws storage cavities; a plurality of Allen-wrench storage cavities respectively formed into said compartmentalized loss-preventing storing-and-organizing tub-tray; a plurality of Allen wrenches respectively inserted into said Allen-wrench storage cavities; a corner-caps storage cavity formed into said compartmentalized loss-preventing storing-and-organizing tub-tray; a plurality of corner caps respectively inserted into said corner-caps storage cavity; first base-plate cover stacked upside down inside said compartmentalized loss-preventing storing-and-organizing tub-tray; a plurality of base plates respectively stacked inside said first base-plate cover; second base-plate cover stacked upside down on said first base-plate cover inside said compartmentalized loss-preventing storing-and-organizing tub-tray; a plurality of screws respectively stacked inside said second base-plate cover; third base-plate cover stacked upside down on said second base-plate cover inside said compartmentalized loss-preventing storing-and-organizing tub-tray; a compartmentalized loss-preventing storing-and-organizing inner-tray stacked within said second and said third base-plate covers; a plurality of louver-end-caps storage compartments respectively formed into said compartmentalized loss-preventing storing-and-organizing inner-tray; a plurality of louver end-caps respectively inserted and secured to said louver-end-caps storage compartments; a plurality of crank-handle-coupler storage-stem molded onto said compartmentalized loss-preventing storing-and-organizing inner-tray; a crank-handle coupler snap-locked onto said crank-handle-coupler storage-stem; a plurality of compression-locking-plates storage compartments respectively formed into said compartmentalized loss-preventing storing-and-organizing inner-tray; a plurality of compression-locking plates respectively inserted and secured to said compression-locking-plates storage compartments; a plurality of drill-bit clips respectively molded onto said compartmentalized loss-preventing storing-and-organizing inner-tray; a drill bit snap-locked between said drill-bit clips; and fourth base-plate cover stacked right side up on said third base-plate cover inside said compartmentalized loss-preventing storing-and-organizing tub-tray.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIGS. 1-6 are diagrams illustrating perspective views of multi-function loss-preventing storing-and-organizing lid-tray system 101 and its included components in accordance with the systems and methods described herein.

FIGS. 7-21 are diagrams illustrating perspective views of compartmentalized loss-preventing storing-and-organizing tub-tray system 105 and its included components in accordance with the systems and methods described herein.

FIGS. 22-34 are diagrams illustrating perspective views of compartmentalized loss-preventing storing-and-organizing inner-tray system 116 and its included components in accordance with the systems and methods described herein.

FIGS. 35-50 are diagrams illustrating perspective views of stacking-method steps of 5-device-in-one space-saving cost-saving production-increasing assembly-time-decreasing multi-function-component box (which can be made as compactly small as 2 inches wide by 2 inches long by 2 inches high) in accordance with the systems and methods described herein.

FIGS. 51-53 are diagrams illustrating perspective views demonstrating how multi-function loss-preventing storing-and-organizing lid-tray 102 can be used as a tray to hold components in accordance with the systems and methods described herein.

FIGS. 54A-56 are diagrams illustrating perspective views demonstrating how multi-link crank control arm wrench 103 can function as a box-wrench or a flat-head screwdriver, respectively in accordance with the systems and methods described herein.

FIGS. 57-68 are diagrams illustrating perspective, exploded, front, and side views demonstrating how 5-device-in-one space-saving cost-saving production-increasing assembly-time-decreasing multi-function-component box provides a compact stackable packaging solution to allow multi-function components and tools to compactly stack on one another to save shipping space and cost in accordance with the systems and methods described herein.

FIGS. 69-71 are diagrams illustrating perspective views demonstrating how compartmentalized loss-preventing storing-and-organizing tub-tray 106 can be used as a loss-preventing storage tray in accordance with the systems and methods described herein.

FIGS. 72-76 are diagrams illustrating perspective views demonstrating how ground-securing-and-leveling screws 107 function in accordance with the systems and methods described herein.

FIGS. 77-84 are diagrams illustrating perspective views demonstrating how compartmentalized loss-preventing storing-and-organizing inner-tray 117 can be used as a loss-preventing storage tray in accordance with the systems and methods described herein.

FIGS. 85-100 are diagrams illustrating perspective views demonstrating method steps of 5-device-in-one space-saving cost-saving production-increasing assembly-time-decreasing multi-function-component box in accordance with the systems and methods described herein.

FIGS. 101-108 are diagrams illustrating perspective views of all the components and tools compactly stacked inside 5-device-in-one space-saving cost-saving production-increasing assembly-time-decreasing multi-function-component box in accordance with the systems and methods described herein.

FIGS. 109A-112B are diagrams illustrating perspective exploded views of equivalent variations of 5-device-in-one space-saving cost-saving production-increasing assembly-time-decreasing multi-function-component box in accordance with the systems and methods described herein.

FIGS. 113-117 are diagrams illustrating perspective exploded views of equivalent applications of 5-device-in-one space-saving cost-saving production-increasing assembly-time-decreasing multi-function-component box being used for storing multi-function components and assembling tools of a sauna house, smokehouse, sky box, and dehydrating house in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Prior art has failed to solve many problems associated with such compact portable storage devices, as follows:

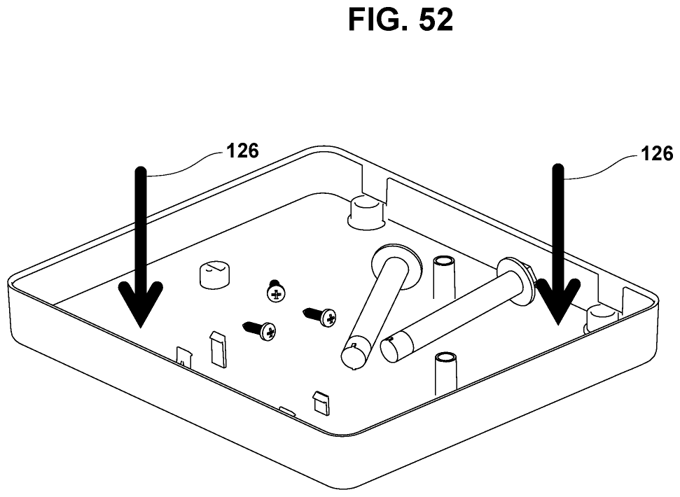

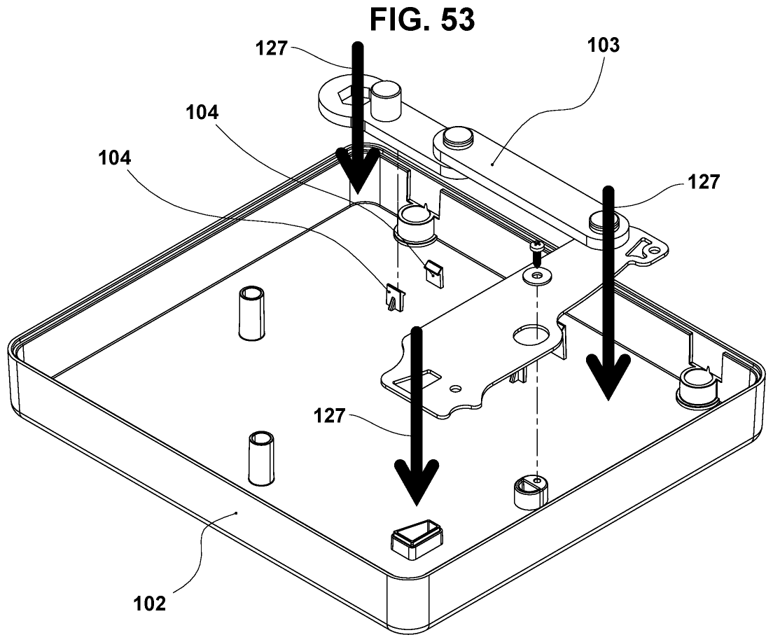

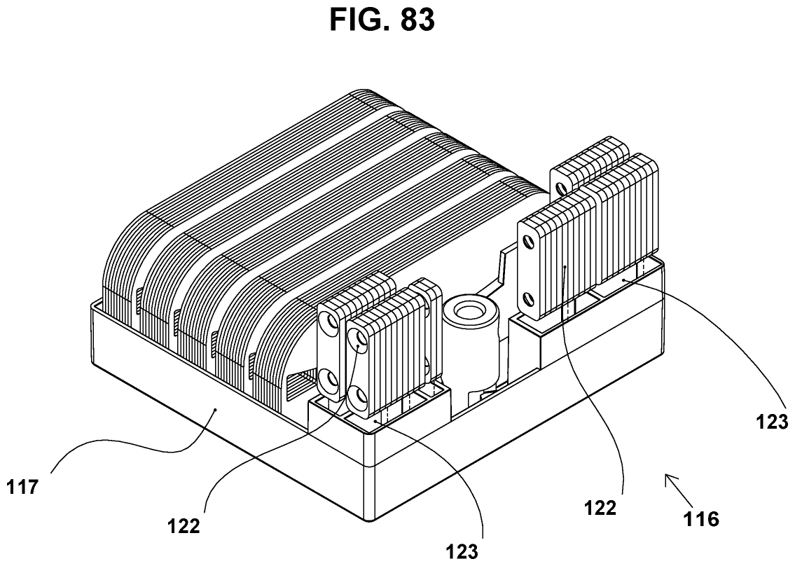

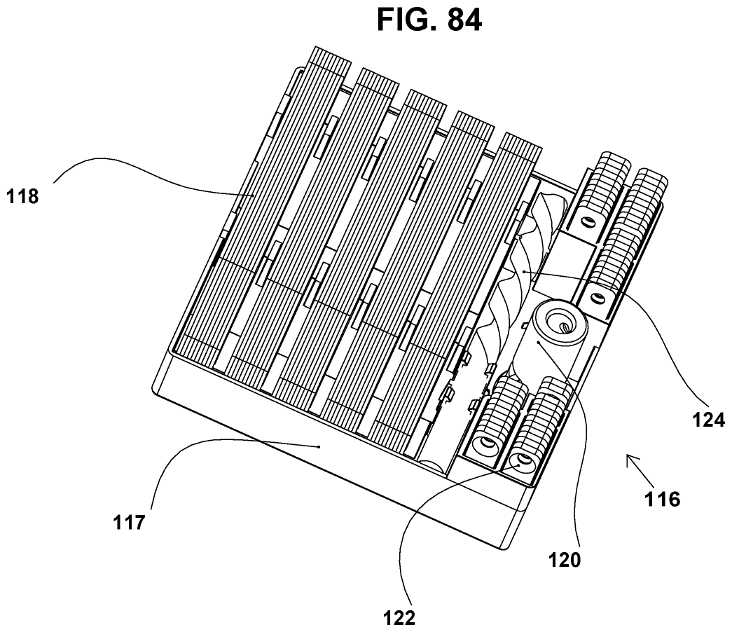

No prior art mention or disclose any compact portable storage device having multi-function loss-preventing storing-and-organizing lid-tray 102. Therefore, the prior art of compact portable storage device is not capable of preventing loss by being turn over during assembly to function as a tray for securely containing multi-link crank control arm wrench 103, Allen wrench 109, screws 113, louver end-caps 118, crank-handle coupler 120, drill bit 124, etc. in the directions of arrows 126 and 136 (see FIGS. 52, 77-84); and not capable of providing a secure location on its under surface to clamp on and store multi-link crank control arm wrench 103 during shipping in the directions of arrow 127 (see FIG. 53).

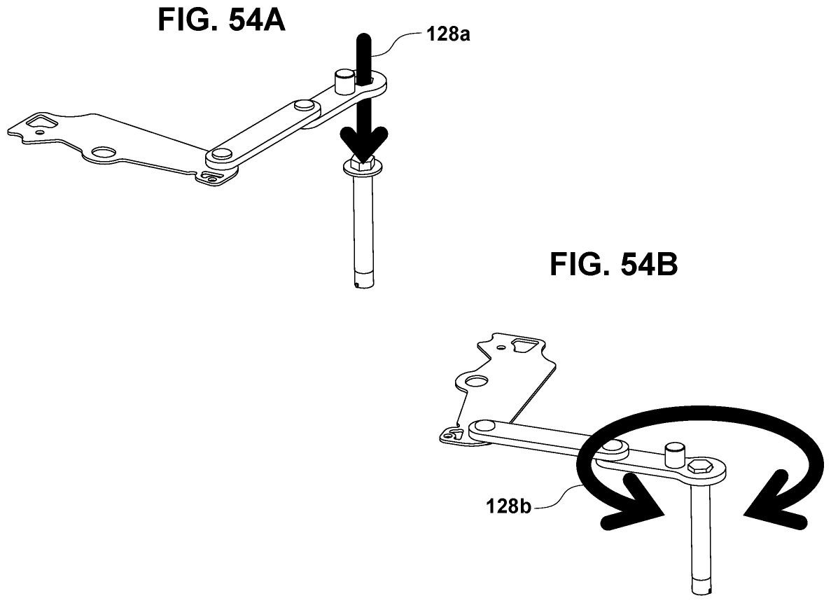

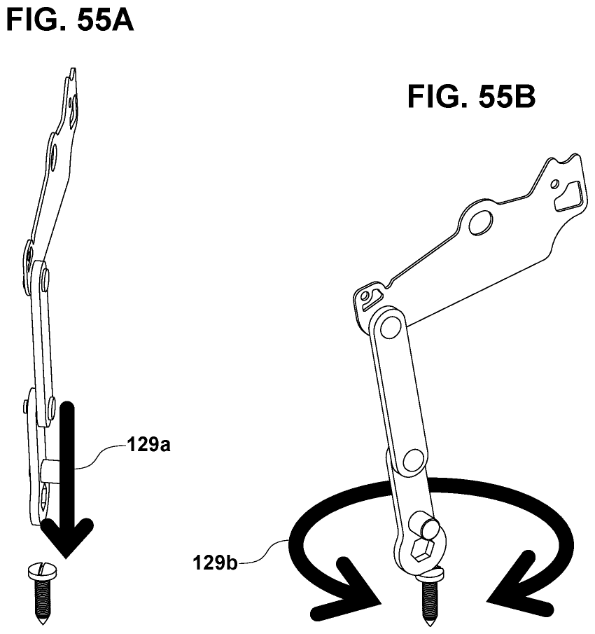

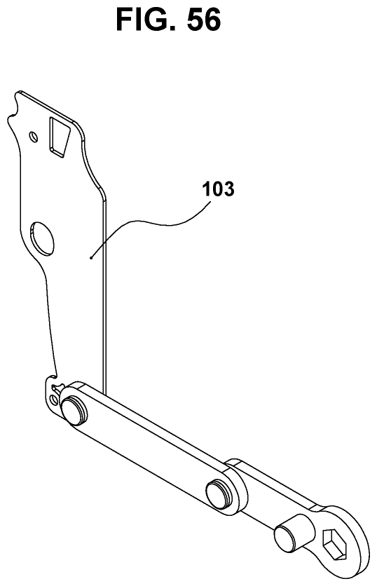

No prior art mention or disclose any compact portable storage device having multi-link crank control arm wrench 103. Therefore, the prior art of compact portable storage device is not capable of functioning as a box wrench in the directions of arrows 128a and 128b (see FIG. 54A and FIG. 54B); and not capable of functioning as a flat-head screwdriver in the directions of arrows 129a and 129b (see FIG. 55A and FIG. 55B).

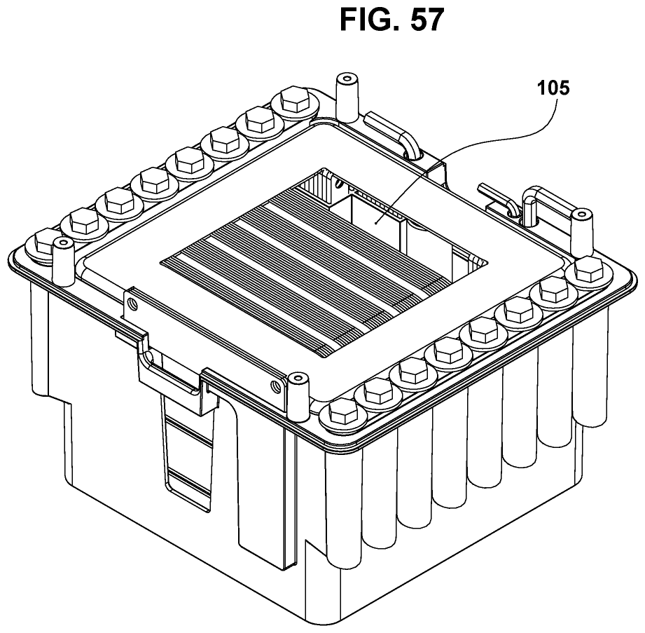

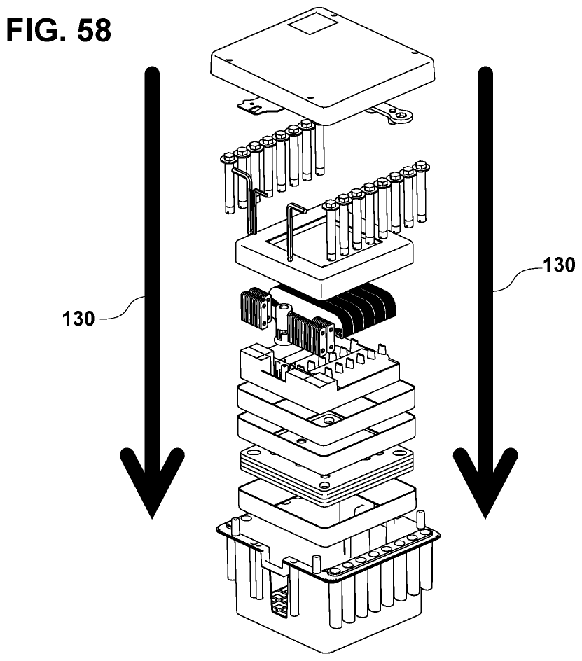

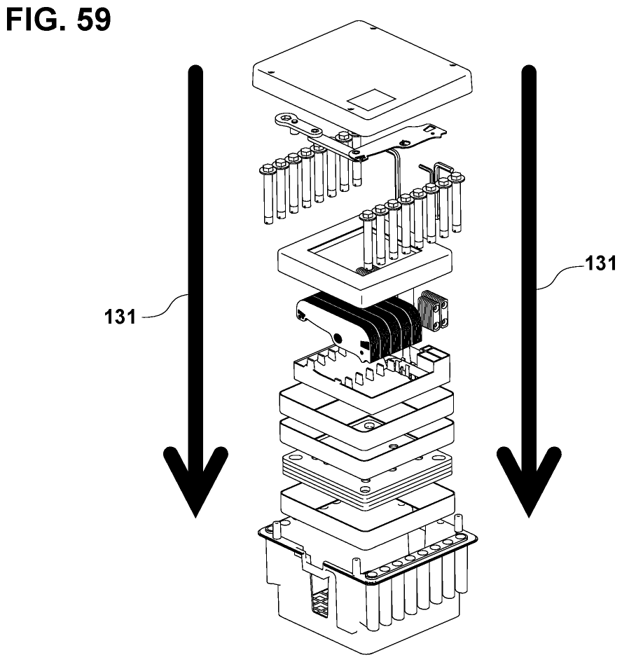

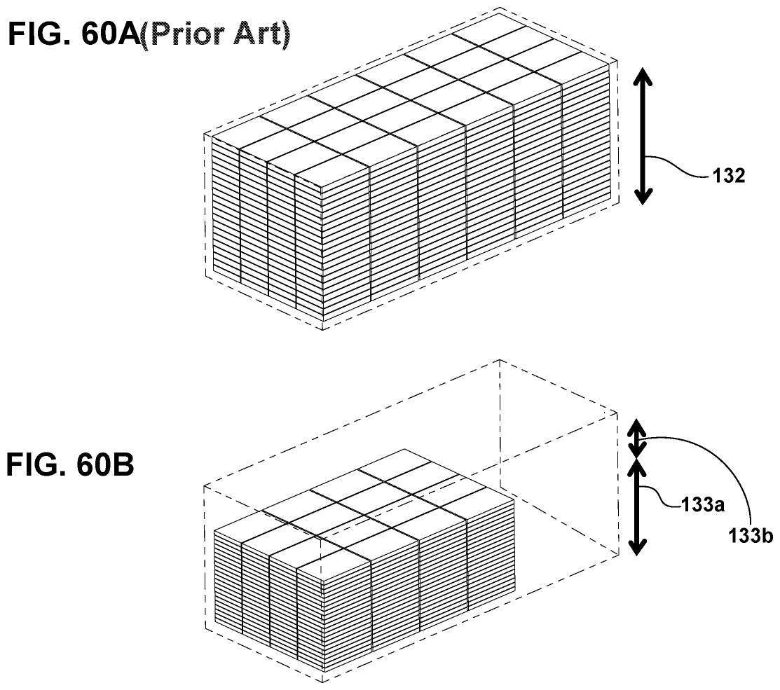

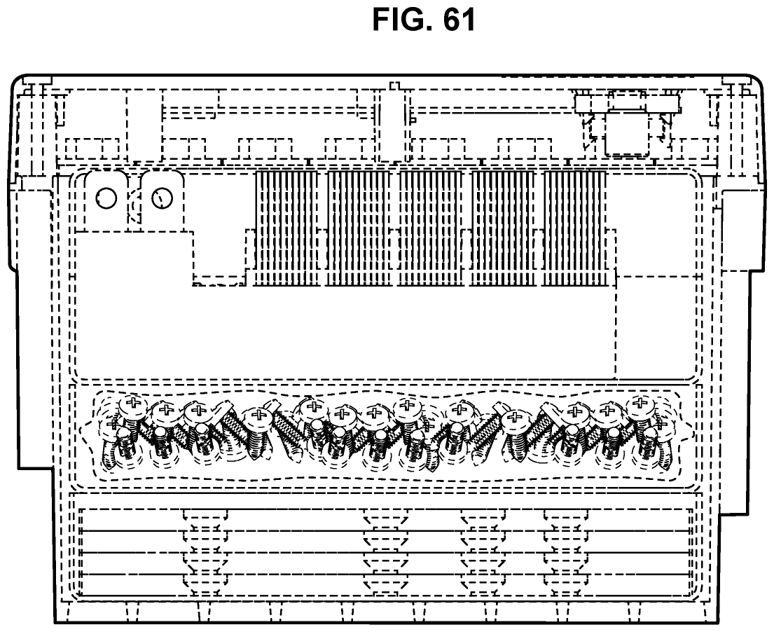

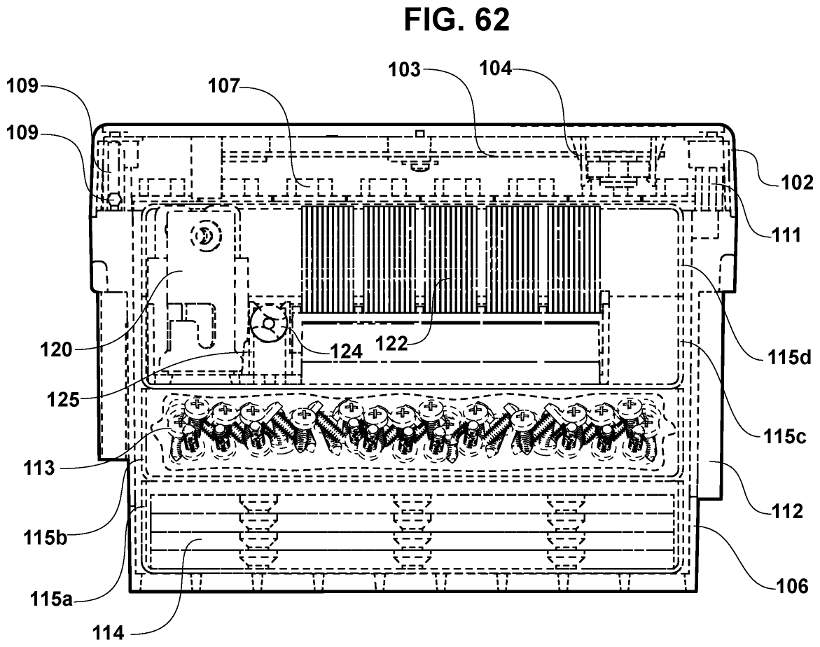

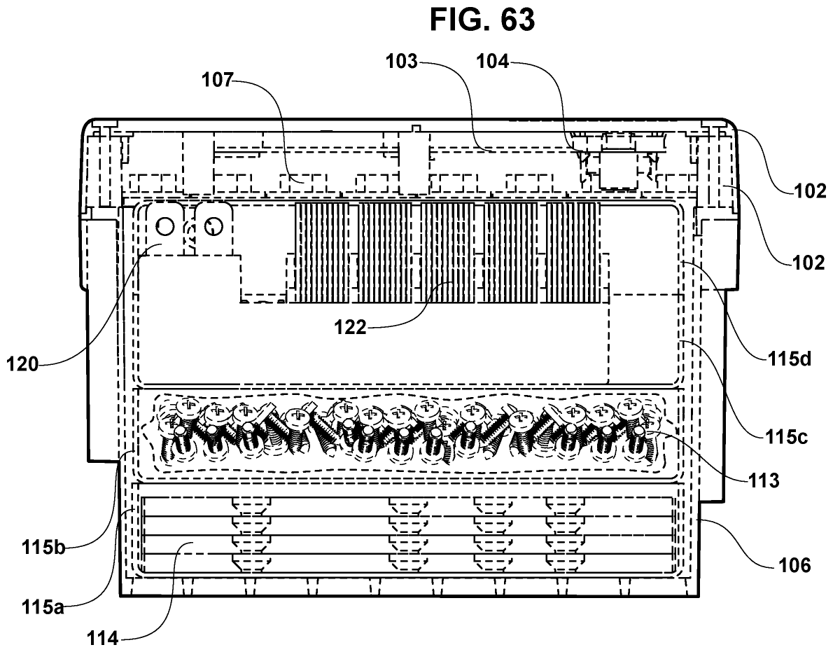

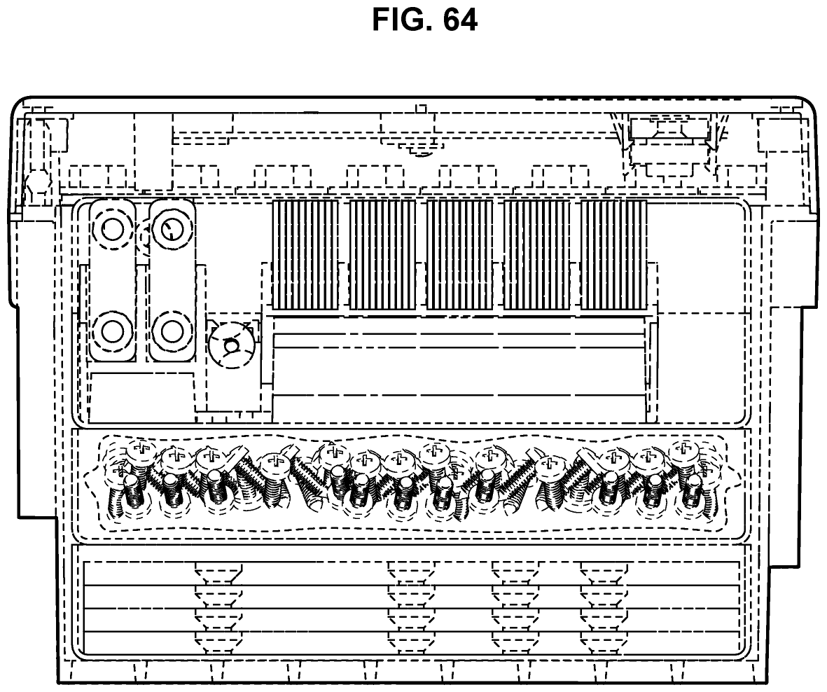

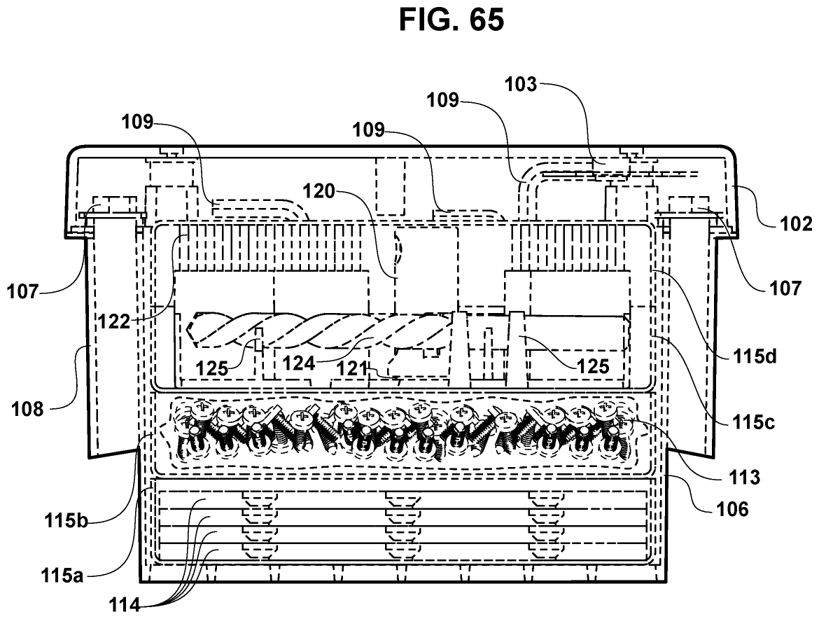

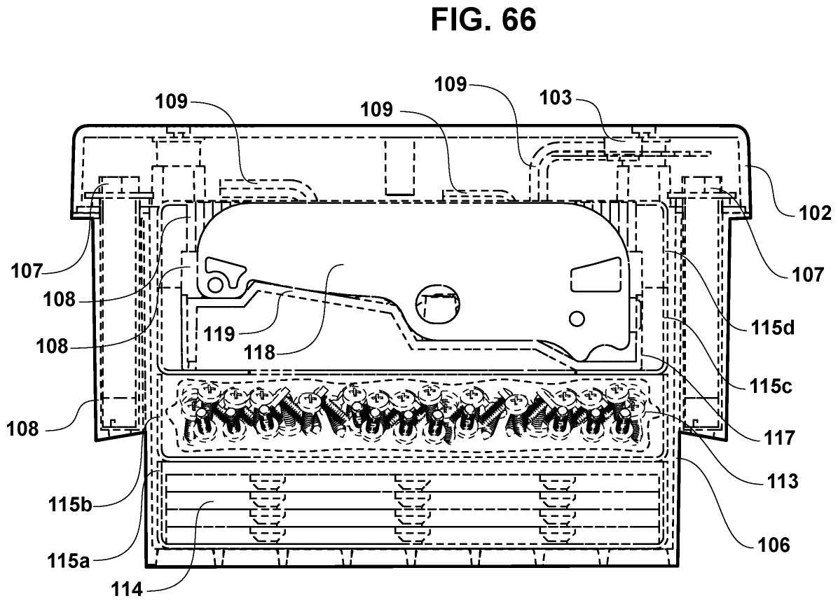

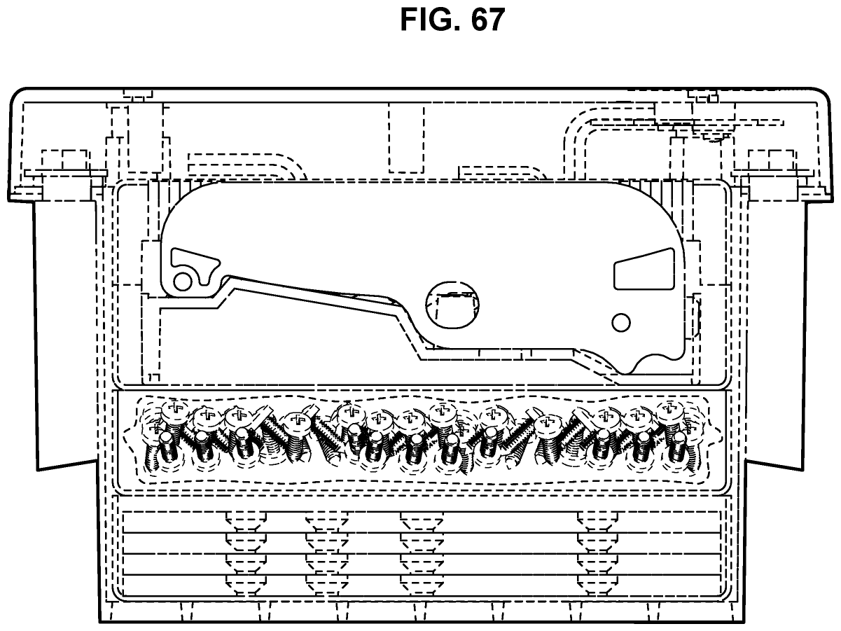

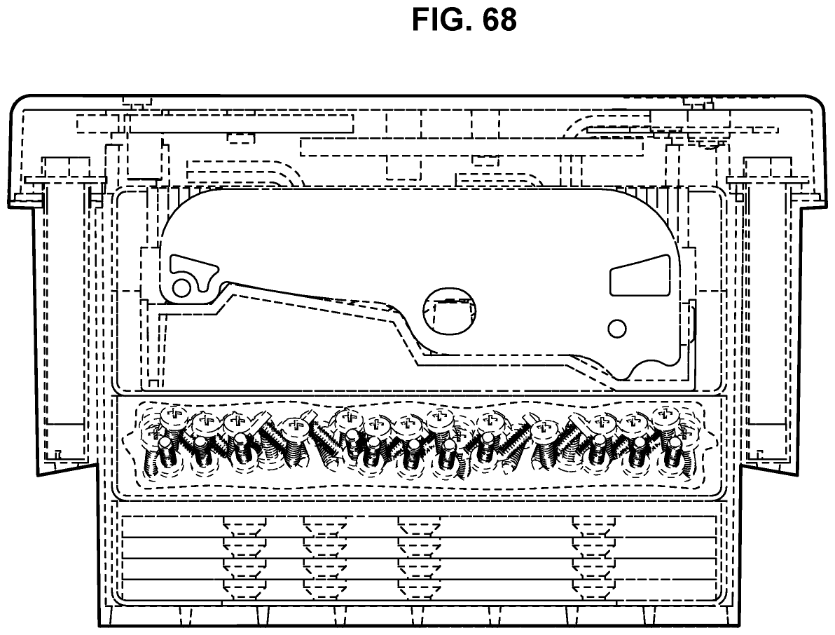

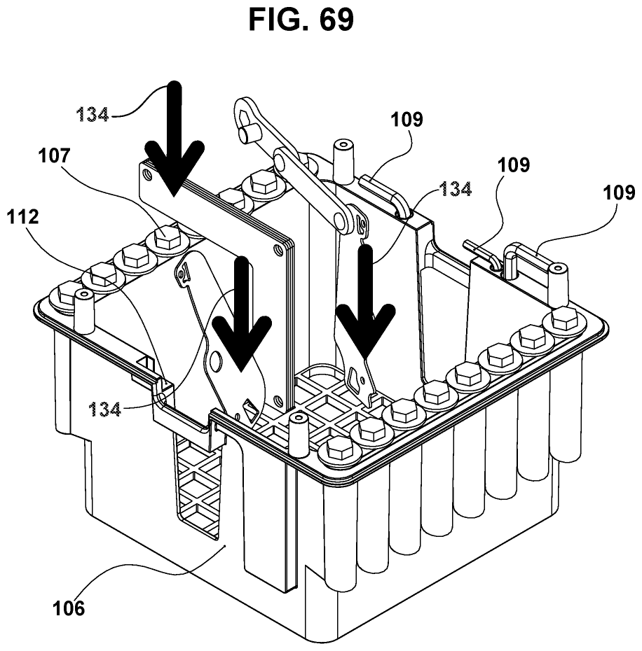

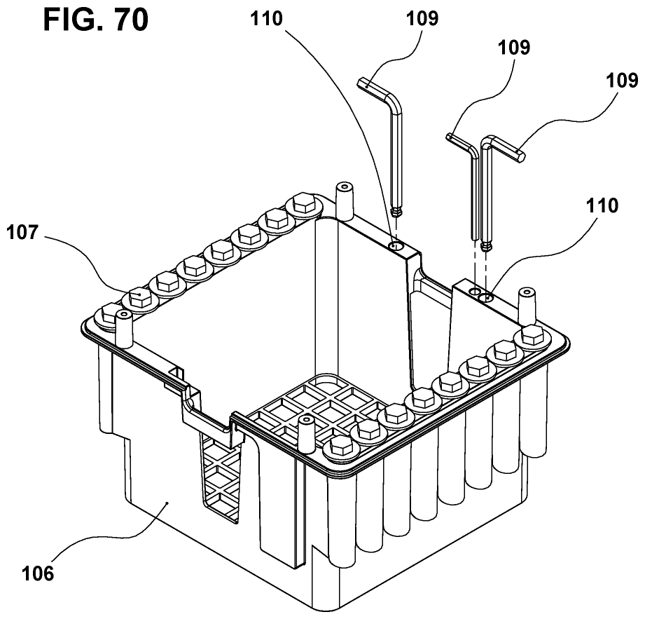

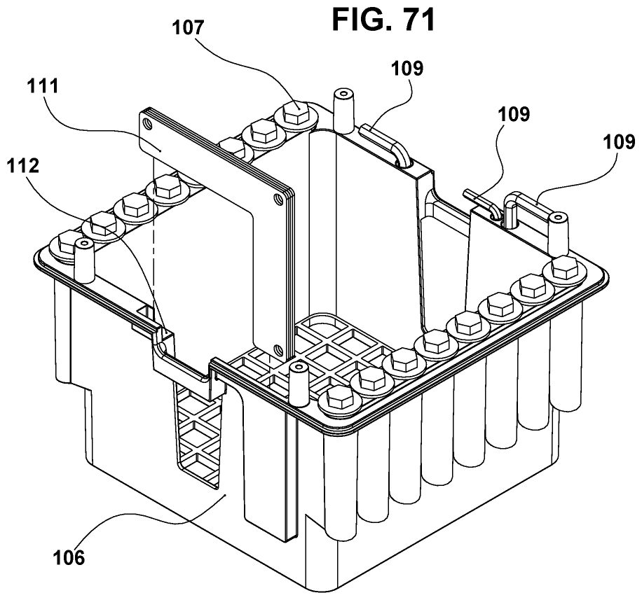

No prior art mention or disclose any compact portable storage device having compartmentalized loss-preventing storing-and-organizing tub-tray 106. Therefore, the prior art of compact portable storage device is not capable of providing a compact stackable packaging solution to allow multi-function components and tools to compactly stack on one another to save shipping space and cost in the directions of arrows 130, 131, 132, 133a, and 133b (see FIG. 57-FIG. 68); and not capable of securing and organizing multi-function components and tools to prevent loss in the direction of arrow 134 (see FIG. 69-FIG. 71.

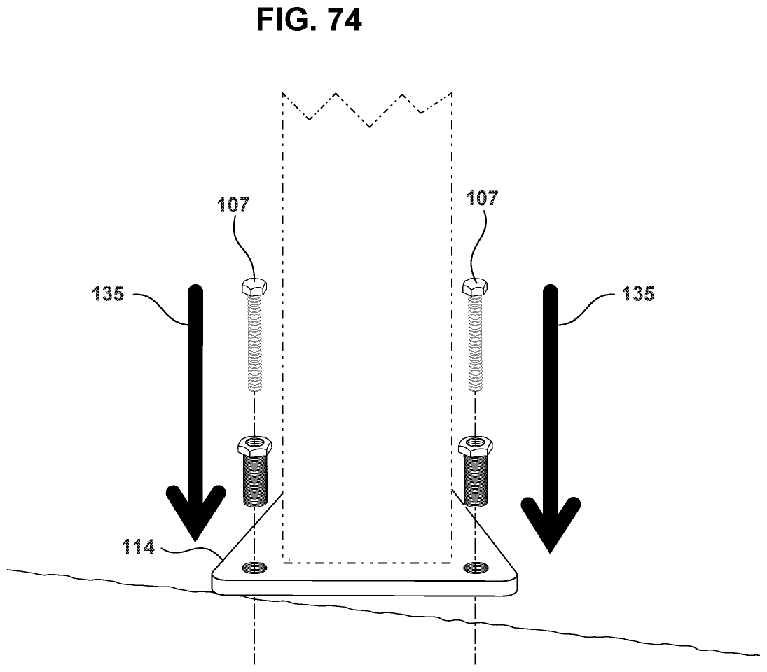

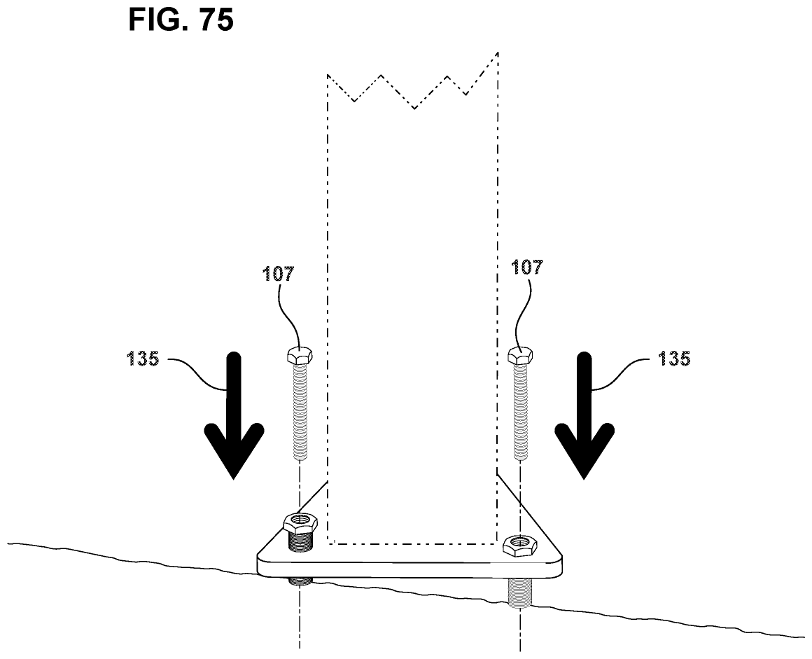

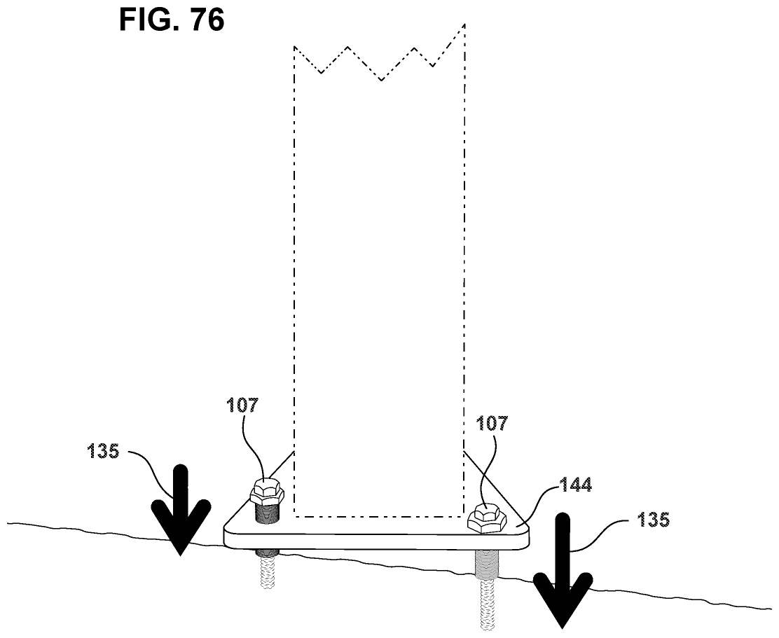

No prior art mention or disclose any compact portable storage device having ground-securing-and-leveling screws 107. Therefore, the prior art of compact portable storage device is not capable of releasably adjusting the height of base plates 114 on ground surface in the direction of arrow 135 (see FIG. 74-FIG. 76); not capable of leveling base plates 114 on ground surface in the direction of arrow 135 (see FIG. 74-FIG. 76); and not capable of securely attaching base plates 114 to ground surface in the direction of arrow 135 (see FIG. 74-FIG. 76).

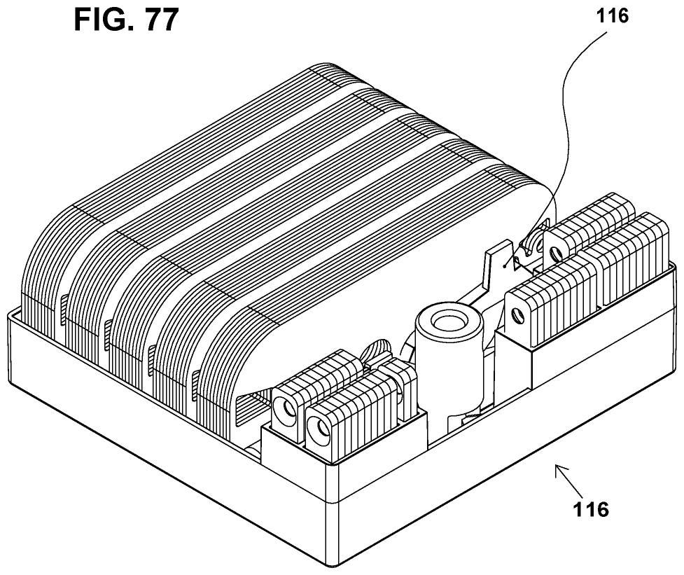

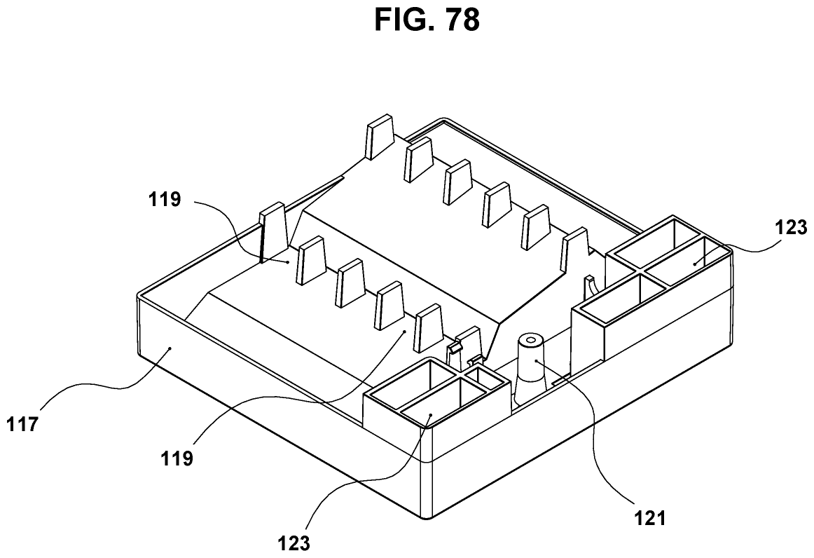

No prior art mention or disclose any compact portable storage device having compartmentalized loss-preventing storing-and-organizing inner-tray 117. Therefore, the prior art of compact portable storage device is not capable of providing a compact stackable packaging solution to allow multi-function components and tools to compactly stack on one another to save shipping space and cost in the directions of arrows 130, 131, 132, 133a, and 133b (see FIG. 57-FIG. 68); not capable of organizing and storing multi-function components and tools to prevent loss in the direction of arrow 136 (see FIG. 77-FIG. 84); not capable of securing multi-function components and tools during shipping (see FIG. 77-FIG. 84); and not capable of preventing loss by functioning as a tray to secure multi-function components and tools during assembly in the direction of arrow 136 (see FIG. 77-FIG. 84).

Some embodiments of the present invention substantially depart from the conventional concepts and designs of the prior art. In doing so, some embodiments provide a compact portable 5-device-in-one space-saving cost-saving production-increasing assembly-time-decreasing multi-function-component box (which can be made as compactly small as 2 inches wide by 2 inches long by 2 inches high), having many unique and significant features, functions, and advantages, which overcome some or all the disadvantages of the prior art, as follows:

It is an object of some embodiments to provide a 5-device-in-one space-saving cost-saving production-increasing assembly-time-decreasing multi-function-component box, having multi-function loss-preventing storing-and-organizing lid-tray 102. Therefore, the 5-device-in-one space-saving cost-saving production-increasing assembly-time-decreasing multi-function-component box may be capable of preventing loss by being turn over during assembly to function as a tray for securely containing multi-link crank control arm wrench 103, Allen wrench 109, screws 113, louver end-caps 118, crank-handle coupler 120, drill bit 124, etc. in the directions of arrows 126 and 136 (see FIGS. 52, 77-84); and capable of providing a secure location on its under surface to clamp on and store multi-link crank control arm wrench 103 during shipping in the directions of arrow 127 (see FIG. 53).

It is another object of some embodiments to provide a 5-device-in-one space-saving cost-saving production-increasing assembly-time-decreasing multi-function-component box, having multi-link crank control arm wrench 103. Therefore, the 5-device-in-one space-saving cost-saving production-increasing assembly-time-decreasing multi-function-component box may be capable of functioning as a box wrench in the directions of arrows 128a and 128b (see FIG. 54A and FIG. 54B); and capable of functioning as a flat-head screwdriver in the directions of arrows 129a and 129b (see FIG. 55A and FIG. 55B).

It is still another object of some embodiments to provide a 5-device-in-one space-saving cost-saving production-increasing assembly-time-decreasing multi-function-component box, having compartmentalized loss-preventing storing-and-organizing tub-tray 106. Therefore, the 5-device-in-one space-saving cost-saving production-increasing assembly-time-decreasing multi-function-component box may be capable of providing a compact stackable packaging solution to allow multi-function components and tools to compactly stack on one another to save shipping space and cost in the directions of arrows 130, 131, 132, 133a, and 133b (see FIG. 57-FIG. 68); and capable of securing and organizing multi-function components and tools to prevent loss in the direction of arrow 134 (see FIG. 69-FIG. 71.

It is yet still another object of some embodiments to provide a 5-device-in-one space-saving cost-saving production-increasing assembly-time-decreasing multi-function-component box, having ground-securing-and-leveling screws 107. Therefore, the 5-device-in-one space-saving cost-saving production-increasing assembly-time-decreasing multi-function-component box may be capable of releasably adjusting the height of base plates 114 on ground surface in the direction of arrow 135 (see FIG. 74-FIG. 76); capable of leveling base plates 114 on ground surface in the direction of arrow 135 (see FIG. 74-FIG. 76); and capable of securely attaching base plates 114 to ground surface in the direction of arrow 135 (see FIG. 74-FIG. 76).

It is a further object of some embodiments to provide a 5-device-in-one space-saving cost-saving production-increasing assembly-time-decreasing multi-function-component box, having compartmentalized loss-preventing storing-and-organizing inner-tray 117. Therefore, the 5-device-in-one space-saving cost-saving production-increasing assembly-time-decreasing multi-function-component box may be capable of providing a compact stackable packaging solution to allow multi-function components and tools to compactly stack on one another to save shipping space and cost in the directions of arrows 130, 131, 132, 133a, and 133b (see FIG. 57-FIG. 68); capable of organizing and storing multi-function components and tools to prevent loss in the direction of arrow 136 (see FIG. 77-FIG. 84); capable of securing multi-function components and tools during shipping (see FIG. 77-FIG. 84); and capable of preventing loss by functioning as a tray to secure multi-function components and tools during assembly in the direction of arrow 136 (see FIG. 77-FIG. 84).

In an embodiment, the 5-device-in-one space-saving cost-saving production-increasing assembly-time-decreasing multi-function-component box (which can be made as compactly small as 2 inches wide by 2 inches long by 2 inches high) may include a multi-function loss-preventing storing-and-organizing lid-tray system 101, a compartmentalized loss-preventing storing-and-organizing tub-tray system 105, and/or a compartmentalized loss-preventing storing-and-organizing inner-tray system 116.

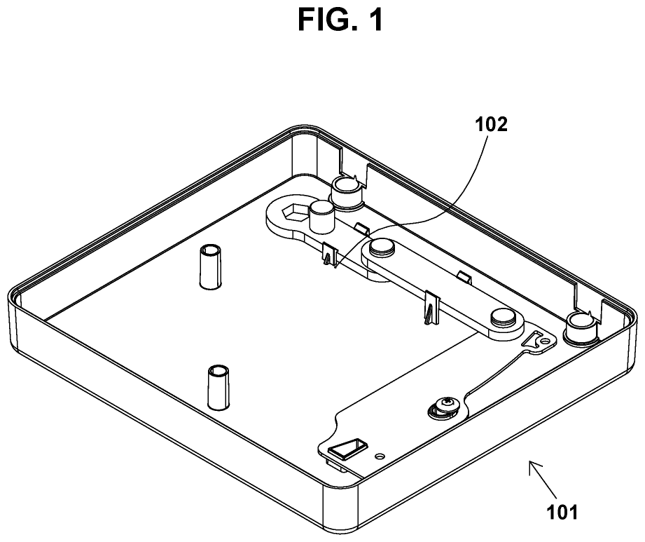

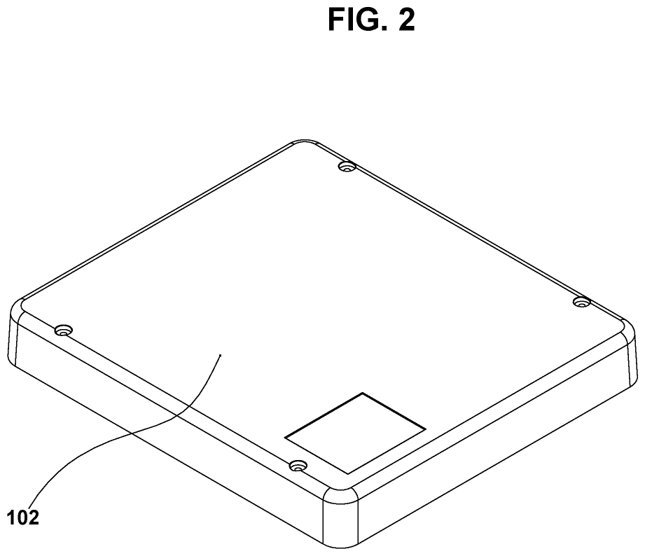

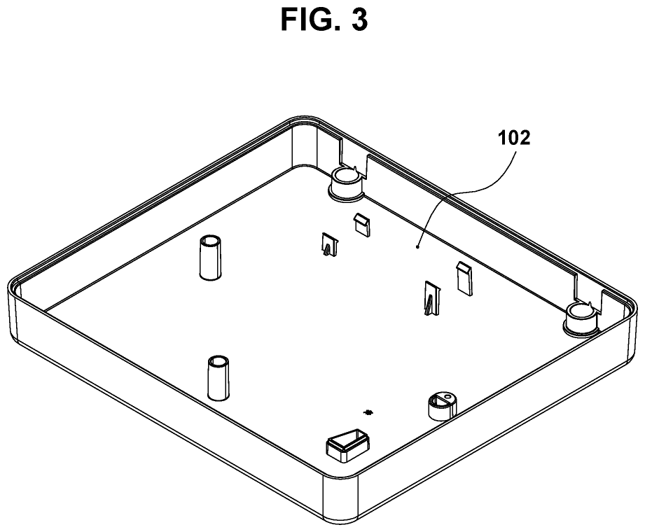

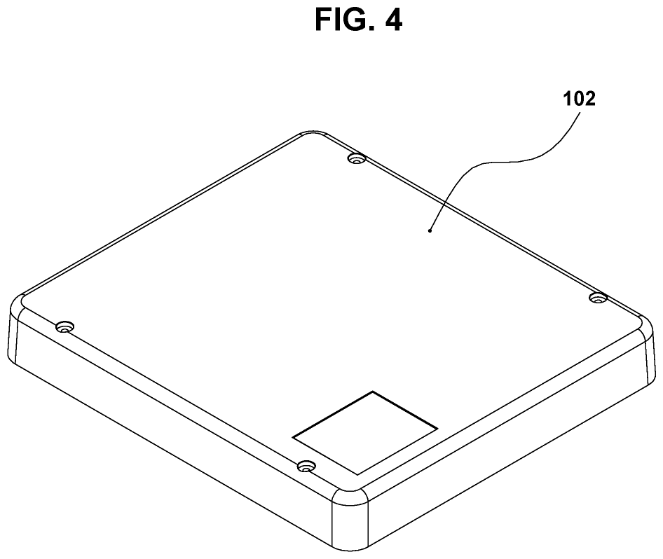

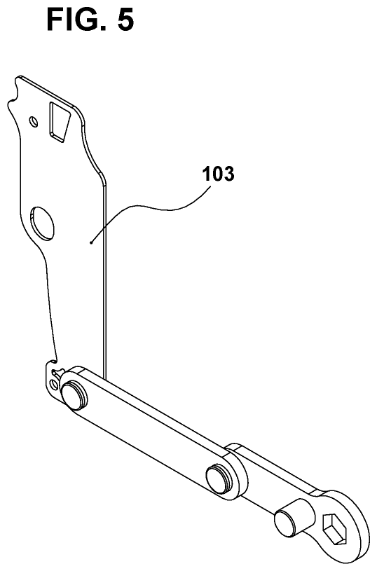

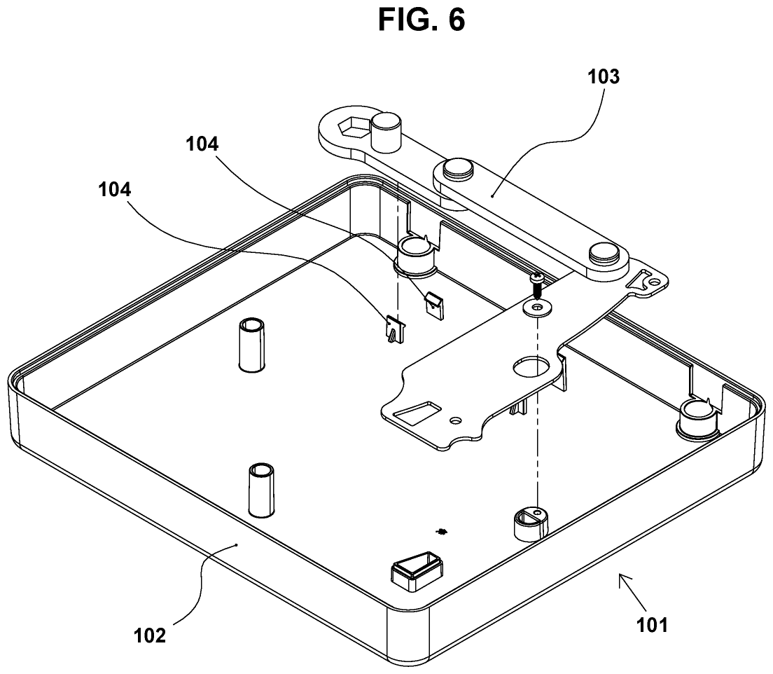

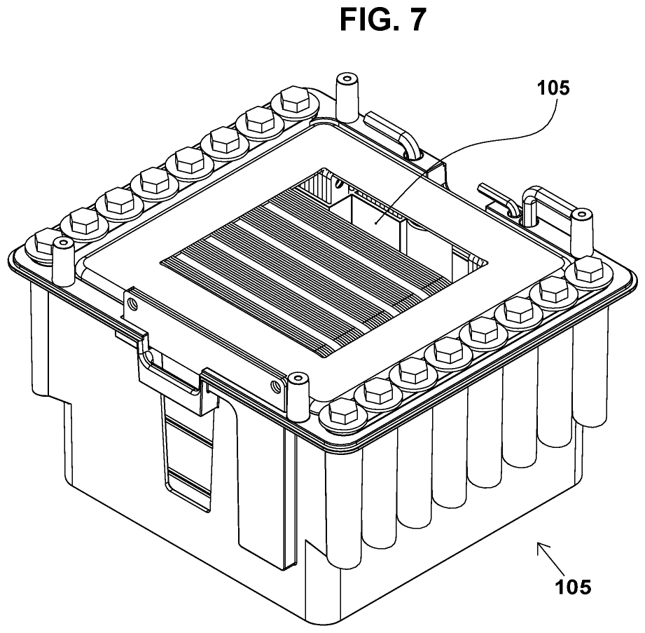

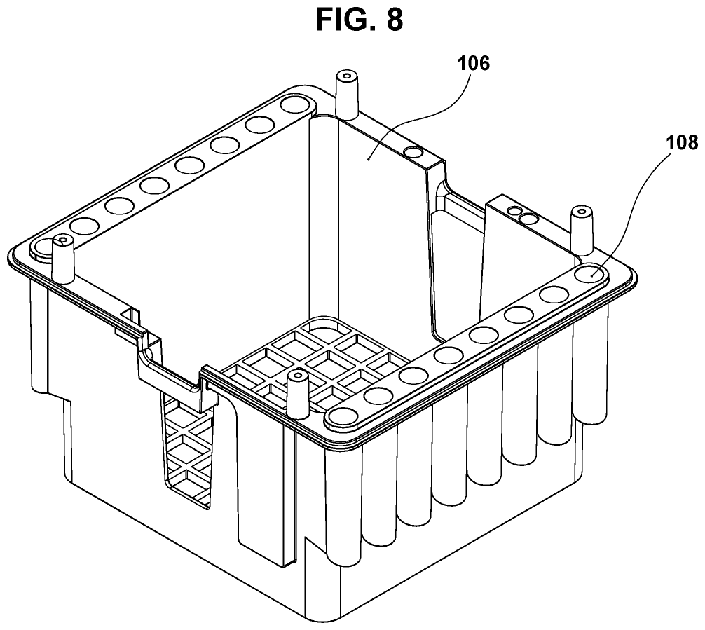

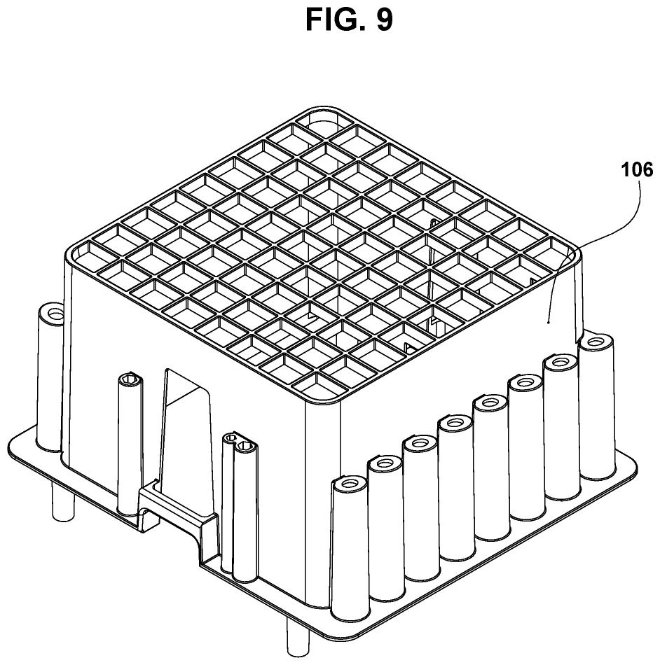

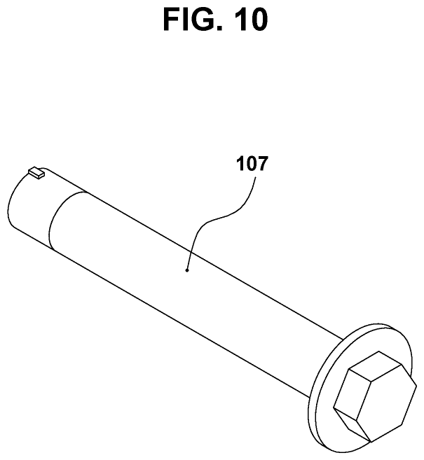

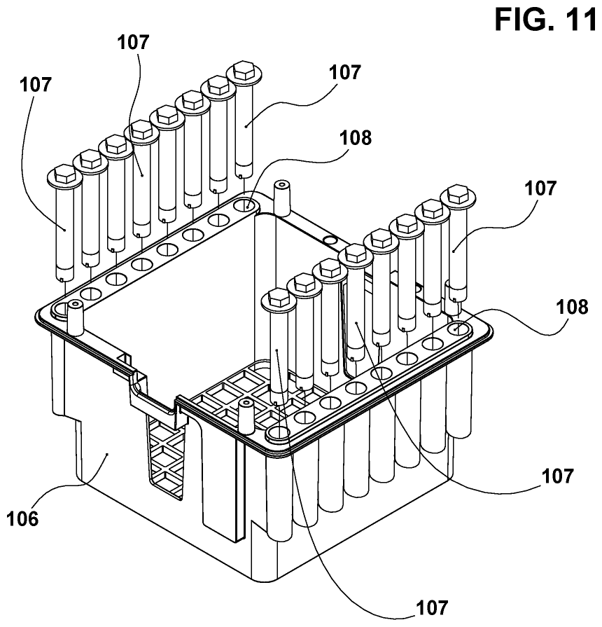

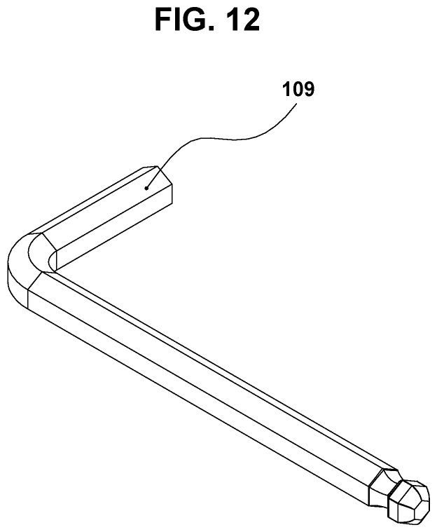

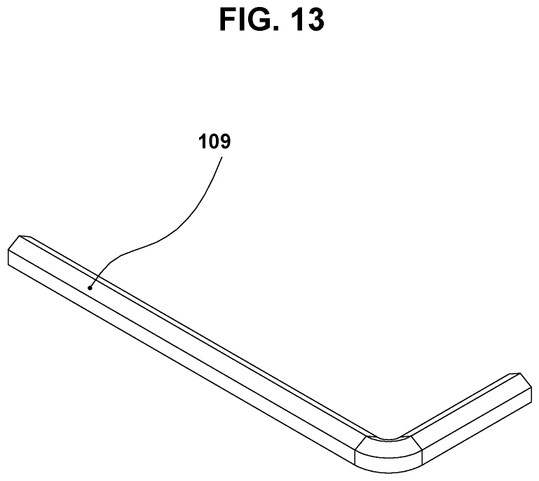

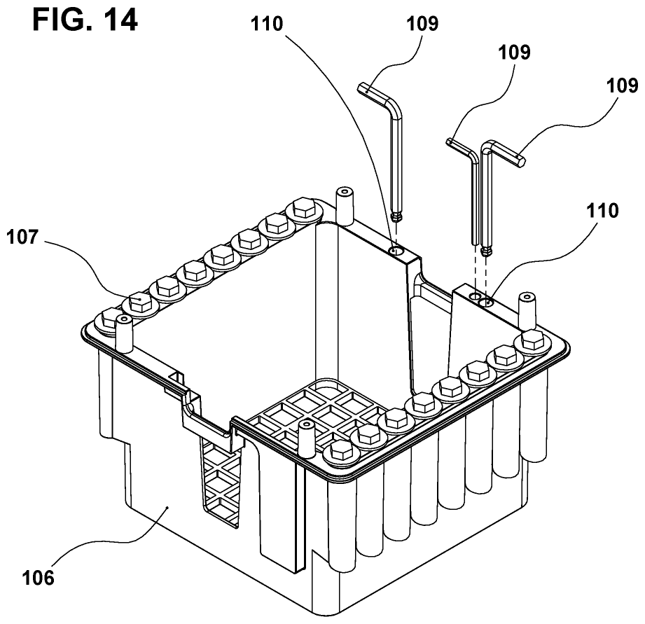

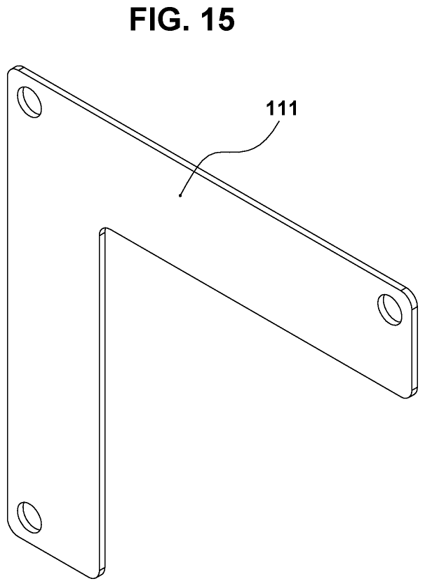

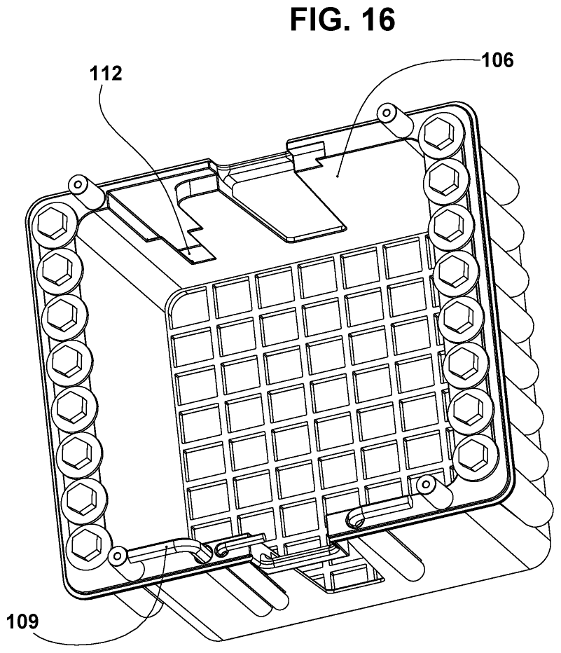

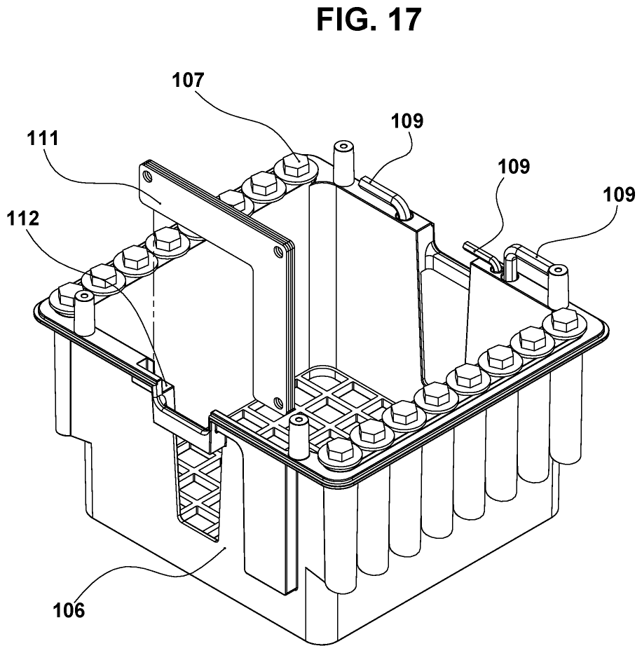

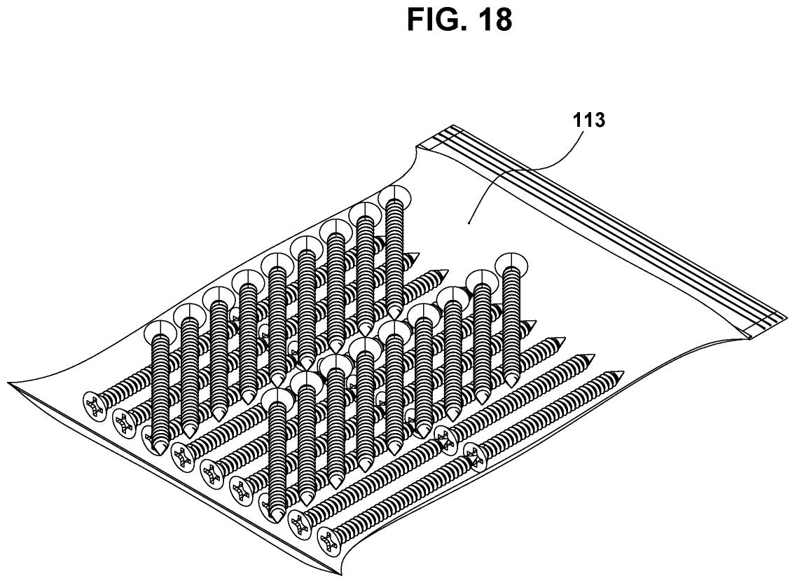

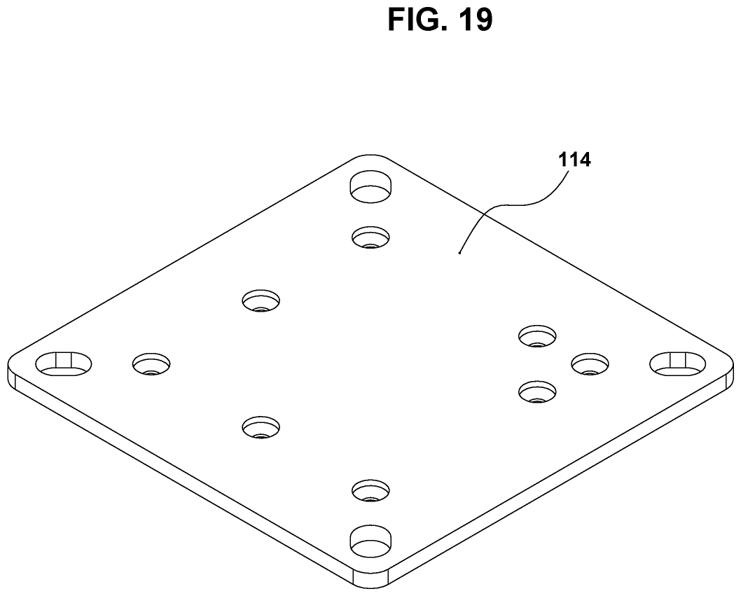

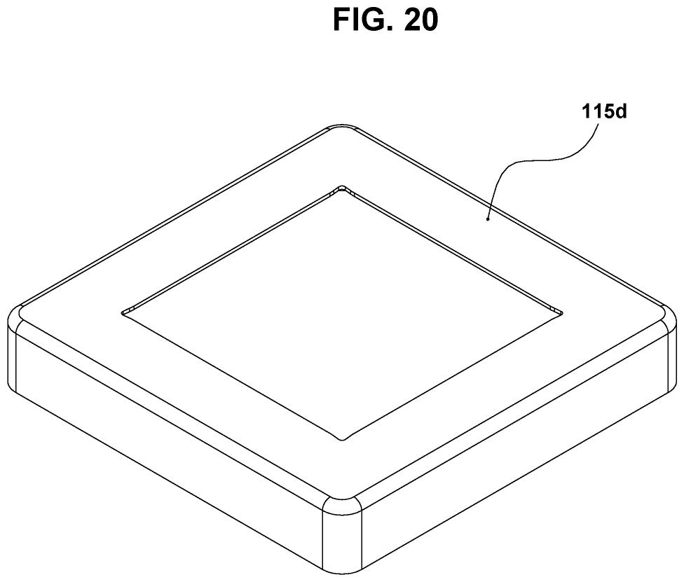

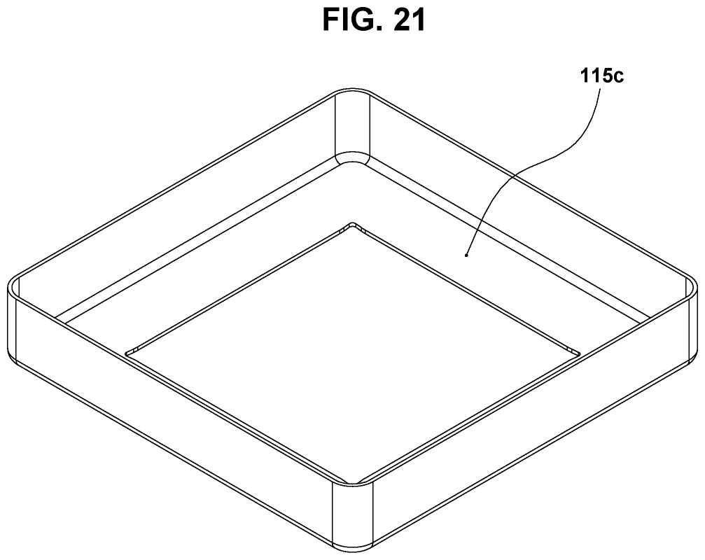

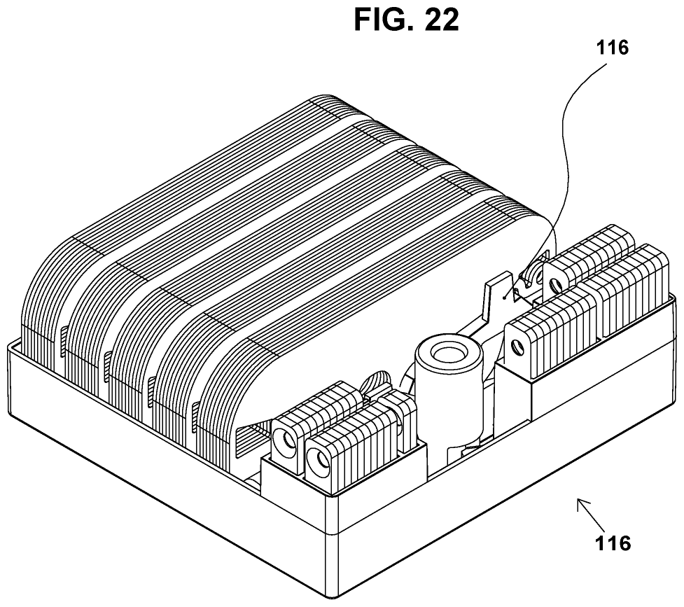

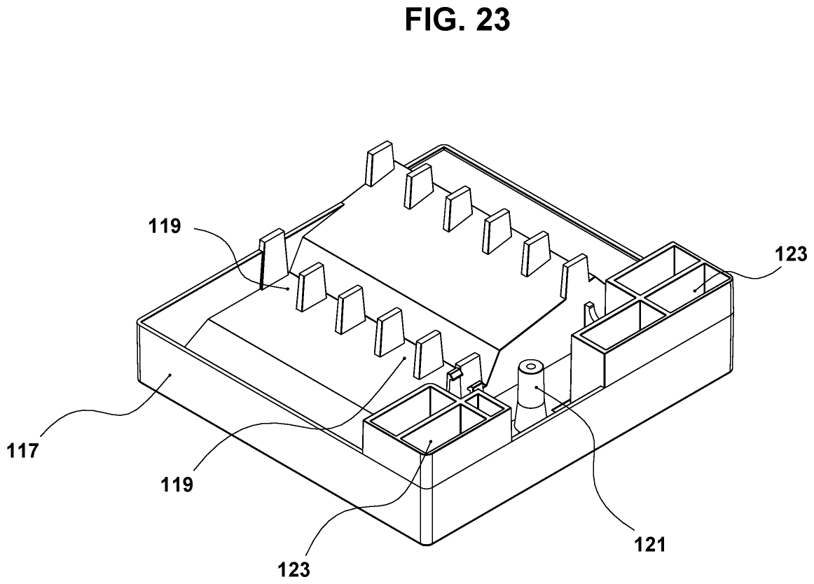

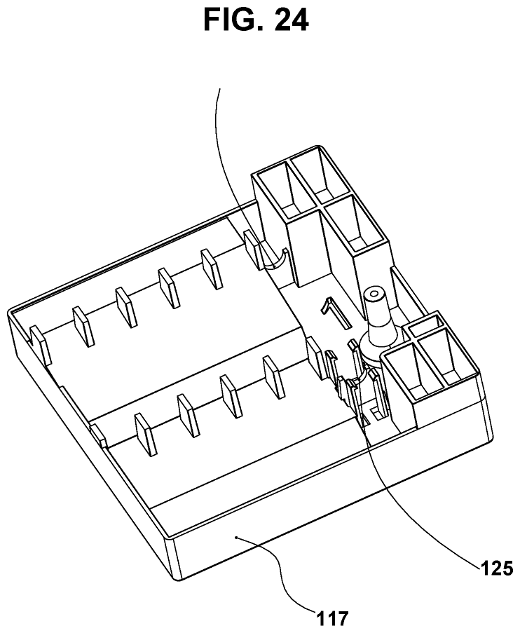

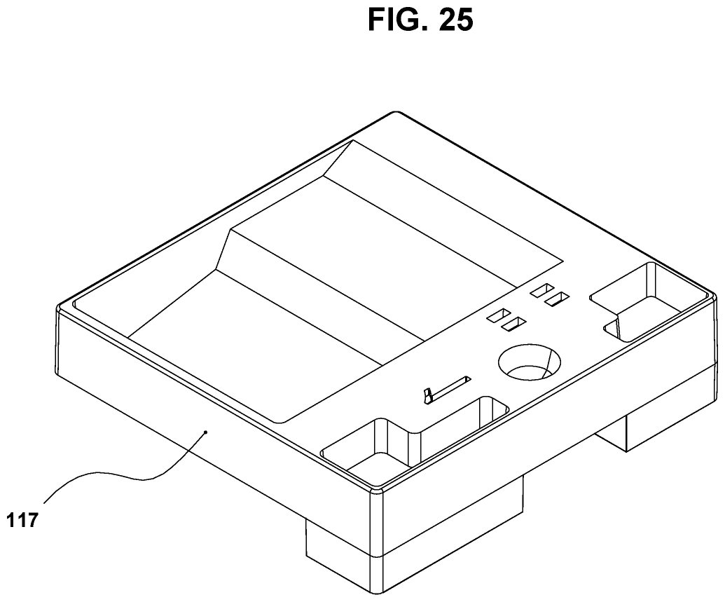

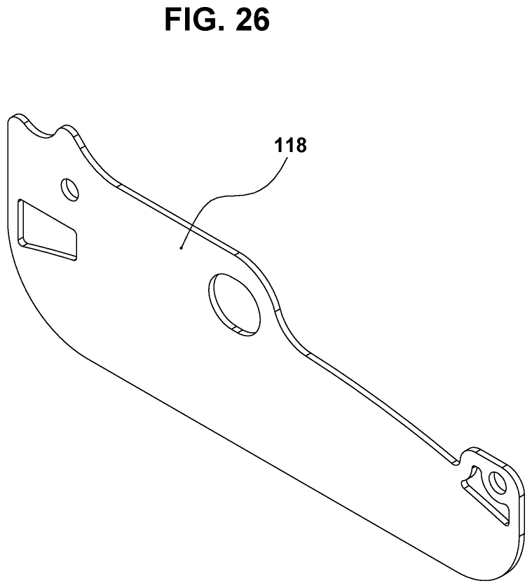

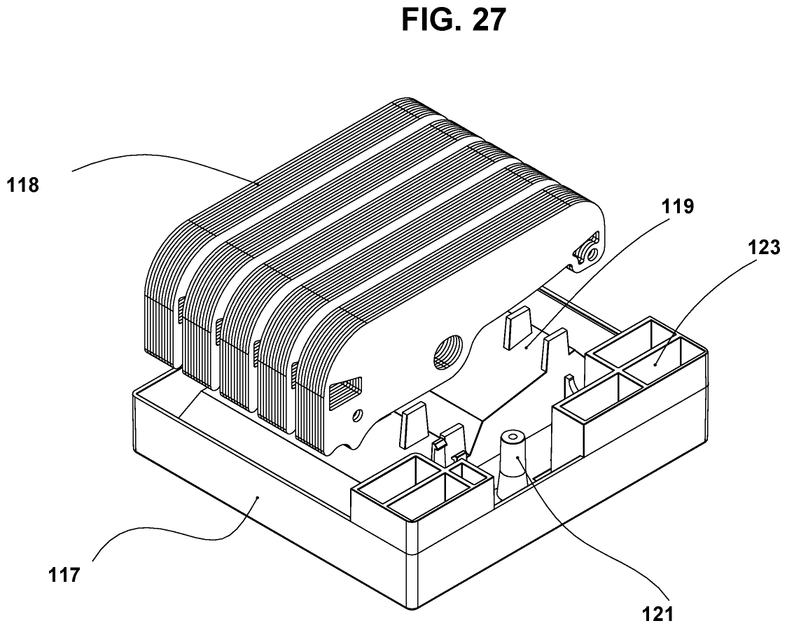

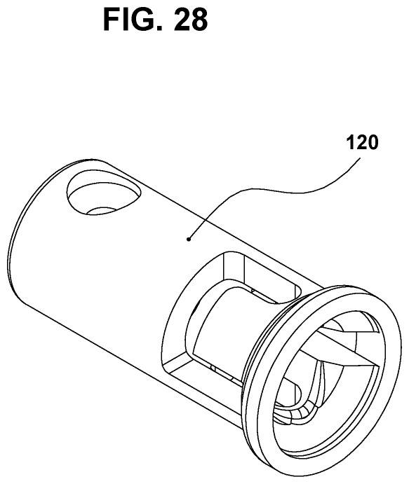

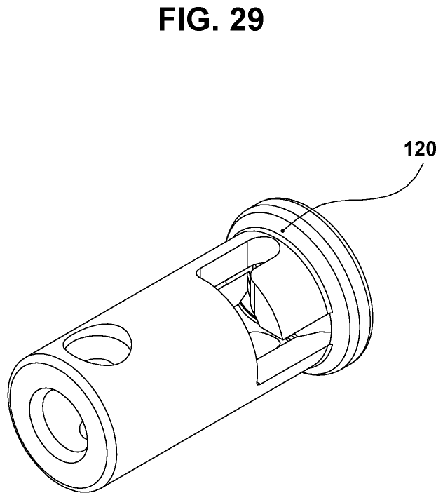

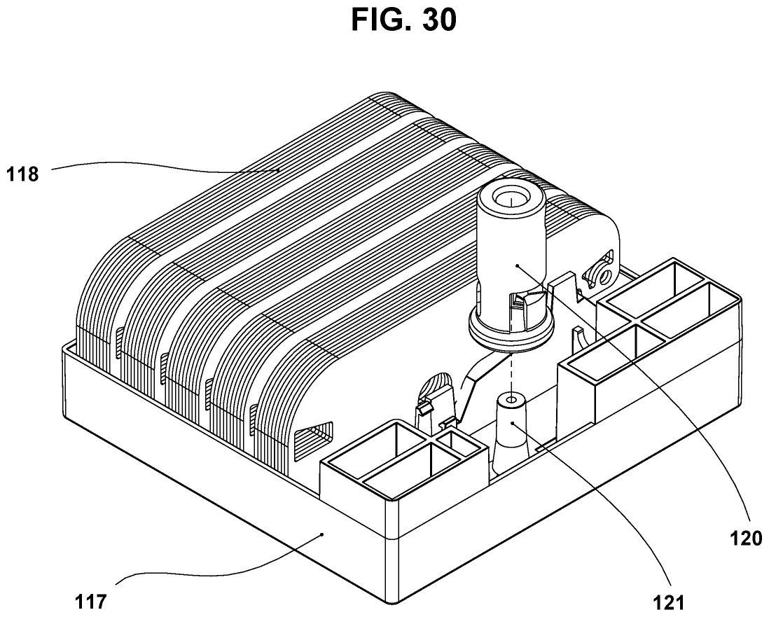

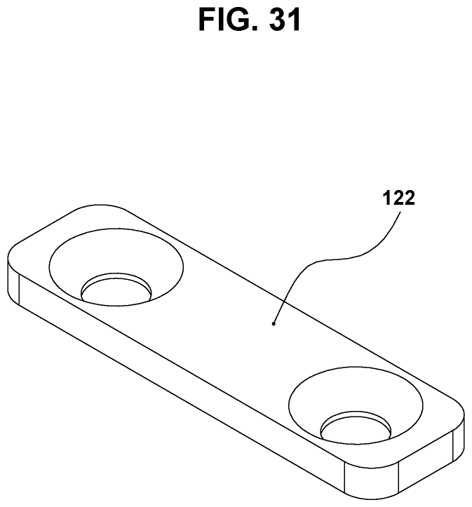

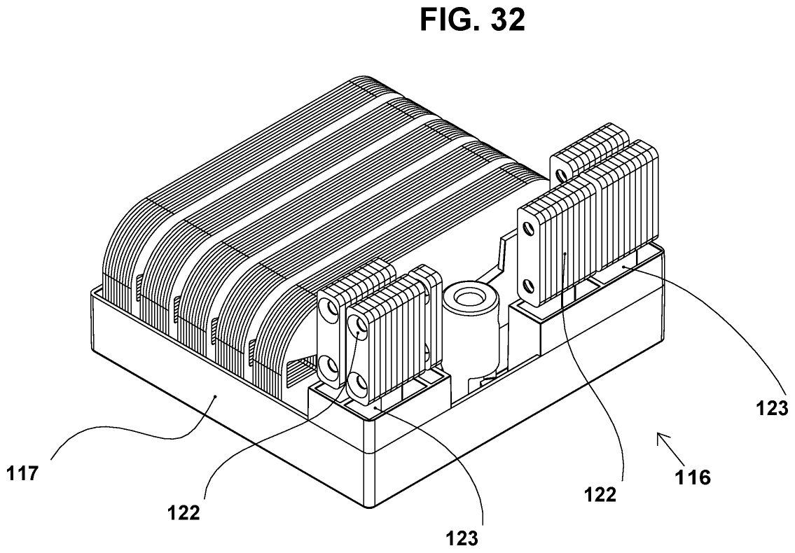

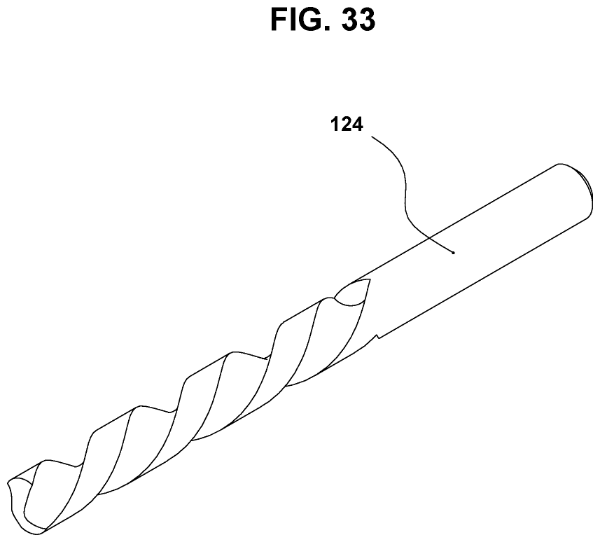

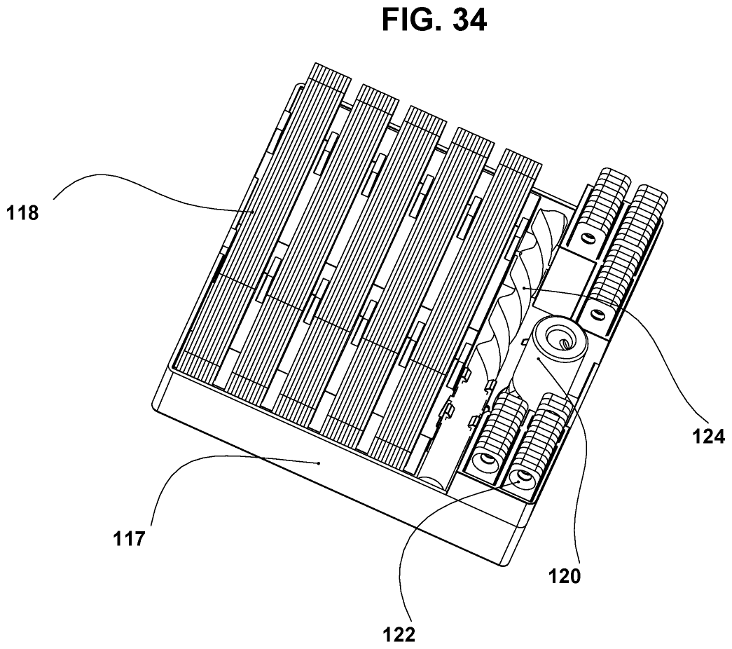

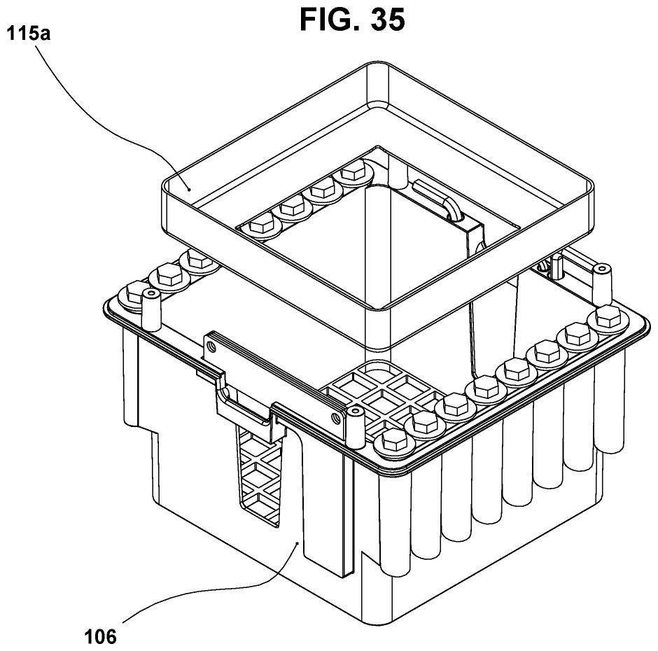

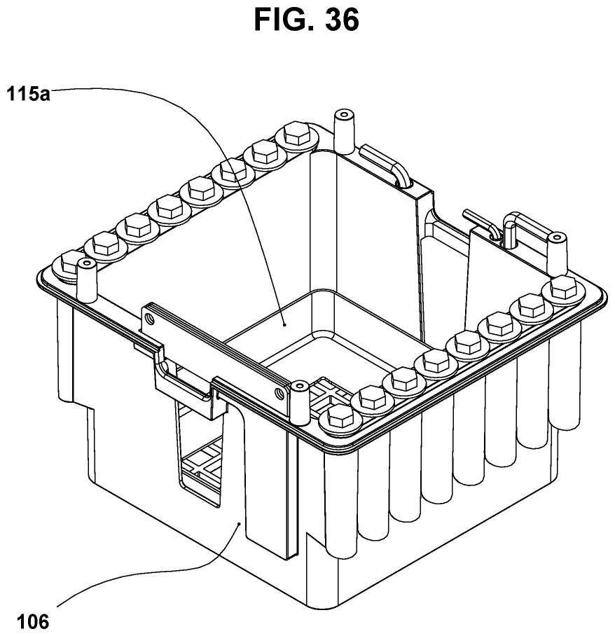

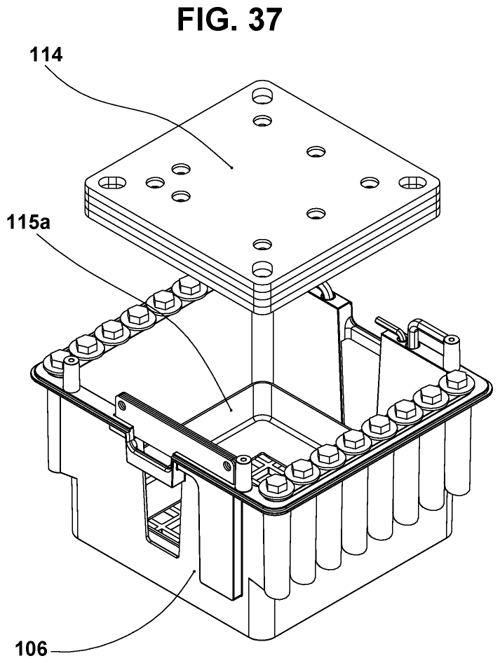

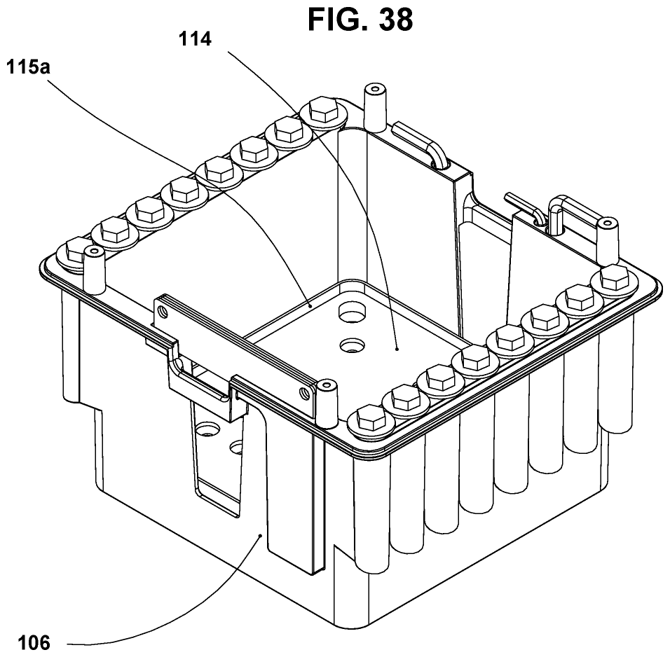

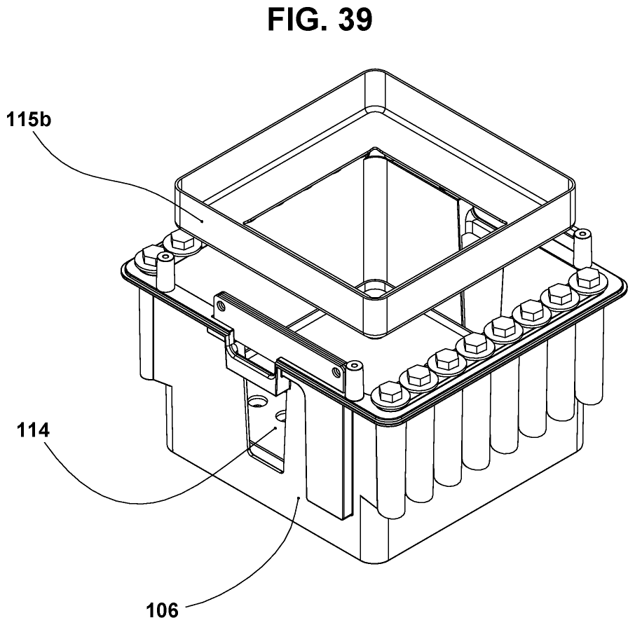

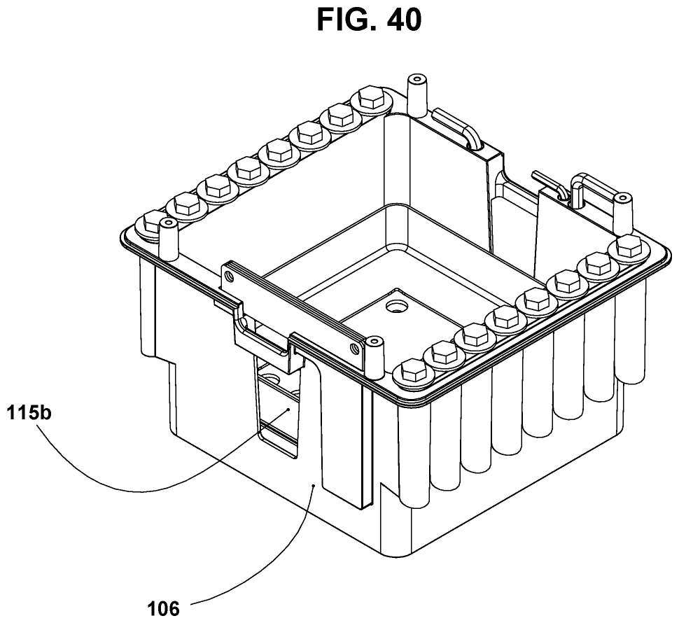

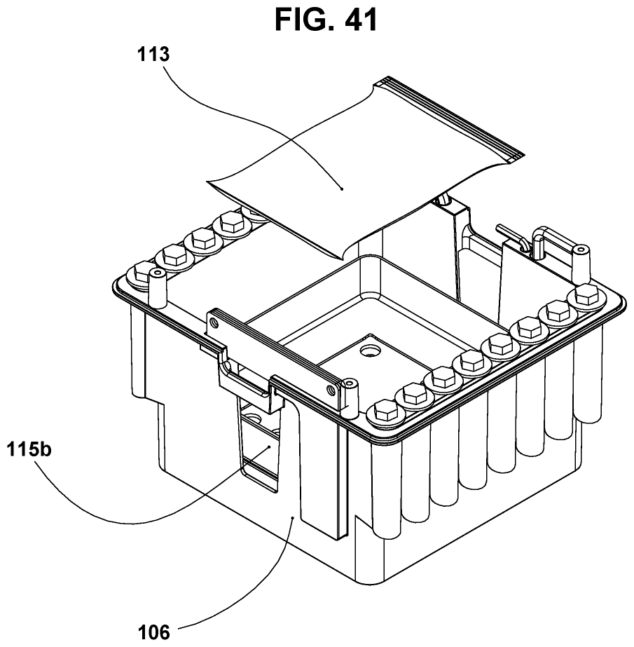

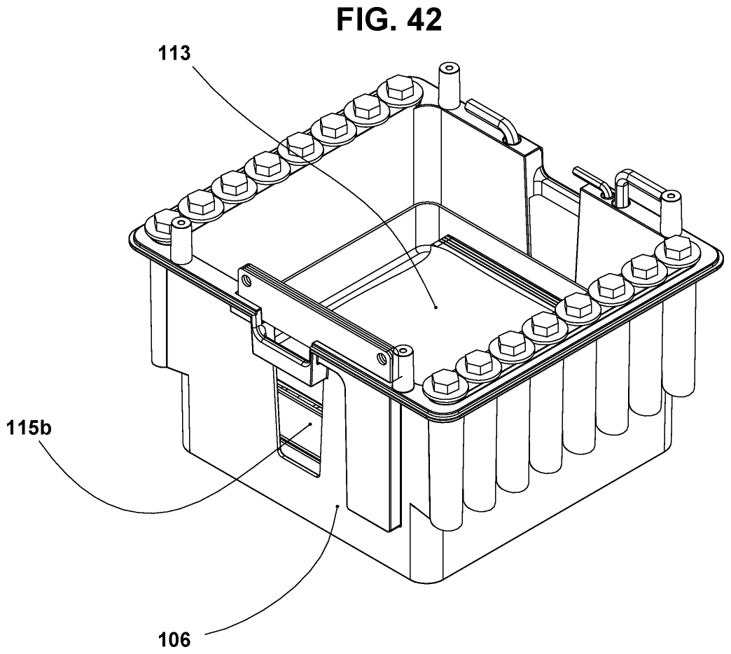

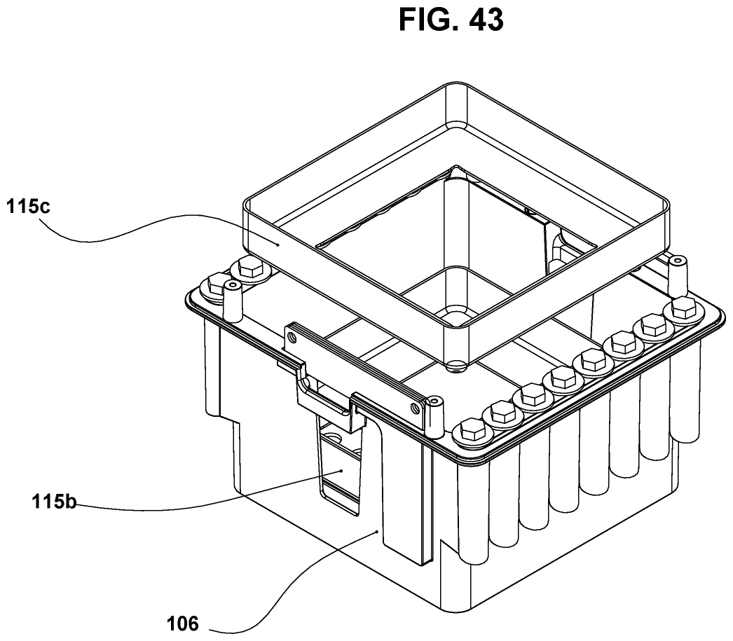

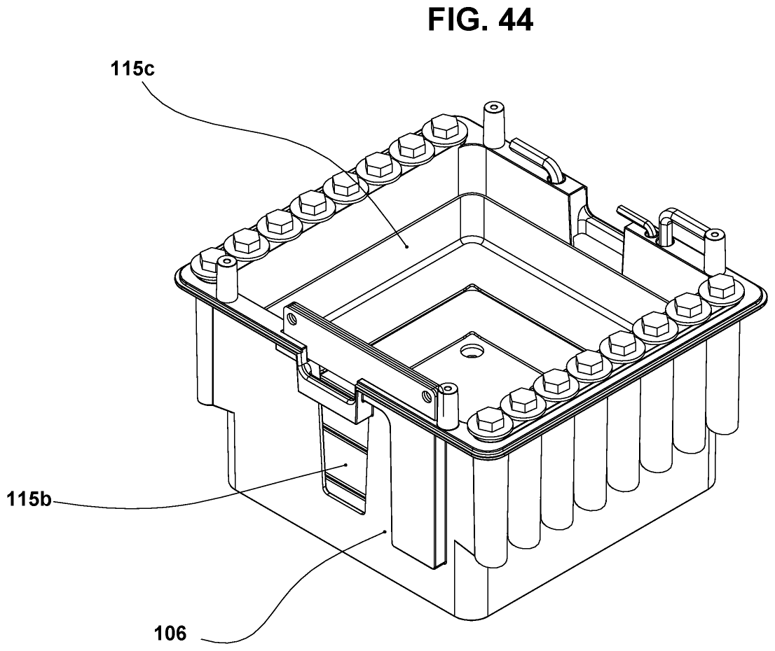

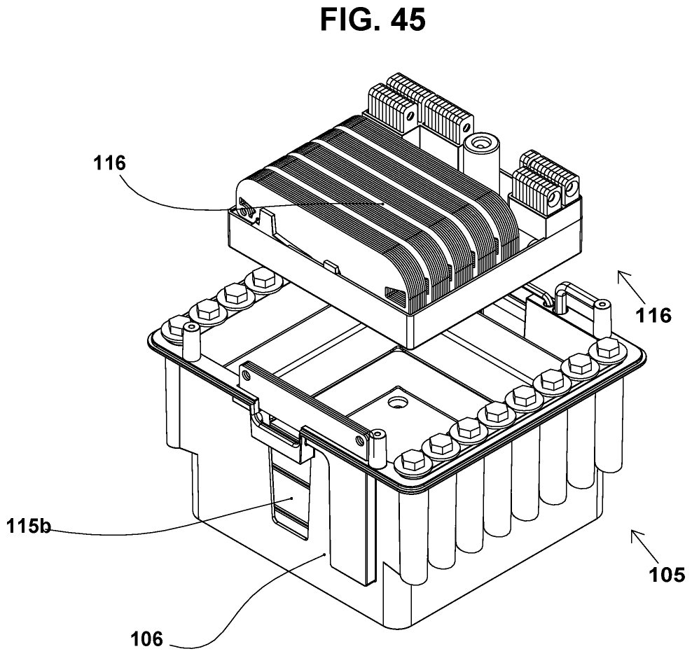

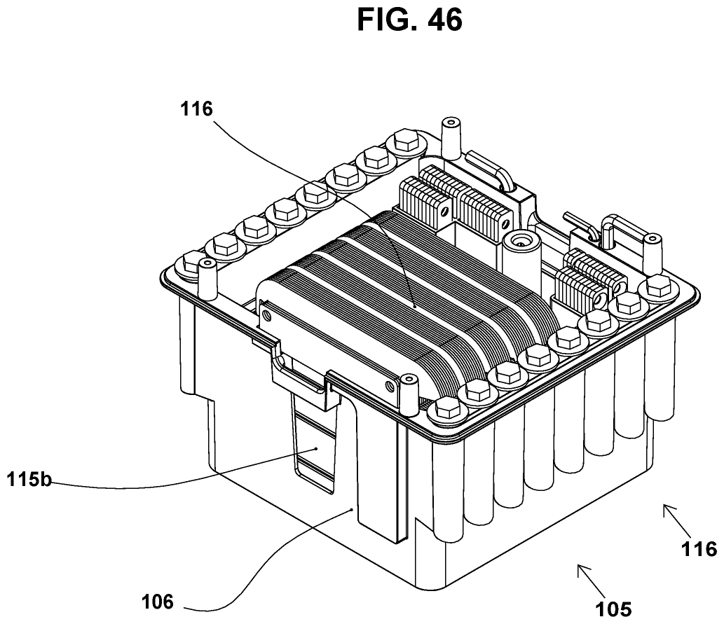

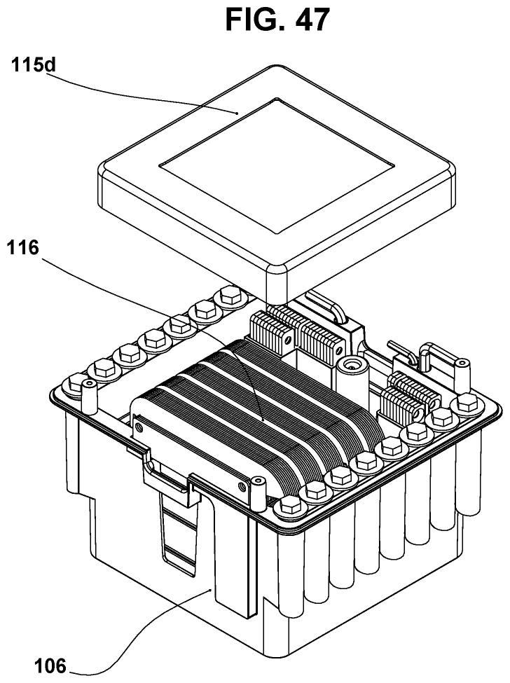

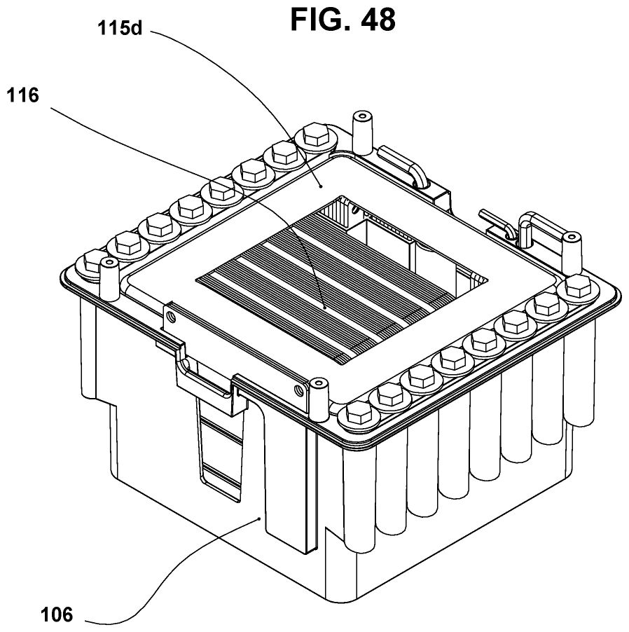

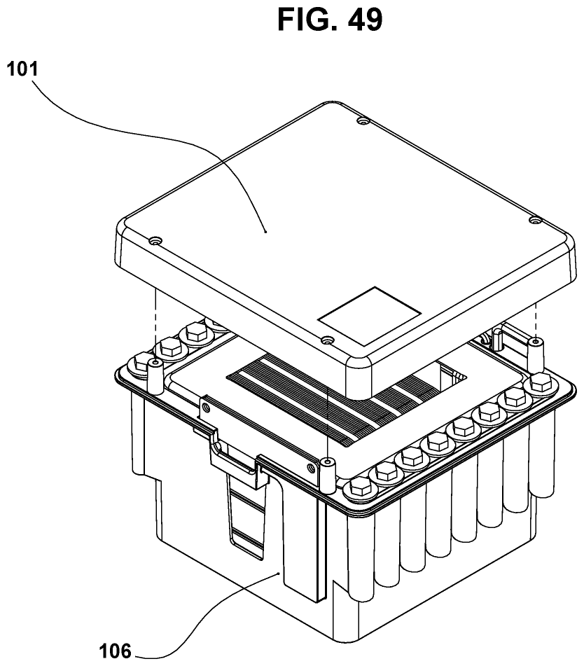

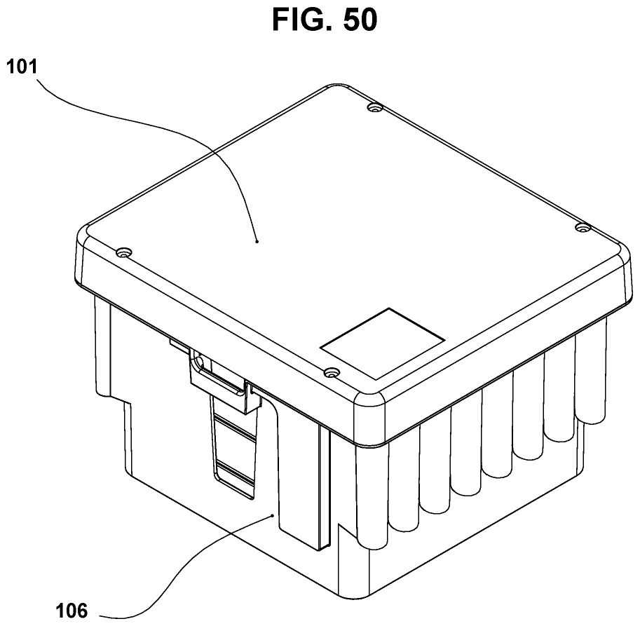

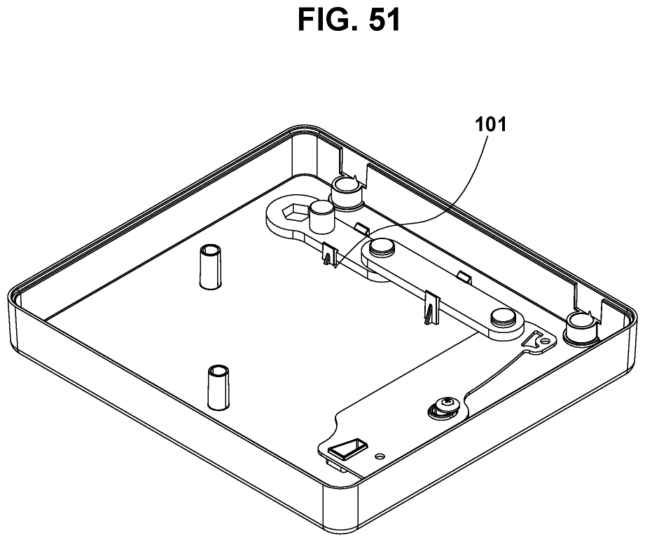

Referring to FIGS. 1-50, an embodiment of the 5-device-in-one space-saving cost-saving production-increasing assembly-time-decreasing multi-function-component box (which can be made as compactly small as 2 inches wide by 2 inches long by 2 inches high) may include a multi-function loss-preventing storing-and-organizing lid-tray system 101 including a multi-function loss-preventing storing-and-organizing lid-tray 102, a multi-link crank control arm wrench 103, and a cranking-arm-wrench storage clips 104.

In an embodiment, the 5-device-in-one space-saving cost-saving production-increasing assembly-time-decreasing multi-function-component box (which can be made as compactly small as 2 inches wide by 2 inches long by 2 inches high) may include Compartmentalized loss-preventing storing-and-organizing tub-tray system 105 may include a compartmentalized loss-preventing storing-and-organizing tub-tray 106, a ground-securing-and-leveling screws 107, a ground-securing-and-leveling-screws storage cavities 108, Allen wrenches 109 (or other tools used in the assembly process), Allen-wrench storage cavities 110 (or storage for other tools used in the assembly process), corner caps 111, a corner-caps storage cavity 112, screws 113, base plates 114, and first, second, third, and fourth base-plate covers 115a, 115b, 115c, 115d; and a compartmentalized loss-preventing storing-and-organizing inner-tray system 116.

In an example embodiment, the compartmentalized loss-preventing storing-and-organizing inner-tray system 116 may include one or more of a compartmentalized loss-preventing storing-and-organizing inner-tray 117, a louver end-caps 118, a louver-end-caps storage compartments 119, a crank-handle coupler 120, a crank-handle-coupler storage-stem 121, a compression-locking plates 122, a compression-locking-plates storage compartments 123, a drill bit 124, and a drill-bit clips 125.

Referring to FIG. 1-FIG. 50, a multi-function loss-preventing storing-and-organizing lid-tray system 101 may be made of the combined materials of its components. For example, in an example embodiment, a multi-function loss-preventing storing-and-organizing lid-tray 102 may be made of plastic. In an example embodiment, a multi-link crank control arm wrench 103 may be made of metal. In an example embodiment, cranking-arm-wrench storage clips 104 may be each made of the material of plastic. In an example embodiment, compartmentalized loss-preventing storing-and-organizing tub-tray system 105 may be made of the combined materials of its components. In an example embodiment, compartmentalized loss-preventing storing-and-organizing tub-tray 106 may be made of the material of plastic. In an example embodiment, ground-securing-and-leveling screws 107 may each be made of the material of metal. In an example embodiment, ground-securing-and-leveling-screws storage cavities 108 may each be an area of empty space generally. In an example embodiment, Allen wrenches 109 may each be made of metal. In an example embodiment, Allen-wrench storage cavities 110 may each be an area of generally empty space. In an example embodiment, corner caps 111 may each be made of the material of metal. In an example embodiment, corner-caps storage cavity 112 may generally be an area of empty space. In an example embodiment, screws 113 may each be made of the material of metal. In an example embodiment, base plates 114 may each be made of the material of metal. In an example embodiment, first, second, third, and fourth base-plate covers 115a, 115b, 115c, 115d may each be made of the material of metal. In an example embodiment, compartmentalized loss-preventing storing-and-organizing inner-tray system 116 may be made of the combined materials of its components. In an example embodiment, compartmentalized loss-preventing storing-and-organizing inner-tray 117 may be made of the material of plastic. In an example embodiment, louver end-caps 118 may each be made of the material of metal. In an example embodiment, louver-end-caps storage compartments 119 may generally each be areas of empty space. In an example embodiment, crank-handle coupler 120 may be made of the material of metal. In an example embodiment, crank-handle-coupler storage-stem 121 may be made of the material of plastic. In an example embodiment, compression-locking plates 122 may each be made of the material of metal. In an example embodiment, compression-locking-plates storage compartments 123 may each generally be areas of empty space. In an example embodiment, drill bit 124 may be made of the material of metal. In an example embodiment, drill-bit clips 125 may each be made of the material of plastic.

### Shape

Referring to FIGS. 1-50, in an example embodiment, multi-function loss-preventing storing-and-organizing lid-tray system 101 may be formed into the combined shapes of its components. Multi-function loss-preventing storing-and-organizing lid-tray 102 may be formed into the shape of a square (many other shapes are possible). Multi-link crank control arm wrench 103 may be formed into the shape of a multi-linked arm (many other shapes are possible). Cranking-arm-wrench storage clips 104 may each be formed into the shape of a square (many other shapes are possible). Compartmentalized loss-preventing storing-and-organizing tub-tray system 105 may be formed into the combined shapes of its components. Compartmentalized loss-preventing storing-and-organizing tub-tray 106 may be formed into the shape of a box (many other shapes are possible). Ground-securing-and-leveling screws 107 may each be formed into the shape of a screw. Ground-securing-and-leveling-screws storage cavities 108 may each be formed into the shape of a tube (many other shapes are possible).

Allen wrenches 109 may each be formed into the shape of a hexagonal tube. Allen-wrench storage cavities 110 may each be formed into the shape of a tube (many other shapes are possible). Corner caps 111 may each be formed into the shape of an L (many other shapes are possible). Corner-caps storage cavity 112 may be formed into the shape of a square (many other shapes are possible). Screws 113 may each be formed into the shape of a screw. Base plates 114 may each be formed into the shape of a square (many other shapes are possible). First, second, third, and fourth base-plate covers 115a, 115b, 115c, 115d may each be formed into the shape of a square ring (many other shapes are possible). Inner compartmentalized loss-preventing storing-and-organizing inner-tray system 116 may be formed into the combined shapes of its components.

Compartmentalized loss-preventing storing-and-organizing inner-tray 117 may be formed into the shape of a square box (many other shapes are possible). Louver end-caps 118 may each be formed into the shape of a rounded rectangle (many other shapes are possible). Louver-end-caps storage compartments 119 may each be formed into the shape of a square (many other shapes are possible). Crank-handle coupler 120 may be formed into the shape of a cylinder (many other shapes are possible). Crank-handle-coupler storage-stem 121 may be formed into the shape of a cylinder (many other shapes are possible). Compression-locking plates 122 may each be formed into the shape of a rectangle (many other shapes are possible). Compression-locking-plates storage compartments 123 may each be formed into the shape of a square (many other shapes are possible). Drill bit 124 may be formed into the shape of a threaded cylinder (many other shapes are possible). Drill-bit clips 125 may each be formed into the shape of a square (many other shapes are possible).

### Connection

Referring to FIGS. 1-50, in an example embodiment, multi-function loss-preventing storing-and-organizing lid-tray system 101 may be connected by the combined connections of its components. Multi-function loss-preventing storing-and-organizing lid-tray 102 may be screwed to compartmentalized loss-preventing storing-and-organizing tub-tray 106. Multi-link crank control arm wrench 103 may be snap-locked between cranking-arm-wrench storage clips 104.

In an example embodiment, cranking-arm-wrench storage clips 104 may be respectively molded onto the undersurface of multi-function loss-preventing storing-and-organizing lid-tray 102. Compartmentalized loss-preventing storing-and-organizing tub-tray system 105 may be connected by the combined connections of its components. Compartmentalized loss-preventing storing-and-organizing tub-tray 106 may be screwed to multi-function loss-preventing storing-and-organizing lid-tray 102. Ground-securing-and-leveling screws 107 may be respectively inserted into ground-securing-and-leveling-screws storage cavities 108.

In an example embodiment, ground-securing-and-leveling-screws storage cavities 108 may be respectively formed into compartmentalized loss-preventing storing-and-organizing tub-tray 106. Allen wrenches 109 may be respectively inserted into Allen-wrench storage cavities 110. Allen-wrench storage cavities 110 may be respectively formed into compartmentalized loss-preventing storing-and-organizing tub-tray 106. Corner caps 111 may be respectively inserted into corner-caps storage cavity 112.

In an example embodiment, corner-caps storage cavity 112 may be formed into compartmentalized loss-preventing storing-and-organizing tub-tray 106. Screws 113 may be respectively stacked inside second base-plate cover 115b. Base plates 114 may be respectively stacked inside first base-plate cover 115a.

In an example embodiment, first base-plate cover 115a may be respectively stacked upside down inside compartmentalized loss-preventing storing-and-organizing tub-tray 106. Second base-plate cover 115b may be respectively stacked upside down on first base-plate cover 115a inside compartmentalized loss-preventing storing-and-organizing tub-tray 106. Third base-plate cover 115c may be respectively stacked upside down on second base-plate cover 115b inside compartmentalized loss-preventing storing-and-organizing tub-tray 106. Fourth base-plate cover 115d may be respectively stacked right side up on third base-plate cover 115c inside compartmentalized loss-preventing storing-and-organizing tub-tray 106.

In an example embodiment, inner compartmentalized loss-preventing storing-and-organizing inner-tray system 116 may be connected by the combined connections of its components. Compartmentalized loss-preventing storing-and-organizing inner-tray 117 may be stacked within second and third base-plate covers 115b and 115c. Louver end-caps 118 may be respectively inserted and secured to louver-end-caps storage compartments 119. Louver-end-caps storage compartments 119 may be respectively formed into compartmentalized loss-preventing storing-and-organizing inner-tray 117.

In an example embodiment, crank-handle coupler 120 may be snap-locked onto crank-handle-coupler storage-stem 121. Crank-handle-coupler storage-stem 121 may be molded onto compartmentalized loss-preventing storing-and-organizing inner-tray 117. Compression-locking plates 122 may be respectively inserted and secured to compression-locking-plates storage compartments 123. Compression-locking-plates storage compartments 123 may be respectively formed into compartmentalized loss-preventing storing-and-organizing inner-tray 117. Drill bit 124 may be snap-locked between drill-bit clips 125. Drill-bit clips 125 may be respectively molded onto compartmentalized loss-preventing storing-and-organizing inner-tray 117.

### Function

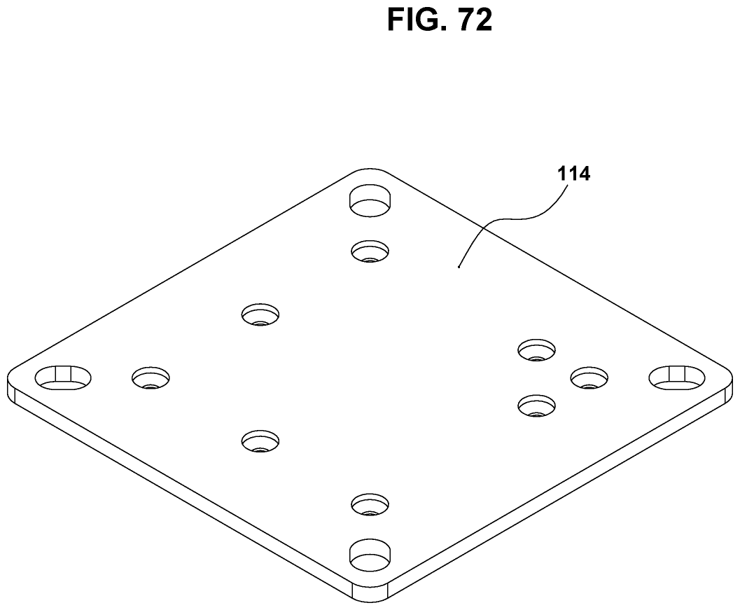

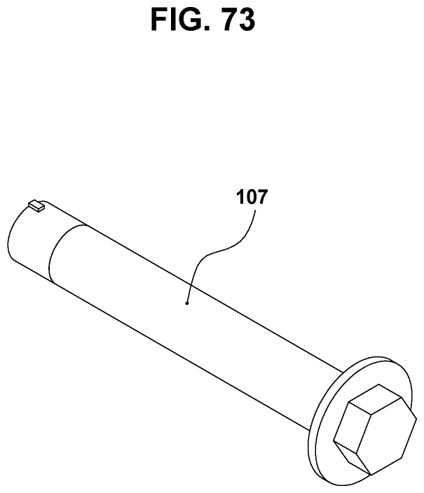

Referring to FIGS. 51-78, in an example embodiment, multi-function loss-preventing storing-and-organizing lid-tray system 101 may be for performing the combined functions of its components. For example, multi-function loss-preventing storing-and-organizing lid-tray 102 may be for preventing loss by being turn over during assembly to function as a tray for securely containing multi-link crank control arm wrench 103, Allen wrench 109, screws 113, louver end-caps 118, crank-handle coupler 120, drill bit 124, etc. in the directions of arrows 126 and 136 (see FIGS. 52, 77-84); and providing a secure location on its under surface to clamp on and store multi-link crank control arm wrench 103 during shipping in the directions of arrow 127 (see FIG. 53).

In an example embodiment, multi-link crank control arm wrench 103 may be for functioning as a box wrench in the directions of arrows 128a and 128b (see FIG. 54A and FIG. 54B); and functioning as a flat-head screwdriver in the directions of arrows 129a and 129b (see FIG. 55A and FIG. 55B).

In an example embodiment, cranking-arm-wrench storage clips 104 may be respectively for securing multi-link crank control arm wrench 103 during shipping. Compartmentalized loss-preventing storing-and-organizing tub-tray system 105 may be for performing the combined functions of its components.

In an example embodiment, compartmentalized loss-preventing storing-and-organizing tub-tray 106 may be for providing a compact stackable packaging solution to allow multi-function components and tools to compactly stack on one another to save shipping space and cost in the directions of arrows 130, 131, 132, 133a, and 133b (see FIG. 57-FIG. 68); and securing and organizing multi-function components and tools to prevent loss in the direction of arrow 134 (see FIG. 69-FIG. 71.)

In an example embodiment, ground-securing-and-leveling screws 107 may be respectively for releasably adjusting the height of base plates 114 on ground surface in the direction of arrow 135 (see FIG. 74-FIG. 76); leveling base plates 114 on ground surface in the direction of arrow 135 (see FIG. 74-FIG. 76); and securely attaching base plates 114 to ground surface in the direction of arrow 135 (see FIG. 74-FIG. 76).

In an example embodiment, ground-securing-and-leveling-screws storage cavities 108 may be respectively for: providing secure locations for ground-securing-and-leveling screws 107 to be stored. Allen wrenches 109 may be respectively for tightening and loosening screws 113.

In an example embodiment, Allen-wrench storage cavities 110 may be respectively for providing secure locations for Allen wrenches 109 to be stored. In an example embodiment, corner caps 111 may be respectively for covering corner posts. In an example embodiment, corner-caps storage cavity 112 may be for providing secure location for corner caps 111 to be stored.

In an example embodiment, screws 113 may be respectively for fastening various components to other components. In an example embodiment, base plates 114 may be respectively for providing stability for structures. In an example embodiment, first, second, third, and fourth base-plate covers 115a, 115b, 115c, 115d may be respectively for covering base plates 114. Inner compartmentalized loss-preventing storing-and-organizing inner-tray system 116 may be for performing the combined functions of its components.

In an example embodiment, compartmentalized loss-preventing storing-and-organizing inner-tray 117 may be for providing a compact stackable packaging solution to allow multi-function components and tools to compactly stack on one another to save shipping space and cost in the directions of arrows 130, 131, 132, 133a, and 133b (see FIG. 57-FIG. 68); organizing and storing multi-function components and tools to prevent loss in the direction of arrow 136 (see FIG. 77-FIG. 84); securing multi-function components and tools during shipping (see FIG. 77-FIG. 84); and preventing loss by functioning as a tray to secure multi-function components and tools during assembly in the direction of arrow 136 (see FIG. 77-FIG. 84).

In an example embodiment, louver end-caps 118 may be respectively for covering louver ends. In an example embodiment, louver-end-caps storage compartments 119 may be respectively for securely storing louver end-caps 118. In an example embodiment, crank-handle coupler 120 may be for coupling a crank-handle. In an example embodiment, crank-handle-coupler storage-stem 121 may be for securing crank-handle coupler 120. In an example embodiment, Compression-locking plates 122 may be respectively for compression-locking certain components to other certain components. In an example embodiment, compression-locking-plates storage compartments 123 may be respectively for securely storing compression-locking plates 122. In an example embodiment, drill bit 124 may be for drilling holes for ground-securing-and-leveling screws 107 to be installed. In an example embodiment, drill-bit clips 125 may be respectively for securely locking drill bit 124.

### Method

In an example embodiment, a method for providing a compact stackable packaging solution to allow multi-function components and tools to be compactly stacked on one another inside the 5-device-in-one space-saving cost-saving production-increasing assembly-time-decreasing multi-function-component box (which can be made as compactly small as 2 inches wide by 2 inches long by 2 inches high) (for storing multi-function tools and assembling tools of pergola, sauna house, smokehouse, sky box, and dehydrating house) to save shipping space in containers, trucks, trains, etc., to save shipping costs, to organize and store multi-function components and tools to prevent loss, to secure multi-function components and tools during shipping, to secure multi-function components and tools during assembly, to increase production, and to decrease assembly time.

In an example embodiment, the method comprises the steps of:
1) Respectively molding cranking-arm-wrench storage clips 104 onto the undersurface of multi-function loss-preventing storing-and-organizing lid-tray 102;
2) Snap-locking multi-link crank control arm wrench 103 between cranking-arm-wrench storage clips 104;
3) Respectively forming ground-securing-and-leveling-screws storage cavities 108 into compartmentalized loss-preventing storing-and-organizing tub-tray 106;
4) Respectively inserting ground-securing-and-leveling screws 107 into ground-securing-and-leveling-screws storage cavities 108;
5) Respectively forming Allen-wrench storage cavities 110 into compartmentalized loss-preventing storing-and-organizing tub-tray 106;
6) Respectively inserting Allen wrenches 109 into Allen-wrench storage cavities 110;
7) Forming corner-caps storage cavity 112 into compartmentalized loss-preventing storing-and-organizing tub-tray 106;
8) Respectively inserting corner caps 111 into corner-caps storage cavity 112;
9) Stacking first base-plate cover 115a upside down inside compartmentalized loss-preventing storing-and-organizing tub-tray 106;
10) Respectively stacking base plates 114 inside first base-plate cover 115a;
11) Stacking second base-plate cover 115b upside down on first base-plate cover 115a inside compartmentalized loss-preventing storing-and-organizing tub-tray 106;
12) Respectively stacking screws 113 inside second base-plate cover 115b;
13) Stacking third base-plate cover 115c upside down on second base-plate cover 115b inside compartmentalized loss-preventing storing-and-organizing tub-tray 106;
14) Stacking compartmentalized loss-preventing storing-and-organizing inner-tray 117 within second and third base-plate covers 115b and 115c;
15) Respectively forming louver-end-caps storage compartments 119 into compartmentalized loss-preventing storing-and-organizing inner-tray 117;
16) Respectively inserting and securing louver end-caps 118 to louver-end-caps storage compartments 119;
17) Molding crank-handle-coupler storage-stem 121 onto compartmentalized loss-preventing storing-and-organizing inner-tray 117;
18) Snap-locking crank-handle coupler 120 onto crank-handle-coupler storage-stem 121;
19) Respectively forming compression-locking-plates storage compartments 123 into compartmentalized loss-preventing storing-and-organizing inner-tray 117;
20) Respectively inserting and securing compression-locking plates 122 to compression-locking-plates storage compartments 123;
21) Respectively molding drill-bit clips 125 onto compartmentalized loss-preventing storing-and-organizing inner-tray 117;
22) Snap-locking drill bit 124 between drill-bit clips 125;
23) Stacking fourth base-plate cover 115d right side up on third base-plate cover 115c inside compartmentalized loss-preventing storing-and-organizing tub-tray 106;
24) Stacking multi-function loss-preventing storing-and-organizing lid-tray 102 on fourth base-plate cover 115d; and
25) Screwing multi-function loss-preventing storing-and-organizing lid-tray 102 to compartmentalized loss-preventing storing-and-organizing tub-tray 106.

### Variation

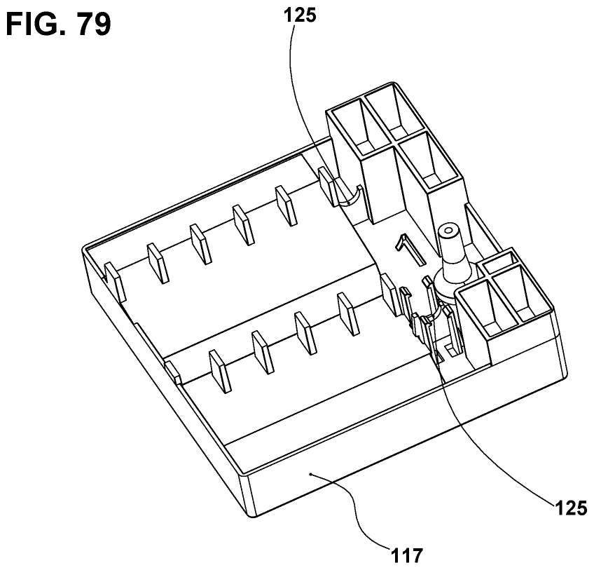

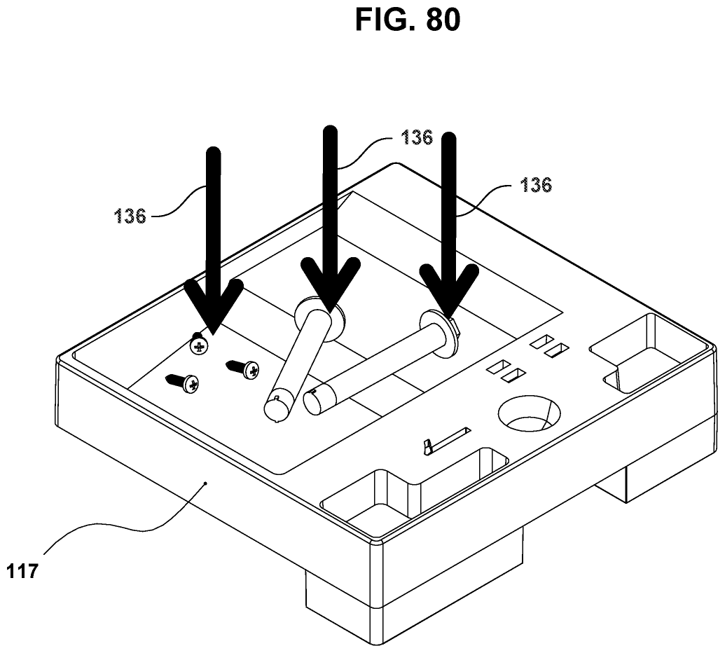

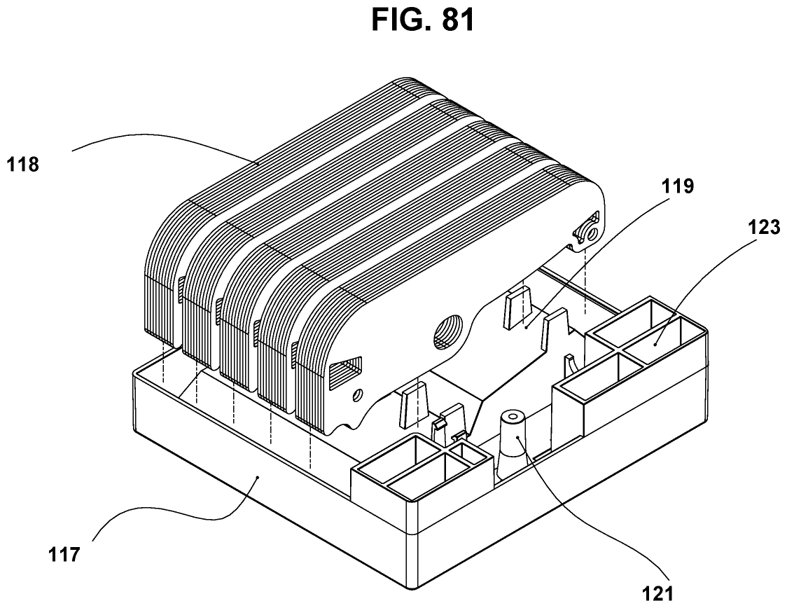

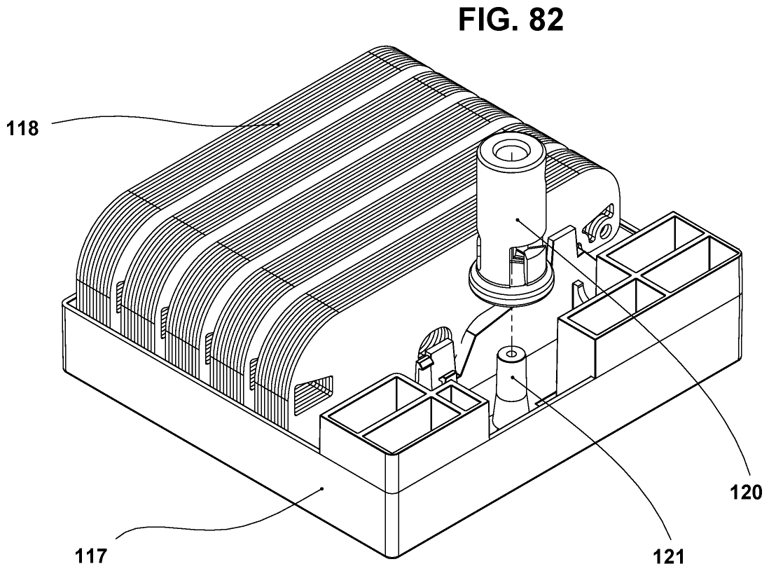

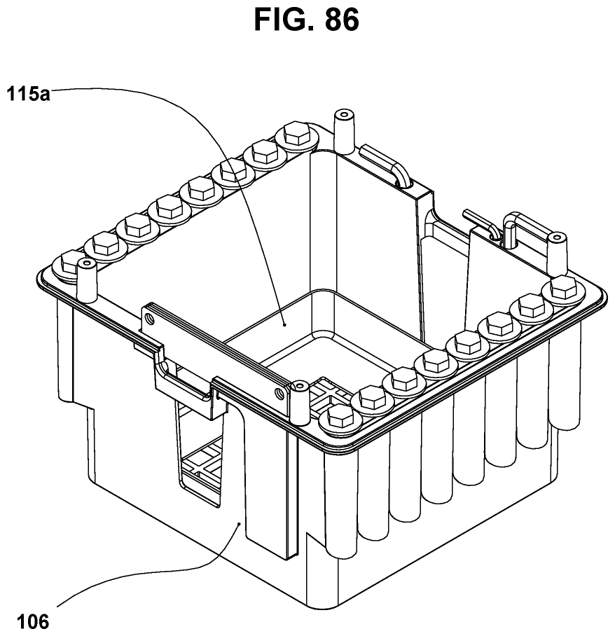

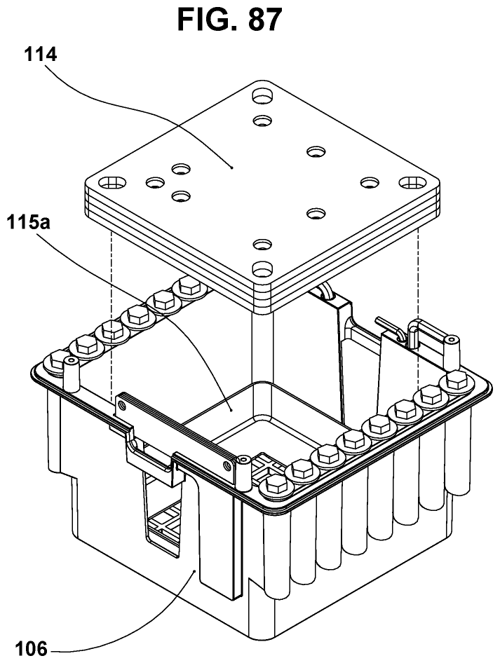

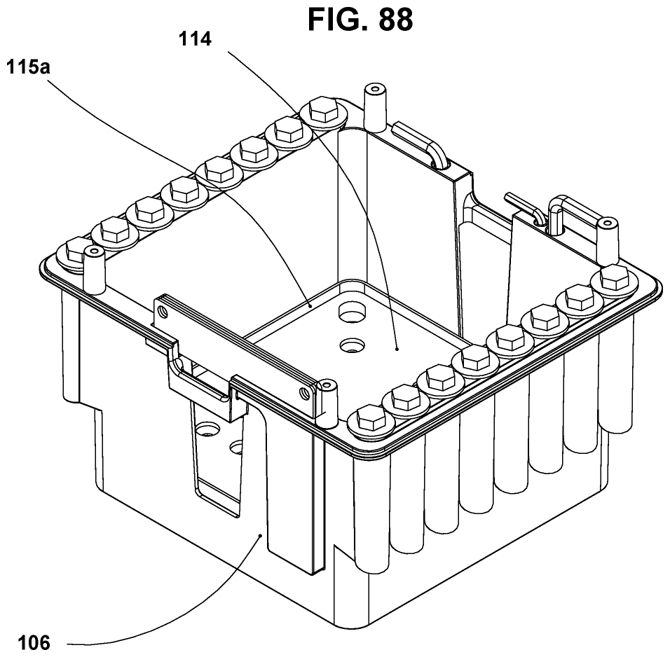

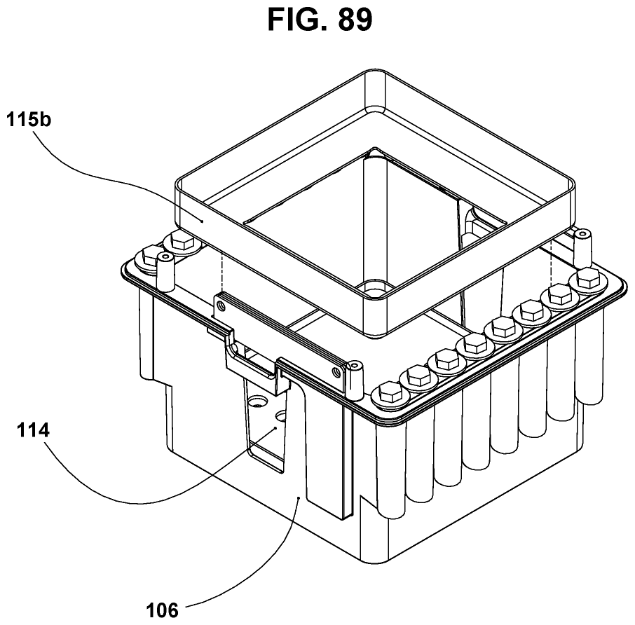

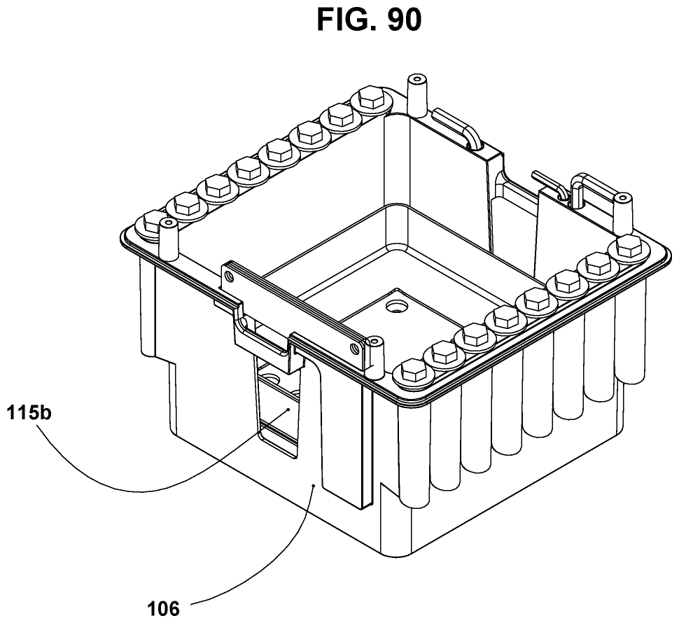

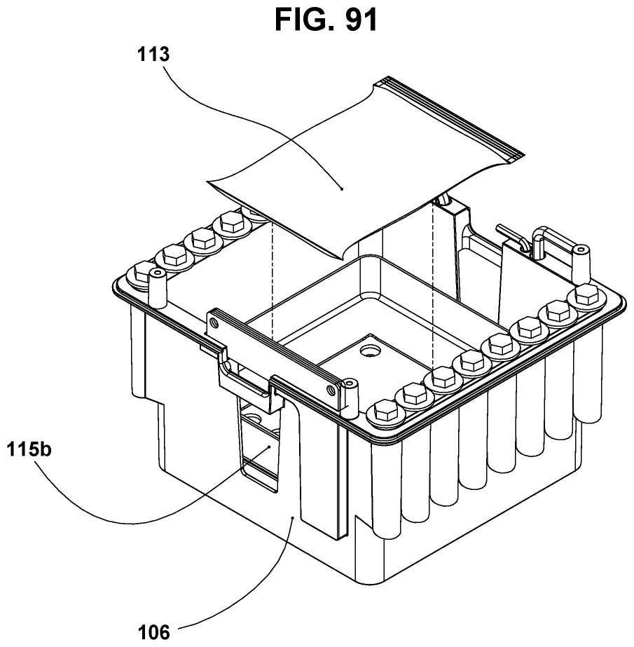

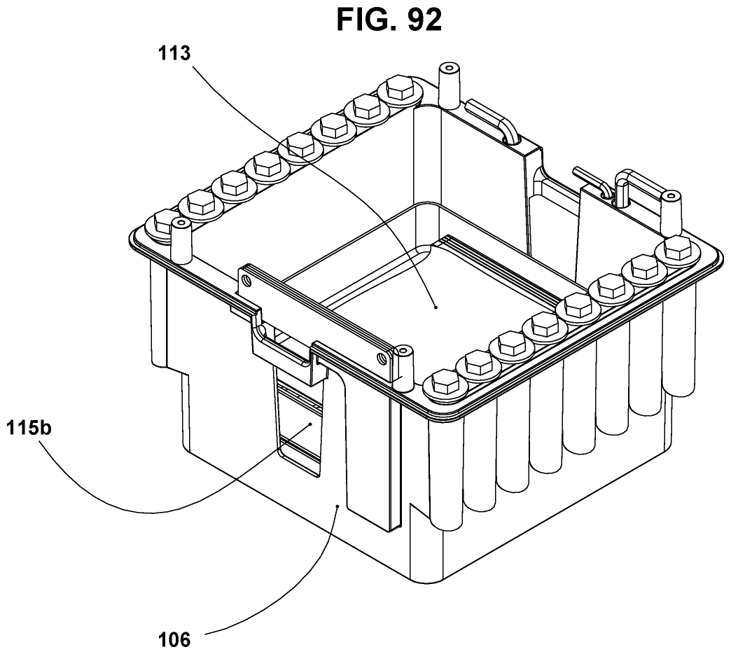

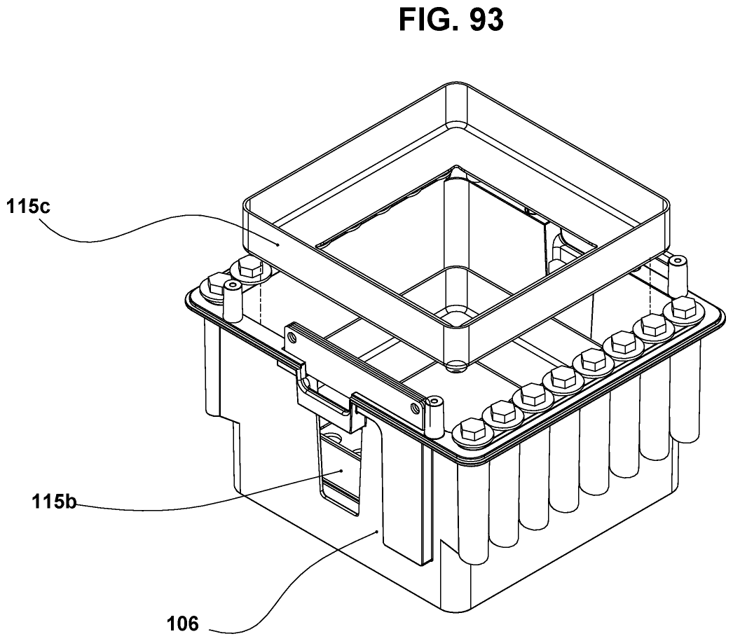

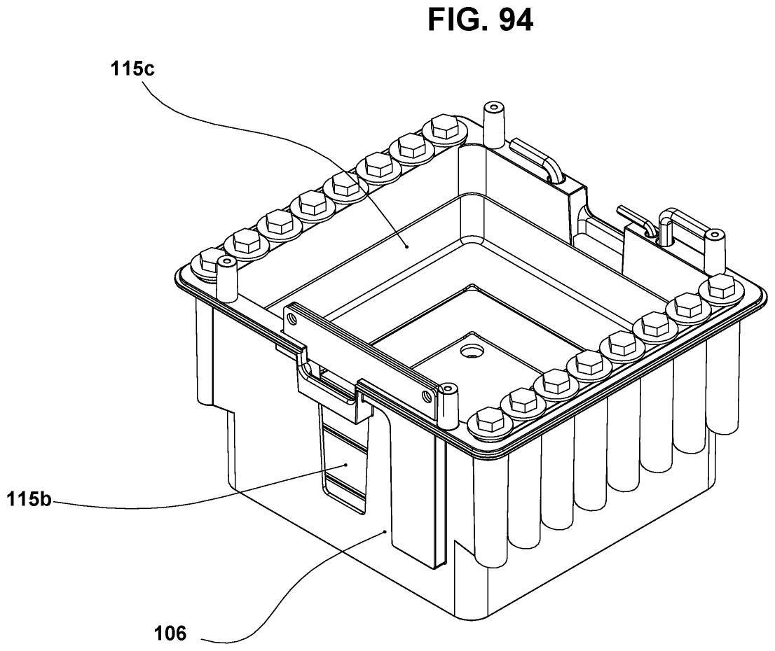

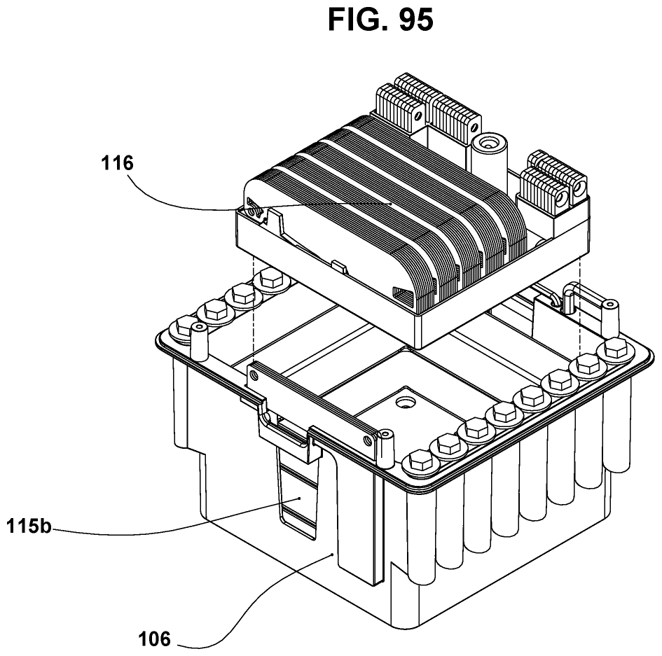

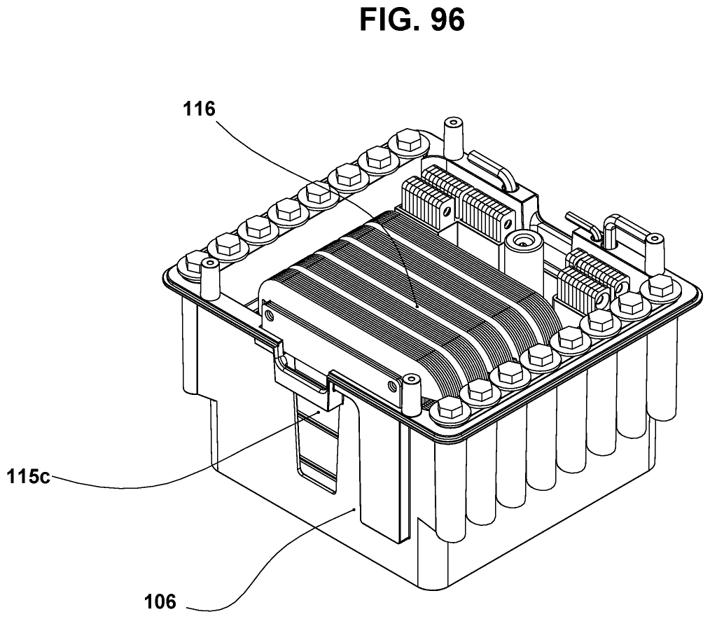

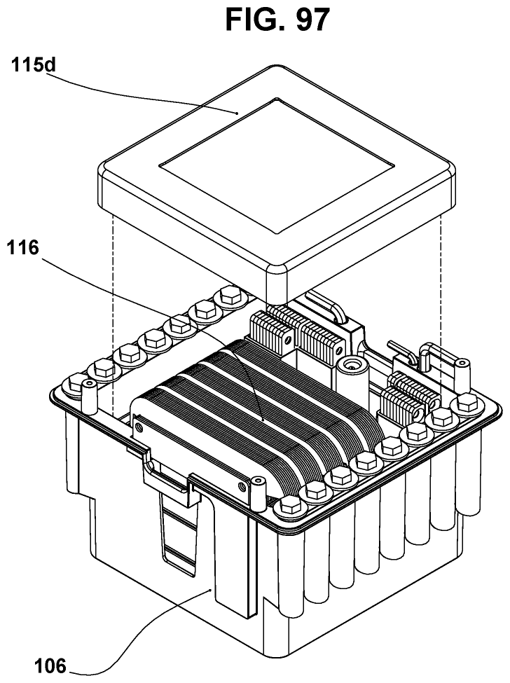

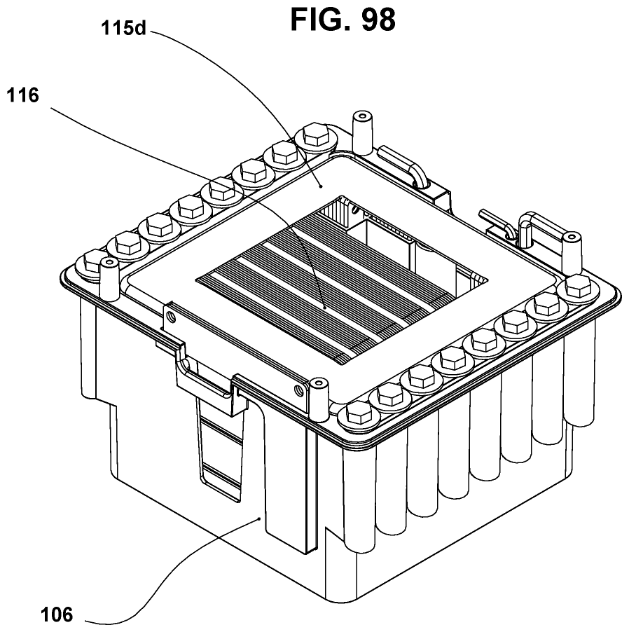

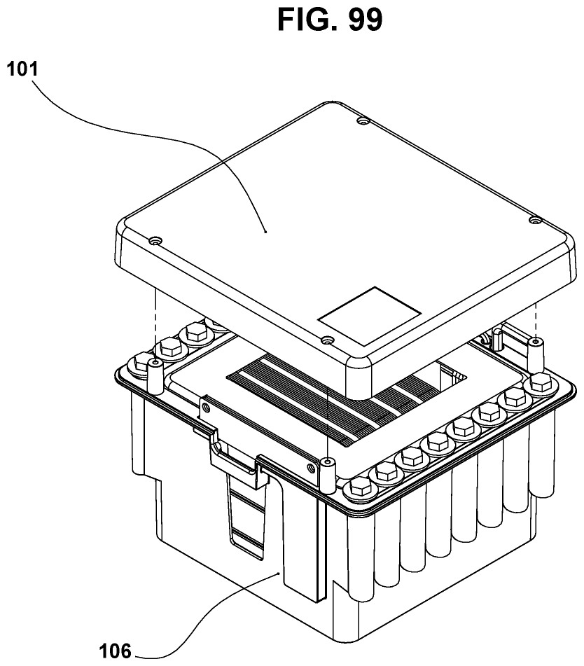

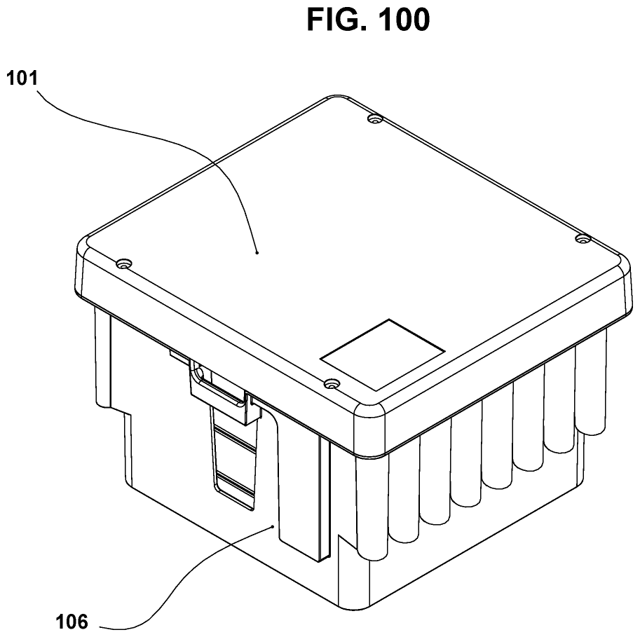

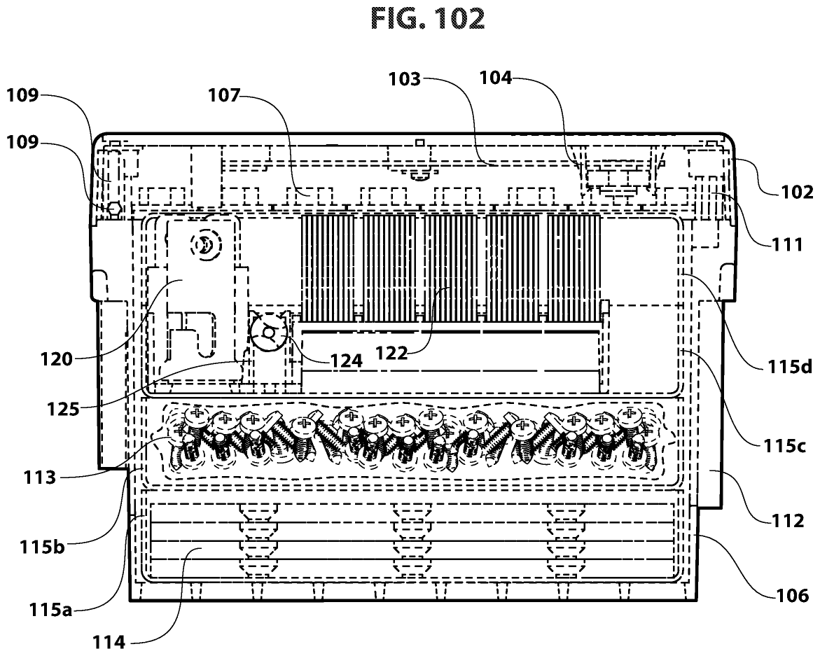

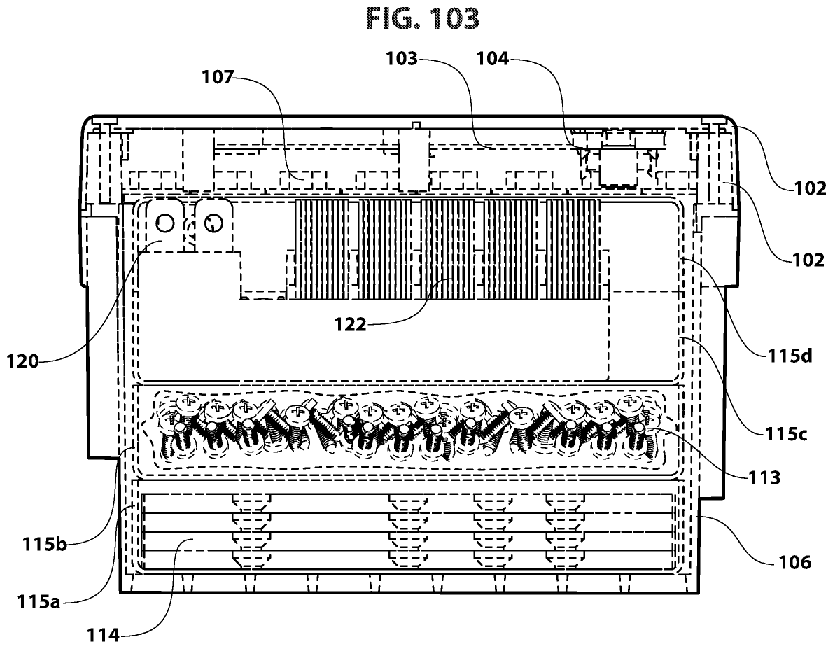

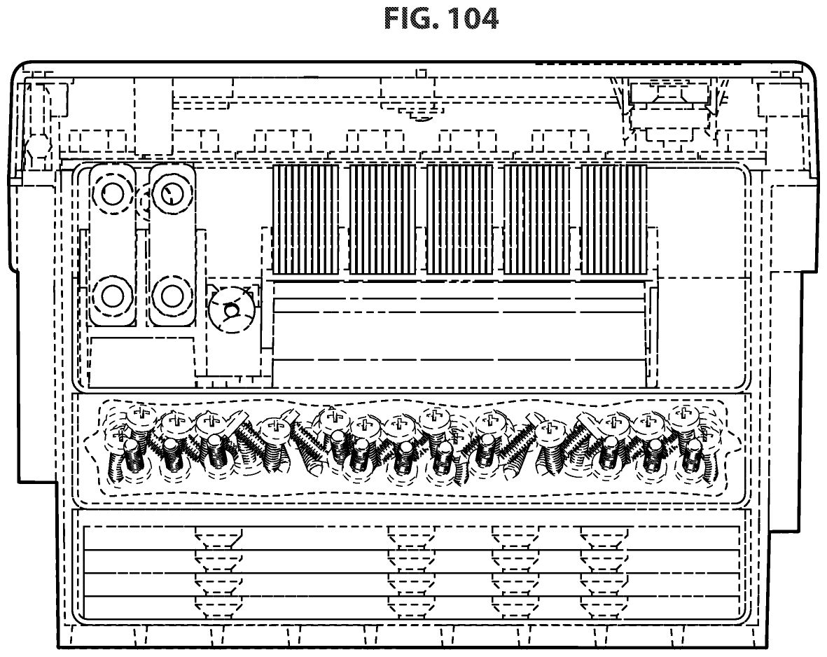

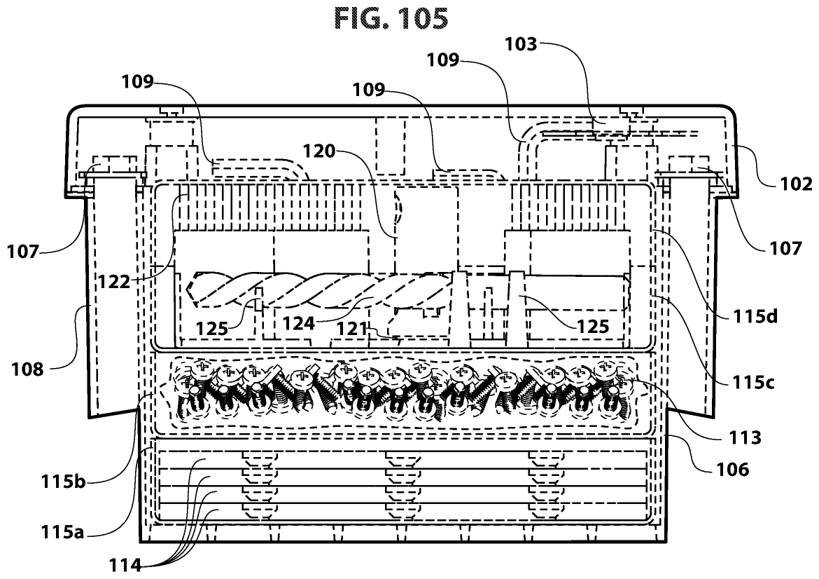

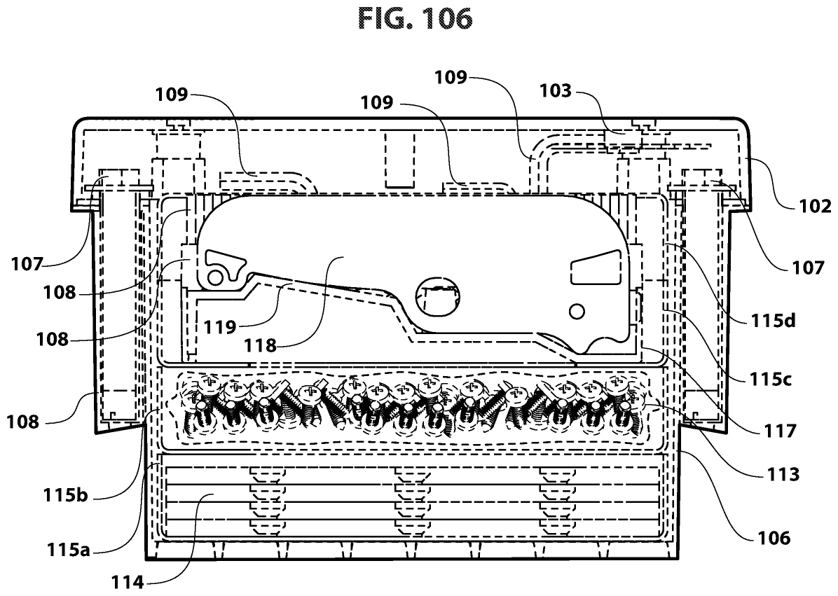

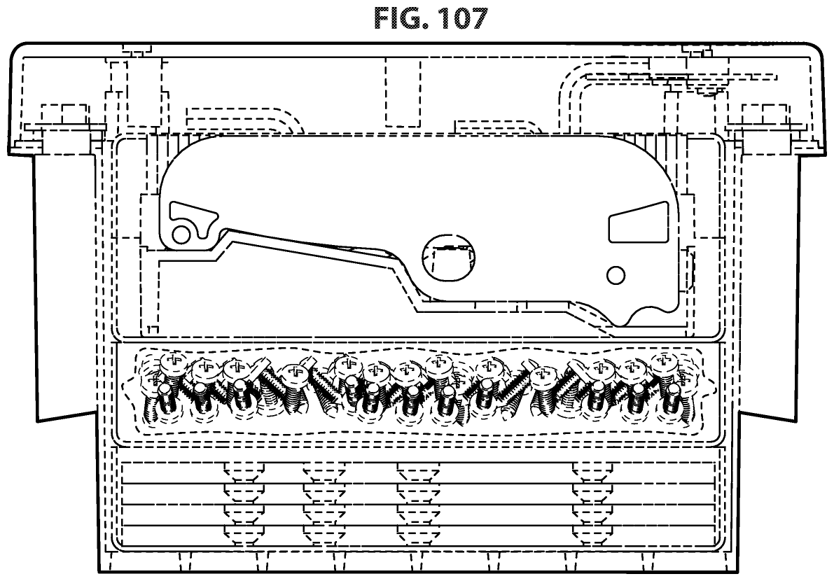

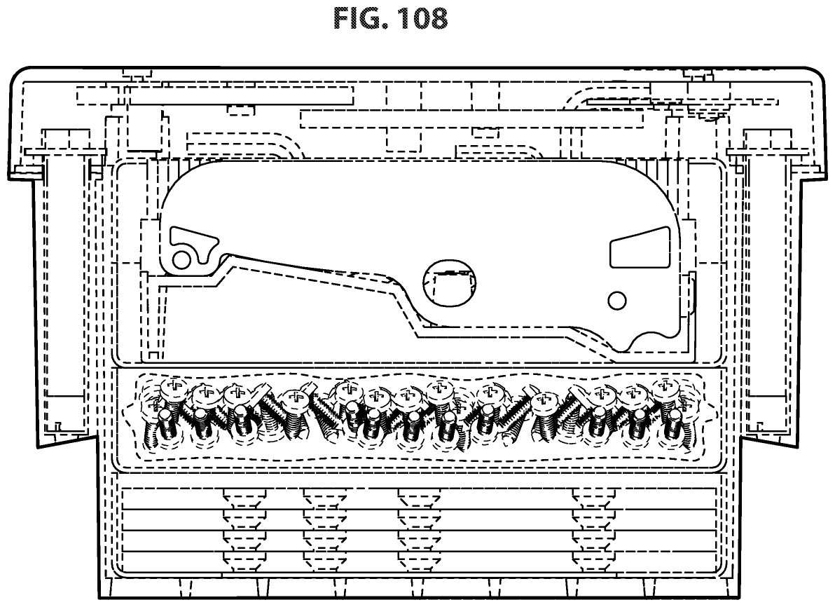

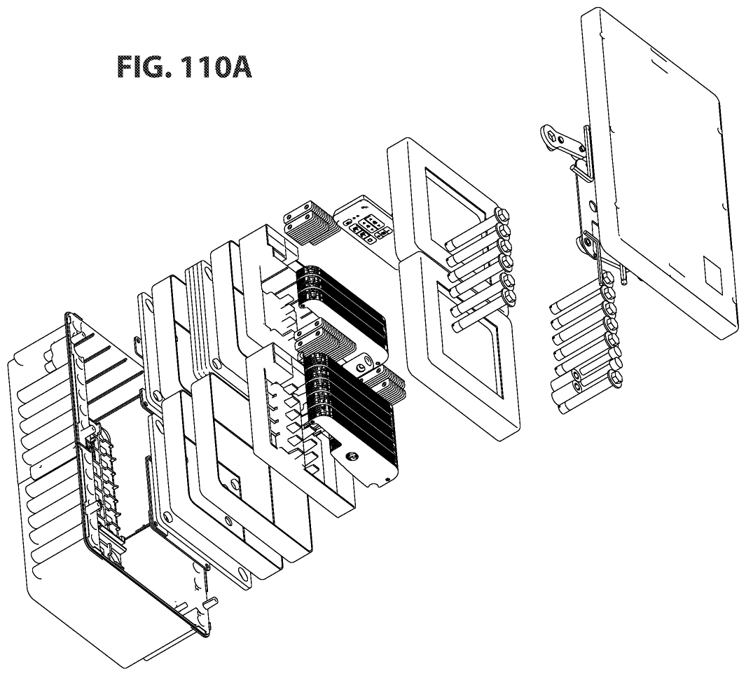

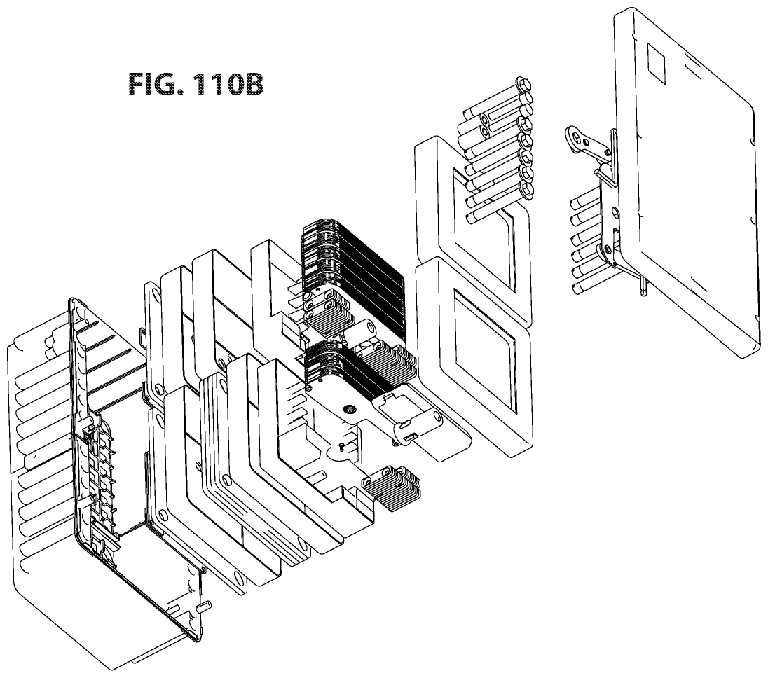

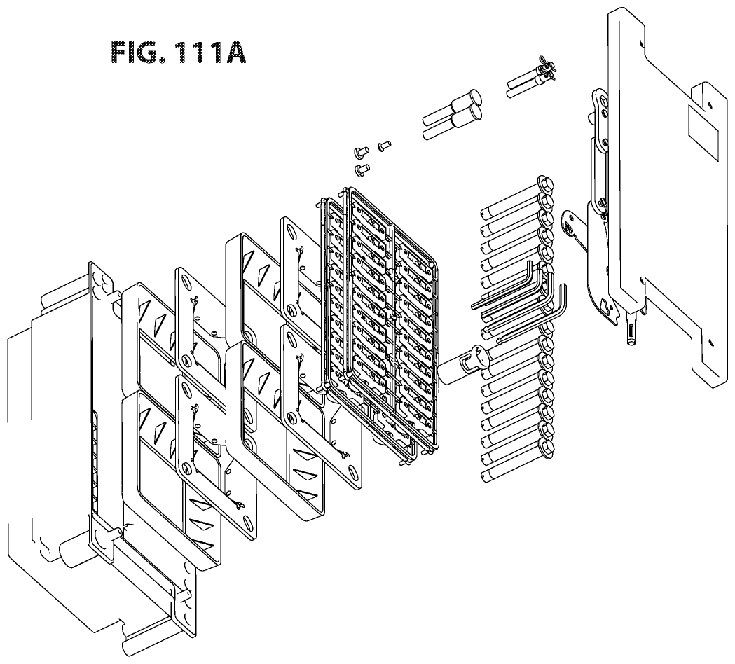

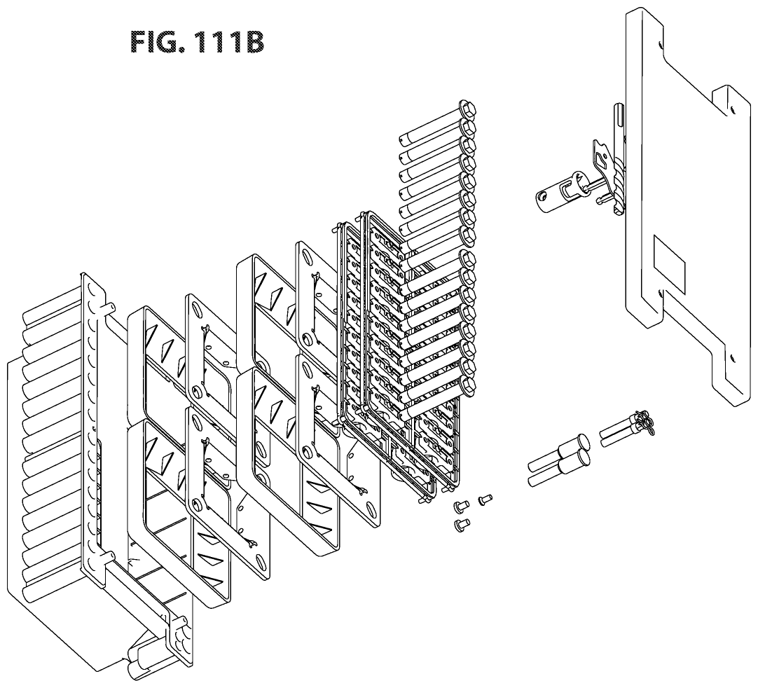

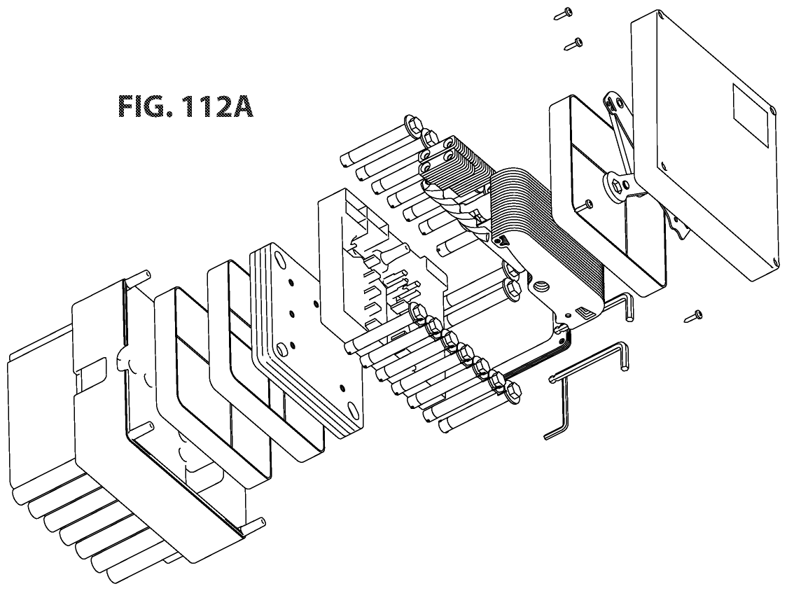

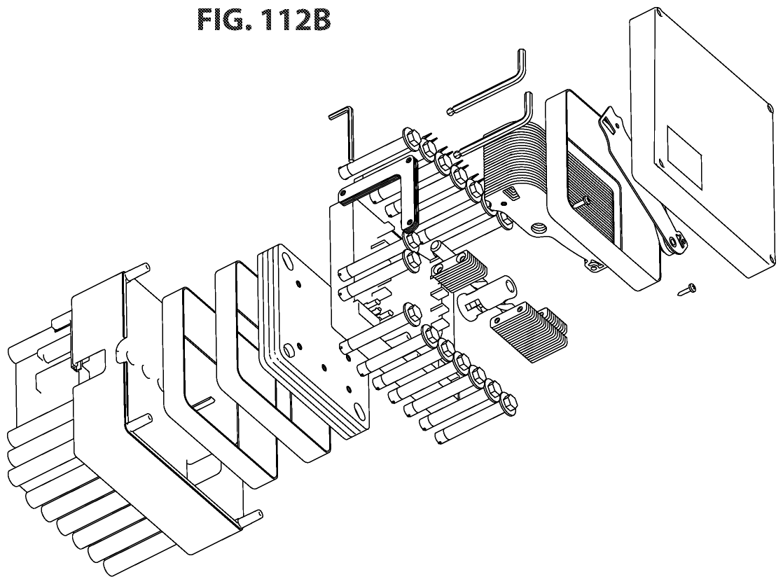

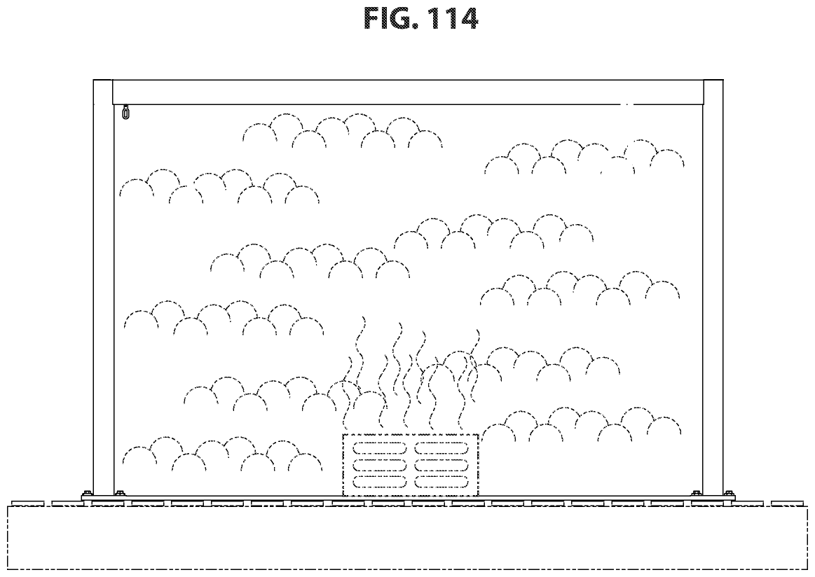

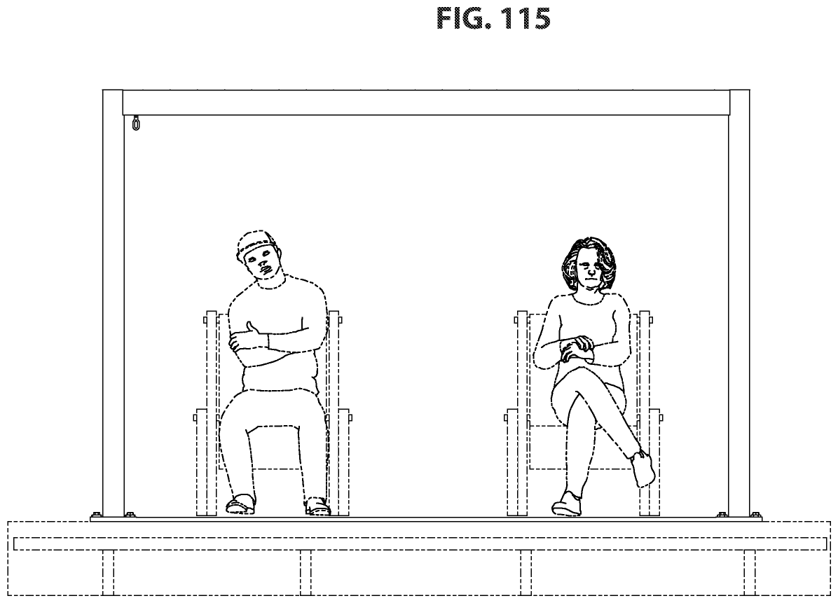

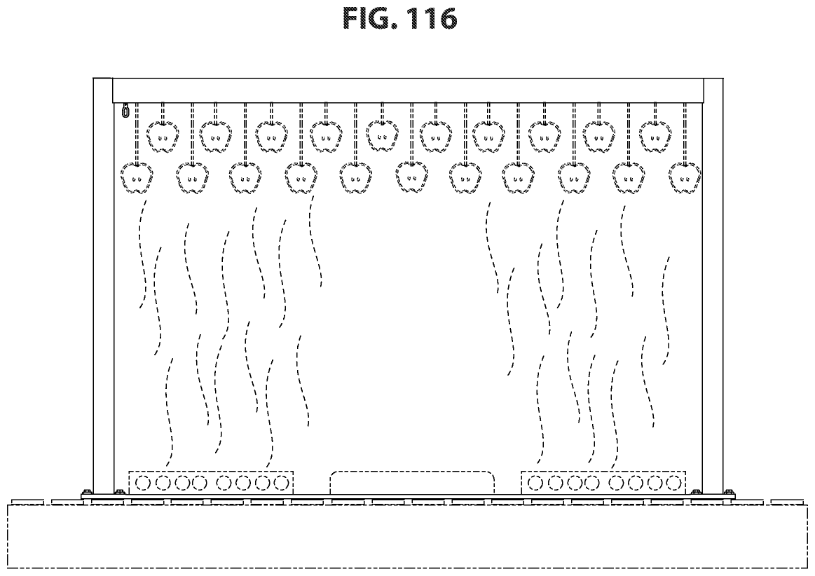

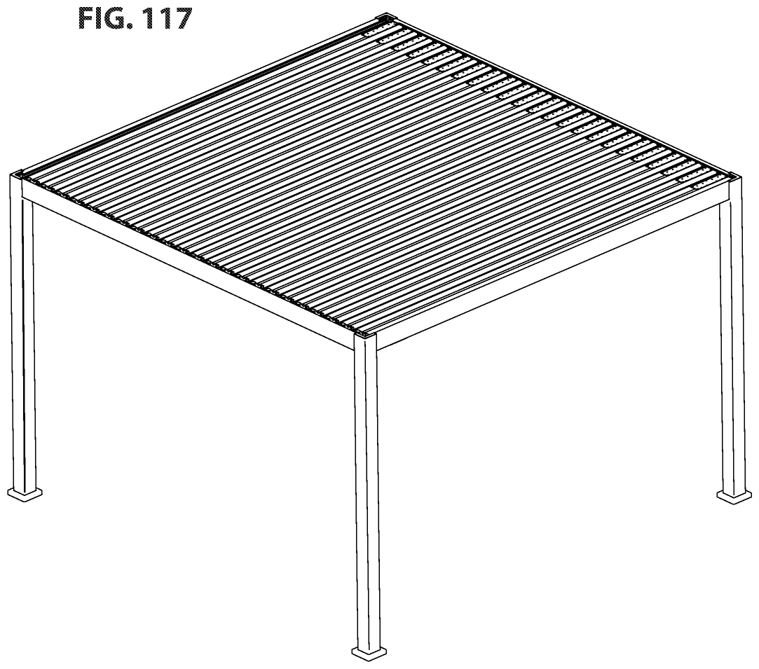

Referring to FIGS. 79-117, in an example embodiment, any component of the 5-device-in-one space-saving cost-saving production-increasing assembly-time-decreasing multi-function-component box can have any shape and size. Any component of the 5-device-in-one space-saving cost-saving production-increasing assembly-time-decreasing multi-function-component box can be made of any material(s). Components of the 5-device-in-one space-saving cost-saving production-increasing assembly-time-decreasing multi-function-component box can be used for a pergola, sauna house, smokehouse, sky box, and dehydrating house.

FIGS. 78-79 illustrate perspective views of equivalent variations of compartmentalized loss-preventing storing-and-organizing tub-tray 106.

FIGS. 80-84 illustrate perspective views of equivalent variations of inner compartmentalized loss-preventing storing-and-organizing inner-tray system 116.

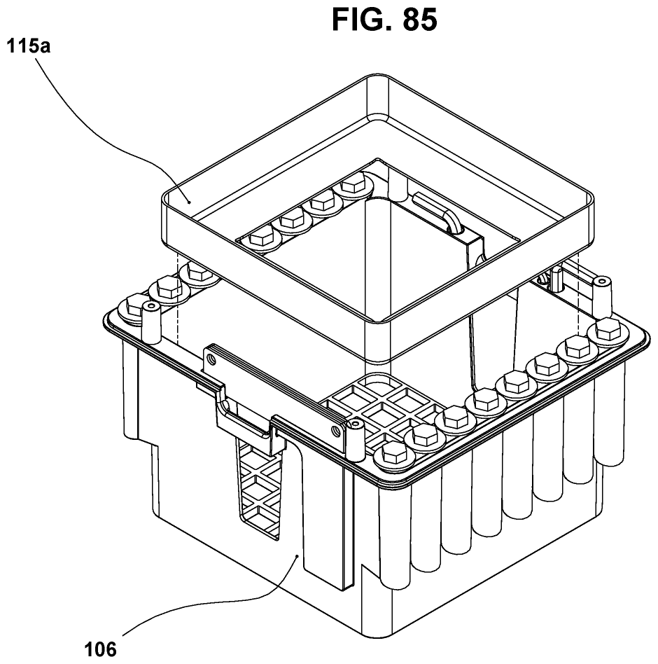

FIGS. 85-100 illustrate perspective views of method steps of 5-device-in-one space-saving cost-saving production-increasing assembly-time-decreasing multi-function-component box.

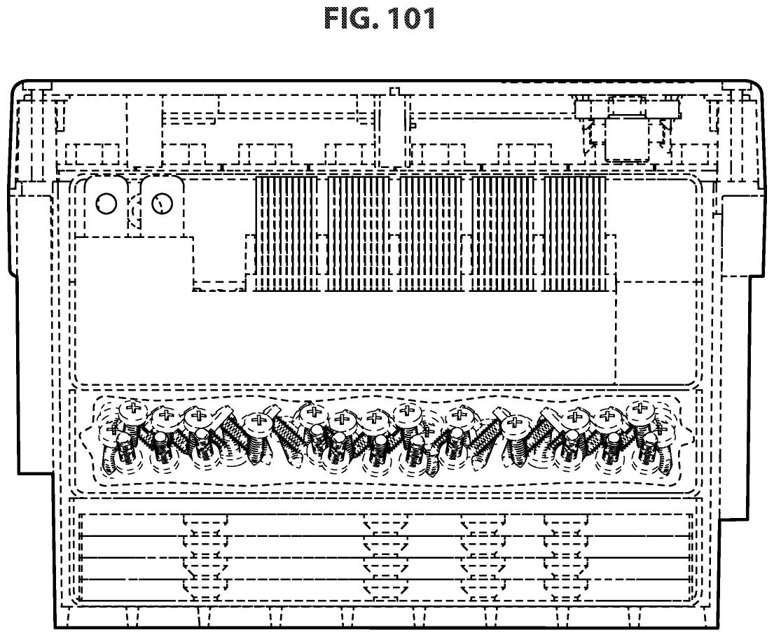

FIGS. 101-108 illustrate perspective views of all the components and tools compactly stacked inside 5-device-in-one space-saving cost-saving production-increasing assembly-time-decreasing multi-function-component box.

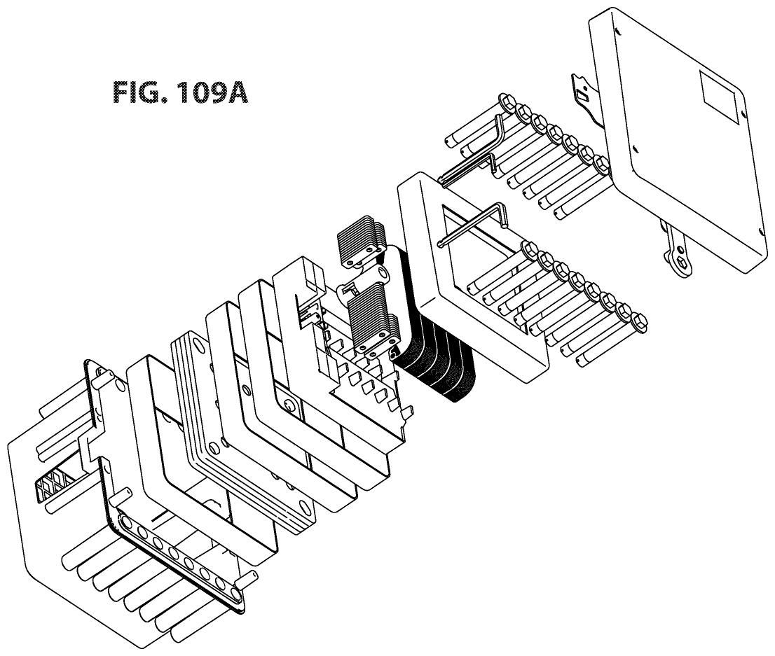

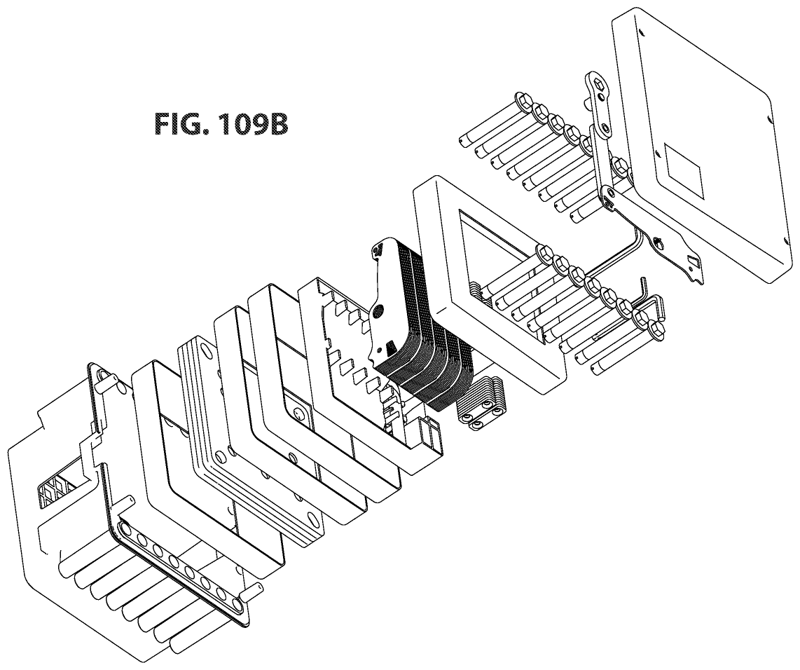

FIGS. 109A-112B illustrate perspective exploded views of equivalent variations of 5-device-in-one space-saving cost-saving production-increasing assembly-time-decreasing multi-function-component box.

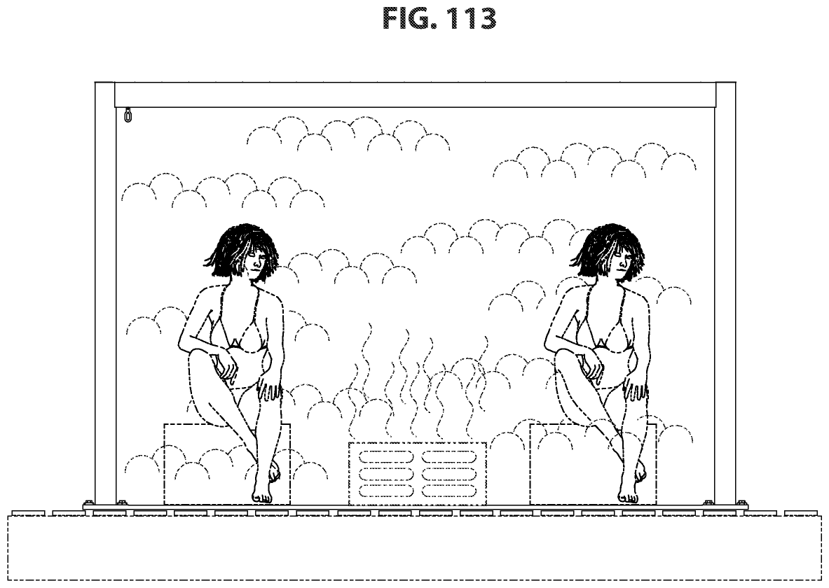

FIGS. 113-117 illustrate perspective exploded views of equivalent applications of 5-device-in-one space-saving cost-saving production-increasing assembly-time-decreasing multi-function-component box being used for storing multi-function components and assembling tools of a sauna house, smokehouse, sky box, and dehydrating house.

Some embodiments of the present invention substantially depart from the conventional concepts and designs of the prior art. In doing so, the present invention provides a 5-device-in-one space-saving cost-saving production-increasing assembly-time-decreasing multi-function-component box (which can be made as compactly small as 2 inches wide by 2 inches long by 2 inches high), having many unique and significant features, functions, and advantages, which overcome some or all the disadvantages of the prior art, as follows:

It is an object of some embodiments to provide a 5-device-in-one space-saving cost-saving production-increasing assembly-time-decreasing multi-function-component box, having multi-function loss-preventing storing-and-organizing lid-tray 102. Therefore, the 5-device-in-one space-saving cost-saving production-increasing assembly-time-decreasing multi-function-component box is capable of preventing loss by being turn over during assembly to function as a tray for securely containing multi-link crank control arm wrench 103, Allen wrench 109, screws 113, louver end-caps 118, crank-handle coupler 120, drill bit 124, etc. in the directions of arrows 126 and 136 (see FIGS. 52, 77-84); and capable of providing a secure location on its under surface to clamp on and store multi-link crank control arm wrench 103 during shipping in the directions of arrow 127 (see FIG. 53).

It is another object of some embodiments to provide a 5-device-in-one space-saving cost-saving production-increasing assembly-time-decreasing multi-function-component box, having multi-link crank control arm wrench 103. Therefore, the 5-device-in-one space-saving cost-saving production-increasing assembly-time-decreasing multi-function-component box is capable of functioning as a box wrench in the directions of arrows 128a and 128b (see FIG. 54A and FIG. 54B); and capable of functioning as a flat-head screwdriver in the directions of arrows 129a and 129b (see FIG. 55A and FIG. 55B).

It is still another object of some embodiments to provide a 5-device-in-one space-saving cost-saving production-increasing assembly-time-decreasing multi-function-component box, having compartmentalized loss-preventing storing-and-organizing tub-tray 106. Therefore, the 5-device-in-one space-saving cost-saving production-increasing assembly-time-decreasing multi-function-component box is capable of providing a compact stackable packaging solution to allow multi-function components and tools to compactly stack on one another to save shipping space and cost in the directions of arrows 130, 131, 132, 133a, and 133b (see FIG. 57-FIG. 68); and Capable of securing and organizing multi-function components and tools to prevent loss in the direction of arrow 134 (see FIG. 69-FIG. 71).

It is yet still another object of some embodiments to provide a 5-device-in-one space-saving cost-saving production-increasing assembly-time-decreasing multi-function-component box, having ground-securing-and-leveling screws 107. Therefore, the 5-device-in-one space-saving cost-saving production-increasing assembly-time-decreasing multi-function-component box is capable of releasably adjusting the height of base plates 114 on ground surface in the direction of arrow 135 (see FIG. 74-FIG. 76); capable of leveling base plates 114 on ground surface in the direction of arrow 135 (see FIG. 74-FIG. 76); and capable of securely attaching base plates 114 to ground surface in the direction of arrow 135 (see FIG. 74-FIG. 76).

It is a further object of some embodiments to provide a 5-device-in-one space-saving cost-saving production-increasing assembly-time-decreasing multi-function-component box, having compartmentalized loss-preventing storing-and-organizing inner-tray 117. Therefore, the 5-device-in-one space-saving cost-saving production-increasing assembly-time-decreasing multi-function-component box is capable of providing a compact stackable packaging solution to allow multi-function components and tools to compactly stack on one another to save shipping space and cost in the directions of arrows 130, 131, 132, 133a, and 133b (scc FIG. 57-FIG. 68); capable of organizing and storing multi-function components and tools to prevent loss in the direction of arrow 136 (see FIG. 77-FIG. 84); capable of securing multi-function components and tools during shipping (see FIG. 77-FIG. 84); and capable of preventing loss by functioning as a tray to secure multi-function components and tools during assembly in the direction of arrow 136 (see FIG. 77-FIG. 84).

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1-20. (canceled)

21. A component box comprising:
a multi-function lid tray having an undersurface and a plurality of storage clips;
a crank control arm wrench secured between the storage clips;
a compartmentalized tub tray; and
an inner tray.

22. The component box of claim 21, wherein the compartmentalized tub tray comprises:
a plurality of storage cavities;
a first base-plate cover stacked upside down inside the compartmentalized tub tray;
a plurality of base plates respectively stacked inside the first base-plate cover;
a second base-plate cover stacked upside down on the first base-plate cover inside the compartmentalized tub tray;
a plurality of screws respectively stacked inside the second base-plate cover;
a third base-plate cover stacked upside down on the second base-plate cover inside the compartmentalized tub tray; and
a fourth base-plate cover stacked right side up on the third base-plate cover inside the compartmentalized tub tray.

23. The component box of claim 21, wherein the inner tray comprises a plurality of storage compartments for louver end-caps, crank-handle couplers, compression-locking plates, and drill bits, at least one of the plurality of storage compartments forming a louver-end-caps storage compartment.

24. The component box of claim 21, further comprising leveling screws inserted into corresponding storage cavities in the compartmentalized tub tray.

25. The component box of claim 21, further comprising Allen wrenches placed in designated storage cavities within the compartmentalized tub tray.

26. The component box of claim 21, further comprising corner caps stored in a dedicated corner-caps storage cavity in the compartmentalized tub tray.

27. The component box of claim 21, wherein the multi-function lid tray can be inverted to serve as a storage tray during assembly.

28. The component box of claim 21, wherein the compartmentalized tub tray and the inner tray are made of plastic.

29. The component box of claim 21, wherein the crank control arm wrench and leveling screws are made of metal.

30. The component box of claim 23, further comprising louver end-caps secured in the louver-end-caps storage compartments.

31. The component box of claim 23, further comprising crank-handle couplers snap-locked onto crank-handle-coupler storage stems.

32. The component box of claim 23, further comprising compression-locking plates secured in compression-locking-plates storage compartments.

33. The component box of claim 23, further comprising drill bits snap-locked between drill-bit clips.

34. A method for packing a component box, the method comprising:
molding storage clips onto an undersurface of a multi-function lid tray;
securing a crank control arm wrench between the storage clips;
forming storage cavities into a compartmentalized tub tray;
inserting various tools into their respective storage cavities within the compartmentalized tub tray;
stacking a first base-plate cover upside down inside the compartmentalized tub tray;
stacking base plates inside the first base-plate cover;
stacking a second base-plate cover upside down on the first base-plate cover inside the compartmentalized tub tray;
stacking screws inside the second base-plate cover;
stacking a third base-plate cover upside down on the second base-plate cover inside the compartmentalized tub tray;
stacking a fourth base-plate cover right side up on the third base-plate cover inside the compartmentalized tub tray; and
stacking an inner tray with storage compartments for louver end-caps, crank-handle couplers, compression-locking plates, and drill bits within the base-plate covers.

35. The method of claim 34, further comprising inserting leveling screws into corresponding storage cavities in the compartmentalized tub tray.

36. The method of claim 34, further comprising placing Allen wrenches into designated storage cavities.

37. The method of claim 34, further comprising inserting corner caps into a dedicated corner-caps storage cavity.

38. The method of claim 34, wherein the multi-function lid tray is inverted to serve as a storage tray during assembly.

39. The method of claim 34, wherein the compartmentalized tub tray and the inner tray are made of plastic.

40. The method of claim 34, wherein the crank control arm wrench and leveling screws are made of metal.
